(19) United States
(12) Patent Application Publication
(10) Pub. No.: US 2022/0175605 A1
(43) Pub. Date: Jun. 9, 2022

(54) Systems and Methods for Relieving Nerve Tension in Scoliosis

(71) Applicant: ScoliWRx Inc., Campbell, CA (US)

(72) Inventors: Matthew I. Janzen, Campbell, CA (US); Michael E. Janzen, Campbell, CA (US)

(21) Appl. No.: 17/598,173

(22) PCT Filed: Mar. 25, 2020
(86) PCT No.: PCT/US20/24745

§ 371 Date: Sep. 24, 2021

Related U.S. Application Data
(60) Provisional application No. 62/823,589, filed on Mar. 25, 2019.

(51) Int. Cl. A61H 1/02

(52) U.S. Cl. CPC A61H 1/0255; A61H 1/0229; A61H 2205/10; A61H 2203/0456; A61H 2201/1642

(57) ABSTRACT

A platform supports a person in a supine position. A pelvic restraint secures the person's hips to the platform. A left leg armature is rotatably connected to the platform, with an axis of rotation of the left leg armature positioned at a prescribed distance from an axis of the person's left hip joint when the hips are secured to the platform. The left leg armature lifts the left leg while pushing the left hip into the platform, and maintains extension of the left knee. A right leg armature is rotatably connected to the platform with an axis of rotation of the right leg armature positioned at a prescribed distance from an axis of the person's right hip joint when the hips are secured to the platform. The right leg armature lifts the right leg while pushing the right hip into the platform, and maintains extension of the right knee.

### BACKGROUND

### 1. Field of the Invention

The present invention relates to treatment of human scoliosis.

### 2. Description of the Related Art

FIG. 1A shows an anterior view of a normal human spinal column. The anterior view is toward the front of the person. A cervical region 101 of the spinal column includes seven cervical vertebrae C1-C7. The first cervical vertebra C1 is referred to as the Atlas vertebra. The second cervical vertebra C2 is referred to as the Axis vertebra. A thoracic region 103 of the spinal column is located below the cervical region 101. The thoracic region 103 includes twelve thoracic vertebrae T1-T12. A lumbar region 105 is located below the thoracic region 103. The lumbar region 105 of the spinal column includes five lumbar vertebrae L1-L5. A sacrum region 107 is located below the lumbar region 105. And, a coccyx (tailbone) region 109 is located below the sacrum region 107. FIG. 1B shows a posterior view of the normal human spinal column. The posterior view is toward the back of the person. FIG. 1C shows a left lateral view of the normal human spinal column. The lateral view is toward the left side of the person.

While each of the first cervical vertebra C1 and the second cervical vertebra C2 is uniquely configured, the cervical vertebrae C3-C7 have a similar structure to one another and include essentially the same structural elements. Therefore, to describe the structure of the cervical vertebrae C3-C7, attention is drawn to the fourth cervical vertebra C4 and the seventh cervical vertebra C7. FIG. 1D shows a superior view of the fourth cervical vertebra C4. The superior view is a view from above looking down. FIG. 1E shows an inferior view of the fourth cervical vertebra C4. The inferior view is a view from below looking up. The fourth cervical vertebra C4 includes a body structure 111. A right transverse process 112R extends laterally away from the body structure 111 toward the right side of the person. And, a left transverse process 112L extends laterally away from the body structure 111 toward the left side of the person. The right transverse process 112R includes a right anterior tubercle 121R and a right posterior tubercle 122R between which pass a spinal nerve. The left transverse process 112L includes a left anterior tubercle 121L and a left posterior tubercle 122L between which pass a spinal nerve. The right transverse process 112R includes a right transverse foramen 113R. The left transverse process 112L includes a left transverse foramen 113L. Each of the right and left transverse foramen 113R, 113L give passage to vertebral arteries and veins, and to a plexus of sympathetic nerves. A right pedicle 114R extends from the body structure 111 to a right inferior articular process 115R. A left pedicle 114L extends from the body structure 111 to a left inferior articular process 115L. A right lamina 116R extends from the right inferior articular process 115R to a spinous process 117. A left lamina 116L extends from the left inferior articular process 115L to the spinous process 117. The spinous process 117 extends toward the back of the person in a direction generally away from the body structure 111. Collectively, the body structure 111, the right inferior articular process 115R, the right lamina 116R, the left inferior articular process 115L, the left lamina 116L, and the spinous process 117 circumscribe a vertebral foramen (vertebral canal) 118, which is a passage through which the spinal cord passes through the vertebra. The fourth cervical vertebra C4 also includes several facets corresponding to joints between adjacent vertebrae. These facets include a right superior articular facet 119R and a left superior articular facet 119L which respectively form joints with respective inferior articular facets of the third cervical vertebra C3. Also, a right inferior articular facet 120R and a left inferior articular facet 120L respectively form joints with respective superior articular facets of the fifth cervical vertebra C5.

FIG. 1F shows a superior view of the seventh cervical vertebra C7. FIG. 1G shows an inferior view of the seventh cervical vertebra C7. Although the seventh cervical vertebra C7 is shaped differently from the fourth cervical vertebra C4, they include essentially the same elements. The seventh cervical vertebra C7 includes the body structure 111, with the right transverse process 112R extending laterally away from the body structure 111 toward the right side of the person, and with the left transverse process 112L extending laterally away from the body structure 111 toward the left side of the person. The right transverse process 112R includes the right anterior tubercle 121R and the right posterior tubercle 122R between which pass the spinal nerve. The left transverse process 112L includes the left anterior tubercle 121L and the left posterior tubercle 122L between which pass the spinal nerve. The right transverse process 112R includes the right transverse foramen 113R. The left transverse process 112L includes the left transverse foramen 113L. Each of the right and left transverse foramen 113R, 113L give passage to vertebral arteries and veins, and to a plexus of sympathetic nerves. The right pedicle 114R extends from the body structure 111 to the right inferior articular process 115R. The left pedicle 114L extends from the body structure 111 to the left inferior articular process 115L. The right lamina 116R extends from the right inferior articular process 115R to the spinous process 117. The left lamina 116L extends from the left inferior articular process 115L to the spinous process 117. And, the spinous process 117 extends toward the back of the person in a direction generally away from the body structure 111. Collectively, the body structure 111, the right inferior articular process 115R, the right lamina 116R, the left inferior articular process 115L, the left lamina 116L, and the spinous process 117 circumscribe the vertebral foramen (vertebral canal) 118, through which the spinal cord passes. The seventh cervical vertebra C7 also includes the right superior articular facet 119R and the left superior articular facet 119L which form joints with respective inferior articular facets of the sixth cervical vertebra C6. Also, the right inferior articular facet 120R and the left inferior articular facet 120L form joints with respective superior articular facets of the first thoracic vertebra T1.

FIG. 1H shows a superior view of the fifth thoracic vertebra T5, which has a structure typical of thoracic vertebrae T1-T11. FIG. 1I shows an inferior view of the fifth thoracic vertebra T5. The thoracic vertebra includes a body structure 131. A right pedicle 132R extends from the body structure 131 to connect with a right transverse process 133R. A right lamina 134R extends from the right transverse process 133R to connect with a spinous process 135. Similarly, a left pedicle 132L extends from the body structure 131 to connect with a left transverse process 133L. And, a left lamina 134L extends from the left transverse process 133L to connect with the spinous process 135. Collectively, the body structure 131, right and left pedicles 132R, 132L, right and left transverse processes 133R, 133L, right and left lamina 134R, 134L, and spinous process 135 circumscribe a vertebral foramen (vertebral canal) 136, which is a passage through which the spinal cord passes through the vertebra. A right superior articular facet 137R and a left superior articular facet 137L form joints with a right inferior articular facet 138R and a left inferior articular facet 138L, respectively, of the vertebra above.

Each of thoracic vertebrae T1-T9 has a right costal facet 139R, a right superior costal demifacet 140R, and a right inferior costal demifacet 141R for forming joints with ribs. Each of thoracic vertebrae T1-T9 has a left costal facet 139L, a left superior costal demifacet 140L, and a left inferior costal demifacet 141L for forming joints with ribs. Specifically, each of ribs one through nine has a tubercle that interfaces and articulates with the costal facet 139R/139L of its numerically corresponding vertebra to form the costotransverse joint. And, each of ribs one through nine has two articular facets that respectively interface and articulate with the superior costal demifacet 140R/140L of its numerically corresponding vertebra and with the inferior costal demifacet 141R/141L of the vertebra above to form the costovertebral joint.

The twelfth thoracic vertebra T12 provides a transition from the thoracic region 103 to the lumbar region 105 and correspondingly has a somewhat unique configuration to relative to thoracic vertebrae T1-T11. FIG. 1J shows a superior view of the twelfth thoracic vertebra T12. FIG. 1K shows an inferior view of the twelfth thoracic vertebra T12. On the superior portion of the twelfth thoracic vertebra T12, the features are similar to those of thoracic vertebrae T1-T11. The twelfth thoracic vertebra T12 includes: the body structure 131, the right pedicle 132R extending from the body structure 131 to connect with the right transverse process 133R, the right lamina 134R extending from the right transverse process 133R to connect with the spinous process 135, the left pedicle 132L extending from the body structure 131 to connect with the left transverse process 133L, and the left lamina 134L extending from the left transverse process 133L to connect with the spinous process 135. Collectively, the body structure 131, right and left pedicles 132R, 132L, right and left transverse processes 133R, 133L, right and left lamina 134R, 134L, and spinous process 135 circumscribe the vertebral foramen (vertebral canal) 136, which provides passage for the spinal cord. The twelfth thoracic vertebra T12 also includes the right superior articular facet 137R and a left superior articular facet 137L to form joints with the right inferior articular facet 138R and a left inferior articular facet 138L of the eleventh thoracic vertebra T11. The right inferior articular facet 138R and the left inferior articular facet 138L of the twelfth thoracic vertebra T12 are uniquely configured to interface with respective superior articular facets of the first lumbar vertebra L1. The twelfth thoracic vertebra T12 also has a right costal facet 143R and a left costal facet 143L to which the twelfth ribs connect.

FIG. 1L shows a superior view of the third lumbar vertebra L3, which is representative of the other lumbar vertebrae L1-L2 and L4-L5. FIG. 1M shows a superior view of the third lumbar vertebra L3. The lumbar vertebra includes a body structure 151. A right pedicle 152R extends from the body structure 151 to connect with a right transverse process 153R. A right lamina 154R extends from the right transverse process 153R to connect with a spinous process 155. Similarly, a left pedicle 152L extends from the body structure 151 to connect with a left transverse process 153L. And, a left lamina 154L extends from the left transverse process 153L to connect with the spinous process 155. Collectively, the body structure 151, right and left pedicles 152R, 152L, right and left transverse processes 153R, 153L, right and left lamina 154R, 154L, and spinous process 155 circumscribe a vertebral foramen (vertebral canal) 156, through which the spinal cord passes. A right superior articular facet 157R and a left superior articular facet 157L form joints with a right inferior articular facet 158R and a left inferior articular facet 158L, respectively, of the vertebra above.

The twelve thoracic vertebrae T1-T12 that make up the thoracic region 103 of the spinal column are configured to connect with and support the rib cage (thoracic cage). FIG. 1N shows a right lateral view of the spinal column with the thoracic cage 160 shown attached to the thoracic vertebrae T1-T12. FIG. 1O shows a right lateral section view of the thoracic cage attached the thoracic vertebrae T1-T12. FIG. 1P shows an anterior view of the thoracic cage connected to the thoracic vertebrae T1-T12. FIG. 1Q shows a posterior view of the thoracic cage connected to the thoracic vertebrae T1-T12. The thoracic cage includes twelve right side ribs R1R, R2R, R3R, R4R, R5R, R6R, R7R, R8R, R9R, R10R, R11R, and R12R, and twelve left side ribs R1L, R2L, R3L, R4L, R5L, R6L, R7L, R8L, R9L, R10L, R11L, and R12L. Ribs one through seven, R1R-R7R and R1L-R7L, attach independently to the sternum 161 through costal cartilages C1R-C7R and C1L-C7L, respectively. Ribs eight through ten, R8R-R10R and R8L-R10L, attach to respective costal cartilages C8R-C10R and C8L-C10L, each of which attaches to its superior costal cartilage. Specifically, costal cartilages C8R and C8L attach to costal cartilages C7R and C7L, respectively, with costal cartilages C7R and C7L attaching to the sternum 161. And, costal cartilages C9R and C9L attach to costal cartilages C8R and C8L, respectively. And, costal cartilages C10R and C10L attach to costal cartilages C9R and C9L, respectively.

Ribs eleven and twelve, R11R-R12R and R11L-R12L, do not have an anterior attachment and terminate in the abdominal musculature and are thus referred to as floating ribs. Each rib has facet(s) for connecting to the thoracic vertebral column. Each of the first ribs R1R and R1L has one facet for articulation with the first thoracic vertebra T1. The posterior end of each of the second through tenth ribs, R2R-R10R and R2L-R10L, has an inferior articular facet for connection to its numerically corresponding thoracic vertebra and a superior articular facet for connection to the thoracic vertebra above its numerically corresponding thoracic vertebra. Also, each of the second through tenth ribs, R2R-R10R and R2L-R10L, has a tubercle that includes an articular portion for articulation with the costal facet of the transverse process of its numerically corresponding thoracic vertebra. Each of the eleventh and twelfth ribs R11R, R11L, R12R, R12L has one facet at its posterior end for articulation with its numerically corresponding thoracic vertebra.

FIG. 1R shows a superior view of an interface between thoracic vertebra T6 and each of ribs R6R and R6L. The posterior end of the rib R6R has its inferior articular facet connected to the superior costal demifacet 140R of thoracic vertebra T6 to form part of the costovertebral joint at that location. Similarly, the posterior end of the rib R6L has its inferior articular facet connected to the superior costal demifacet 140L of thoracic vertebra T6 to form part of the costovertebral joint at that location. Also, rib R6R has a tubercle that includes an articular portion for articulation with the costal facet 139R of the transverse process 133R of the thoracic vertebra T6. Similarly, rib R6L has a tubercle that includes an articular portion for articulation with the costal facet 139L of the transverse process 133L of the thoracic vertebra T6. FIG. 1S shows an isometric view of the interface between the sixth thoracic vertebra T6 and the seventh thoracic vertebra T7, including the ribs R7R and R7L. FIG. 1S shows the posterior end of the rib R7L having its superior articular facet connected to the inferior costal demifacet 141L of thoracic vertebra T6, and having its inferior articular facet connected to the superior costal demifacet 140L of thoracic vertebra T7 (hidden from view in FIG. 1S), to form the costovertebral joint at that location. Also, FIG. 1S shows the tubercle 171 of the rib R7L that includes the articular portion for articulation with the costal facet 139L of the transverse process 133L of the thoracic vertebra T7.

When viewed posteriorly, the spinal column should follow a straight line extending vertically upward from the vertical centerline of the sacrum 107, which is referred to as the sacral vertical line. However, a person can be afflicted with a condition known as scoliosis in which a three-dimensional torsional deformity manifests in the spine and trunk of the person. With scoliosis, the spinal column assumes (develops into) a configuration having one or more lateral curves (side-to-side curves) relative to the sagittal plane that divides the human body into left and right halves. Also, scoliosis often includes rotation of vertebrae in a direction transverse direction relative to the vertebral foramen. FIG. 1T shows diagrams from a posterior perspective of the human spinal column having a normal configuration 173, a scoliotic configuration 175 exhibiting a generalized “C-shaped” curvature, and a scoliotic configuration 177 exhibiting a generalized “S-shaped” curvature. The “C-shaped” curvature of the scoliotic configuration 175 includes a single curve 179 relative to the sacral vertical line 172. The “S-shaped” curvature of the scoliotic configuration 177 includes an upper curve 181 relative to the sacral vertical line 172 and a lower curve 183 relative to the sacral vertical line 172. It should be understood that the “C-shaped” curvature of the scoliotic configuration 175 and the “S-shaped” curvature of the scoliotic configuration 177 are simplified representations of the actual scoliotic condition provided for purposes of description. In reality, actual scoliotic configurations of the human spinal column can include more than two curves and can include substantial vertebral rotations that “twist” the thoracic cage causing noticeable physical deformities and in some cases significant pain and suffering.

Additionally, scoliosis is not to be confused with the normal coronal curvature (front-to-back curvature) of the spinal column relative to the coronal plane that divides the human body into anterior and posterior halves. FIG. 1U shows diagrams from a right-lateral perspective of the human spinal column having a normal coronal configuration 185, a kyphosis coronal configuration 186, and a lordosis coronal configuration 187. The normal coronal configuration 185 includes a cervical coronal curvature 188 along the cervical region 101, a thoracic coronal curvature 189 along the thoracic region 103, and a lumbar coronal curvature 190 along the lumbar region 105. In the kyphosis coronal configuration 186, the thoracic coronal curvature 189 is greater than normal, which can manifest as a persistent downward bend or hunch in the human's posture. In the lordosis coronal configuration 187, the lumbar coronal curvature 190 is greater than normal, which can manifest as backward lean in the human's posture. Scoliotic configurations of the human spinal column may contribute to or worsen the kyphosis coronal configuration 186 and/or the lordosis coronal configuration 187 when present.

Scoliosis can cause noticeable asymmetry in the human torso region. In some cases, a person having scoliosis may appear to be standing with one shoulder higher than the other, or with a tilt in their waistline. In some cases, a shoulder blade of a person having scoliosis may appear more prominent than the other shoulder blade due to transverse rotation of the spinal column. Scoliotic curvatures tend to increase more rapidly near the adolescent growth spurt. Also, scoliosis that begins at an earlier age is more likely to progress to a significant condition as compared with scoliosis that begins later in puberty.

About 10% of adolescents have some amount of scoliosis. And, about 1% of adolescents have scoliotic curvatures that require significant medical attention. However, as the 10% of the adolescents that have some amount of scoliosis reach older age, the effects of their scoliosis can become more significant, and possibly lead to struggles with pain and other forms of spinal degeneration. Four out of five cases of scoliosis are considered idiopathic, which means that the cause of scoliosis in those cases is unknown. Also, a person with scoliosis can be otherwise healthy.

Idiopathic scoliosis can be typed according to age of onset. For infantile idiopathic scoliosis, scoliotic spinal curvature appears before age three. For juvenile idiopathic scoliosis, scoliotic spinal curvature appears between ages three and ten. For adolescent idiopathic scoliosis (AIS), scoliotic spinal curvature appears between ages ten and thirteen, near the beginning of puberty. Except for the age of onset, AIS and juvenile idiopathic scoliosis can be considered essentially equivalent to each other. AIS is the most common type of scoliosis. For adult idiopathic scoliosis, scoliotic spinal curvature appears after physical maturation is complete.

Although idiopathic scoliosis is considered to have an unknown cause, some theories exist as to the root cause. In 1968, a neuroradiologist named Dr. Milan Roth proposed a theory that a tight spinal cord could be the cause of adolescent scoliosis. The theory was further expounded upon by Dr. Richard W. Porter in 2001, and has become known as the Roth-Porter Hypothesis. To understand how a tight spinal cord can cause scoliosis, Roth and Porter used the analogy of a string that runs through the middle of a spring. The spring represents the spinal bones, and the string represents the spinal cord. As the string is pulled tight, the spring coils down into a scoliotic shape. When the spinal cord is in sufficient tension, a tugging force manifests on posterior parts of the vertebral column, causing the vertebral column to compress down. In a manner similar to the above-mentioned string-spring example, the tension on the spinal cord can cause the spinal column to coil down into a scoliotic configuration, such that the coiled-down scoliotic configuration relieves the tension on the spinal cord. Therefore, under the Roth-Porter Hypothesis, the scoliotic configuration of the spinal column is an adaptive position in response to spinal nerve tension.

A number of nerve tension pathologies exist that can cause scoliosis. An example nerve tension pathology can include tumors and/or cysts that bind the meninges or spinal cord and cause tension on the nerves, which leads to scoliosis. The tumors and/or cysts may also create neuromuscular dysfunction. In another example, intraspinal anomalies can be a nerve tension pathology that leads to scoliosis. With intraspinal anomalies, the spinal cord or nerves develop embryologically in a way such that one side or one part of the spinal cord is pulled tight at birth. Even though the intraspinal anomalies exist at birth, the scoliotic effects of the intraspinal anomalies may not appear until the child begins to have growth spurts.

Another example nerve tension pathology is tethered cord syndrome, which is a condition from birth that causes the entire spinal cord to be pulled noticeably lower towards the sacrum, placing tension on the spinal cord. And, what is likely the most common nerve tension pathology is referred to as uncoupled neuro-osseous development, which means that the bones of the spinal column (osseous) are growing faster than the spinal cord (neuro), thereby creating spinal cord tension or meningeal tension. Uncoupled neuro-osseous development is believed by some medical professionals to be the most common cause of adolescent scoliosis.

It has been clinically observed that a scoliosis patient's nervous system is very tight and resistant to stretch. In fact, the spinal cord is almost always tight in childhood idiopathic scoliosis cases. Moreover, in scoliosis correction surgery, the tight spinal cord presents a significant problem in that if the surgeon accidentally over-straightens the spine and makes the spine too tall for the tight spinal cord, paralysis may result. This is the main reason that spinal cord monitoring is a routine practice today with scoliosis correction surgery. The tight spinal cord is also the number one reason that surgeons cannot make the spine perfectly straight when performing a scoliosis fusion surgery. However, while there is wide acceptance of the existence of the short spinal cord problem in scoliosis cases, debate continues with regard to which comes first, the tight spinal cord or the scoliotic spinal configuration, and which causes which.

Initially, it was hypothesized that the extreme deformity of the scoliotic spinal configuration was placing tension on the nervous system of the patient, and thereby causing the nervous system to be very resistant to stretch. However, some cases do not fit the hypothesis of the scoliotic spinal configuration preceding the tension on the nervous system. For example, scoliosis patients have been observed to have quite small scoliotic curves of the spinal column (e.g., 18 degrees), while exhibiting severe signs of nerve tension. These cases are indicators that nerve tension can precede the spinal column having a scoliotic configuration. Dr. Milan Roth and others have recognized that in some adolescent scoliosis cases a tight spinal cord can be the sole cause of a growing spine developing a scoliotic configuration. And, in adolescent scoliosis cases where a hyper-mobile skeletal structure exists, such as occurs with Ehlers-Danlos syndrome (EDS) or Marfan syndrome (MFS), the tight nerve problem can be severely magnified with corresponding adverse scoliotic effects on the growing spinal column.

Beyond idiopathic scoliosis, causes are known for some types of scoliosis, including congenital scoliosis, neuromuscular scoliosis, and degenerative scoliosis. Congenital scoliosis is caused by congenital abnormal formation of the bones of the spine and is often associated with other organ defects. Neuromuscular scoliosis is caused by loss of control of the nerves and/or muscles that support the spinal column. Some causes of neuromuscular scoliosis include cerebral palsy, poliomyelitis, muscular dystrophy, severe chiari and syringomyelia, and functional neurologic deficits. Degenerative scoliosis is caused by degeneration of intervertebral discs and/or arthritis in vertebral joints.

In some cases, there may be structural or biomechanical root causes of scoliosis. “Structural” root causes may refer to bones that are asymmetric or incorrectly shaped. For example, a half-formed vertebra at birth, known as a hemi-vertebra, may also create a scoliosis.

Another example of structural-biomechanical scoliosis is when one leg grows a little longer than the other, causing the sacrum to not be level. The sacrum is the base of the spine, so when the sacrum tilts, the spine tilts, and there can be a mild (and sometimes moderate) scoliosis as a result. “Structural causes” may also apply to ligament damage from trauma or from degeneration of discs. If key stabilizing ligaments of the spine are damaged or torn, the vertebra may tilt in response, creating a scoliotic curve. Structural or biomechanical conditions that lead to scoliosis are common and usually cause mild to moderate non-progressive scoliosis.

In the case of scoliosis caused by neuro-muscular pathology, there is a breakdown in either the body's control system (the brain) or the nerves that connect the brain to the muscles, or the muscles themselves cannot work correctly. For example, in cerebral palsy, there is a lack of proper central nervous system control within the brain. In poliomyelitis, the peripheral nerves that carry signals from the brain to the muscles are damaged. In muscular dystrophy, there is weakness of the muscles, rendering the muscles unable to support a straight spine. Neuro-muscular pathology cases tend to be more aggressive. Progression of the scoliosis, i.e., the tendency for the curve to grow large, is often quite high for neuro-muscular pathology cases.

Whatever the root cause of a scoliosis, it will usually begin as a small, flexible scoliosis. At this stage, the spine is still capable of going through its normal range of motion (more or less). In a small, flexible, or “functional” scoliosis, lateral bending X-rays would show an easy correction of the curve when bending the spine sideways to the left and right. As a scoliosis grows, increasing distortion occurs in the soft tissues of the spine, which leads to loss of normal range of motion. When normal range of motion is lost, severe stiffness can set in.

As a scoliotic curve size increases, the ability to exercise the spine throughout its full range of motion is lost. As a result, the scoliosis becomes rigid and stiff primarily due to changes in soft tissue. Secondary stiffness comes from small changes in the shapes of the bones. “Structural scoliosis” is a term applied when the scoliotic curve has become stiff, inflexible, and rigid. Calling a scoliosis “structural” does not mean the curve was caused by a structural asymmetry, such as a wedge-shaped vertebra. It may be more accurate to simply call the scoliosis “rigid” instead of “structural.” Some physicians prefer to use the term “structural” in order to divide scoliosis into two categories: 1) functional (flexible) scoliosis, and 2) structural (rigid) scoliosis. This may be considered a false dichotomy, as most scoliotic curves have both some functional and some structural qualities. Also, using the term “structural” for a scoliotic curve that is rigid creates the false impression that the curve is being caused by bones that are “structurally” misshaped. In truth, most larger, rigid scoliotic curves have relatively minimal distortion in the bones. Additionally, the term “structural” is often used to communicate to the person that nothing at this point could straighten their spine, except surgery. However, this is not always true.

In child and adolescent scoliosis, a small flexible scoliotic curve can quickly become a large, stiff, and rigid. During growth of the spinal bones, the tightness of the spinal cord causes the vertebrae to “coil down” like a spring that has a tight string run through it, such as according to the Roth-Porter Hypothesis. The spine is now constantly postured in a scoliotic pattern, unable to straighten even when the person tries to bend out of it. This means that the ligaments, muscles, and discs are no longer being exercised through their normal range of motion. Failure to move muscles and joints always results in stiff “contractures” of the joints. These “contractured” joints are so stiff, that it can feel like bone running into bone, when in reality, it is really just soft tissue that has become stiff, shortened, and tough. This is good and bad news. Good news because soft tissue contractures can be loosened up with proper mobilization. Bad news, because it is a difficult and arduous process to loosen up contractured soft tissue around the joints.

A typical progression of AIS begins with an early stage flexible and functional scoliosis. Then, the scoliotic curve size progresses, which lead to a loss of range of motion of the spinal column. This loss of range of motion in turn leads to joint contractures of within the spinal column. With the joint contractures, the scoliotic portions of spinal column are no longer being exercised, which causes stiffer, rigid, “structural” scoliosis. Ultimately, the bones of the spine can change shape in response to the mechanical stresses placed on them by the scoliosis, causing wedge-shaped vertebra, asymmetric pedicles, and thoracic cage deformity.

Early stage spinal bone changes in a small scoliosis have been observed. These early stage changes are most noticeable in the front part of the thoracic vertebral bodies. It has been observed that the front part of the vertebral body can grow taller than what is normal. This is called Relative Anterior Spinal Overgrowth (RASO). In other words, with RASO, the front of the vertebra is growing taller than it should. This can lead to a lordosis condition in which there is a loss of the normal thoracic coronal curvature. The existence of RASO and a loss of the normal thoracic coronal curvature is most likely in response to nerve tension. Nerve tension will cause the thoracic region of the spine to flatten out its normally curved shape (see the normal thoracic coronal curvature 189 of FIG. 1U). The loss of thoracic coronal curvature, or “flat back,” is a position that relieves tension on the spinal cord. The “flat back” posture is an early adaptive position in response to a tight spinal cord. It is suspected that nerve tension occurs first, followed by the “flat back” in response to the nerve tension.

As a scoliotic curve becomes larger, the thoracic cage distorts to adapt to the growing scoliosis. Also, a scoliotic curve becomes larger, the pedicles of the spine may grow asymmetric in length and thickness. Further, a scoliotic curve becomes larger, the normally rectangular vertebrae may develop a slight rhomboid-wedge shape at the apex of the scoliotic curve.

A system for classifying AIS has been developed by Lawrence G. Lenke, Md., and was published in the “Journal of Bone and Joint Surgery” in 2001. This system is commonly referred to as the “Lenke Classification System for AIS.” FIG. 1V shows a chart of the Lenke Classification System for AIS. FIG. 1W shows a chart of scoliotic spinal diagrams corresponding to scoliosis curve classifications within the Lenke Classification System for AIS. To use the Lenke Classification System for AIS, it is necessary to measure the Cobb angle(s) of the scoliotic curve(s) along the spinal column. FIG. 1X shows a diagram illustrating how to measure the Cobb angle of scoliotic curve. In the example of FIG. 1X, the scoliotic curve extends from vertebra V2 to vertebra V8, with the apex of the curve occurring at vertebra V5. The most significantly angled vertebra within the curve above the apex is vertebra V3. The most significantly angled vertebra within the curve below the apex is vertebra V7. To measure the Cobb angle, an upper line is drawn parallel to the upper border of the most significantly angled vertebra within the curve above the apex. Therefore, in the example of FIG. 1X, an upper line 191 is drawn parallel to the upper border of vertebra V3. Further, a lower line is drawn parallel to the lower border of the most significantly angled vertebra within the curve below the apex. In the example of FIG. 1X, a lower line 192 is drawn parallel to the lower border of vertebra V7. A upper perpendicular line is drawn to extend downward in a direction perpendicular to the upper line that is drawn parallel to the upper border of the most significantly angled vertebra within the curve above the apex. In the example of FIG. 1X, an upper perpendicular line 193 is drawn to extend downward in a direction perpendicular to the upper line 191. A lower perpendicular line is drawn to extend upward in a direction perpendicular to the lower line that is drawn parallel to the lower border of the most significantly angled vertebra within the curve below the apex. In the example of FIG. 1X, an lower perpendicular line 194 is drawn to extend upward in a direction perpendicular to the lower line 192. The angle formed between the upper perpendicular line and the lower perpendicular line at their point of crossing is the Cobb angle, or the angle of curvature of the scoliotic curve. FIG. 1Y shows a diagram of anatomical planes and reference directions relative to the human body that are used to facilitate description of the systems and methods disclosed herein.

Given the foregoing, it is of interest to determine new and effective ways for mitigating and reversing scoliosis, and particularly AIS, for the benefit of humanity. It is within this context that the present invention arises.

### SUMMARY

In an example embodiment, a nervous system stretching apparatus is disclosed. The nervous system stretching apparatus includes a platform configured to support a person in a supine position. The nervous system stretching apparatus also includes a pelvic restraint configured to secure hips of the person to the platform. The nervous system stretching apparatus also includes a left leg armature rotatably connected to the platform, with an axis of rotation of the left leg armature positioned at a first prescribed distance from an axis of a left hip joint of the person when the hips of the person are secured to the platform by the pelvic restraint. The left leg armature is configured to lift a left leg of the person while maintaining a substantially full extension of a left knee of the person. The left leg armature and the position of the axis of rotation of the left leg armature relative to the axis of the left hip joint are collectively configured to apply a downward force to a left pelvis of the person as the left leg armature is rotated to lift the left leg of the person. The nervous system stretching apparatus also includes a right leg armature rotatably connected to the platform, with an axis of rotation of the right leg armature positioned at a second prescribed distance from an axis of a right hip joint of the person when the hips of the person are secured to the platform by the pelvic restraint. The right leg armature is configured to lift a right leg of the person while maintaining a substantially full extension of a right knee of the person. The right leg armature and the position of the axis of rotation of the right leg armature relative to the axis of the right hip joint are collectively configured to apply a downward force to a right pelvis of the person as the right leg armature is rotated to lift the right leg of the person.

In an example embodiment, a nervous system stretching apparatus is disclosed. The nervous system stretching apparatus includes a platform having a substantially planar shape. The platform has a head end and a tail end. The platform has a left side extending between the head end and the tail end. The platform has a right side extending between the head end and the tail end. The nervous system stretching apparatus also includes a pelvic restraint secured to the platform. The nervous system stretching apparatus also includes a left leg armature rotatably connected to the platform, such that an axis of rotation of the left leg armature is positioned at a location proximate to the left side of the platform and between the pelvic restraint and the tail end of the platform. The left leg armature is configured to rotate within a plane substantially perpendicular to the platform. The nervous system stretching apparatus also includes a right leg armature rotatably connected to the platform, such that an axis of rotation of the right leg armature is positioned at a location proximate to the right side of the platform and between the pelvic restraint and the tail end of the platform. The right leg armature is configured to rotate within a plane substantially perpendicular to the platform.

In an example embodiment, a method is disclosed for nervous system stretching. The method includes having a person in a supine position on a top surface of a platform. The method also includes securing a leg of the person in a substantially fully extended configuration in a leg armature. The leg armature has an axis of rotation located in a fixed position relative to the platform at a prescribed distance from an axis of rotation of a hip joint of the person. The axis of rotation is oriented such that the leg armature is rotatable within a plane substantially perpendicular to the top surface of the platform. The method also includes rotating the leg armature upward about the axis of rotation to a prescribed position while substantially preventing movement of hips of the person away from the top surface of the platform. The method also includes holding the leg armature at the prescribed position for a prescribed amount of time.

In an example embodiment, a method is disclosed for nervous system stretching. The method includes having a nervous system stretching apparatus that includes a platform, a pelvic restraint, a left leg armature, and a right leg armature. The platform has a substantially planar shape. The platform has a head end and a tail end. The platform has a left side extending between the head end and the tail end. The platform has a right side extending between the head end and the tail end. The pelvic restraint is secured to the platform. The left leg armature is rotatably connected to the platform, such that an axis of rotation of the left leg armature is positioned at a location proximate to the left side of the platform and between the pelvic restraint and the tail end of the platform. The left leg armature is configured to rotate within a plane substantially perpendicular to the platform. The right leg armature is rotatably connected to the platform, such that an axis of rotation of the right leg armature is positioned at a location proximate to the right side of the platform and between the pelvic restraint and the tail end of the platform. The right leg armature is configured to rotate within a plane substantially perpendicular to the platform. The method also includes securing the pelvic restraint over a pelvis of a person when the person is supported in a supine position on the platform. The method also includes tightening the pelvic restraint toward a top surface of the platform so that the hips of the person cannot move away from the platform. The method also includes performing a nerve stretching process on the person by either a first process, or a second process, or a third process. The first process includes securing a left leg of the person within the left leg armature, such that a left knee of the person is held in substantially full extension by the left leg armature. The first process also includes rotating the left leg armature upward about the axis of rotation of the left leg armature to a prescribed position. The first process also includes holding the left leg armature at the prescribed position for a prescribed amount of time. The first process also includes rotating the left leg armature downward about the axis of rotation of the left leg armature to a resting position after the prescribed amount of time. The second process includes securing a right leg of the person within the right leg armature, such that a right knee of the person is held in substantially full extension by the right leg armature. The second process includes rotating the right leg armature upward about the axis of rotation of the right leg armature to a prescribed position. The second process includes holding the right leg armature at the prescribed position for a prescribed amount of time. The second process also includes rotating the right leg armature downward about the axis of rotation of the right leg armature to a resting position after the prescribed amount of time. The third process includes securing a left leg of the person within the left leg armature, such that a left knee of the person is held in substantially full extension by the left leg armature, and securing a right leg of the person within the right leg armature, such that a right knee of the person is held in substantially full extension by the right leg armature. The third process includes rotating the left leg armature upward about the axis of rotation of the left leg armature to a prescribed position, and rotating the right leg armature upward about the axis of rotation of the right leg armature to the prescribed position. The third process includes holding the left leg armature and the right leg armature at the prescribed position for a prescribed amount of time. The third process also includes rotating the left leg armature downward about the axis of rotation of the left leg armature to a resting position after the prescribed amount of time, and rotating the right leg armature downward about the axis of rotation of the right leg armature to a resting position after the prescribed amount of time.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1A shows an anterior view of a normal human spinal column.

FIG. 1B shows a posterior view of the normal human spinal column.

FIG. 1C shows a left lateral view of the normal human spinal column.

FIG. 1D shows a superior view of the fourth cervical vertebra C4.

FIG. 1E shows an inferior view of the fourth cervical vertebra C4.

FIG. 1F shows a superior view of the seventh cervical vertebra C7.

FIG. 1G shows an inferior view of the seventh cervical vertebra C7.

FIG. 1H shows a superior view of the fifth thoracic vertebra T5, which has a structure typical of thoracic vertebrae T1-T11.

FIG. 1I shows an inferior view of the fifth thoracic vertebra T5.

FIG. 1J shows a superior view of the twelfth thoracic vertebra T12.

FIG. 1K shows an inferior view of the twelfth thoracic vertebra T12.

FIG. 1L shows a superior view of the third lumbar vertebra L3, which is representative of the other lumbar vertebrae L1-L2 and L4-L5.

FIG. 1M shows a superior view of the third lumbar vertebra L3.

FIG. 1N shows a right lateral view of the spinal column with the thoracic cage 160 shown attached to the thoracic vertebrae T1-T12.

FIG. 1O shows a right lateral section view of the thoracic cage attached the thoracic vertebrae T1-T12.

FIG. 1P shows an anterior view of the thoracic cage connected to the thoracic vertebrae T1-T12.

FIG. 1Q shows a posterior view of the thoracic cage connected to the thoracic vertebrae T1-T12.

FIG. 1R shows a superior view of an interface between thoracic vertebra T6 and each of ribs R6R and R6L.

FIG. 1S shows an isometric view of the interface between the sixth thoracic vertebra T6 and the seventh thoracic vertebra T7, including the ribs R7R and R7L.

FIG. 1T shows diagrams from a posterior perspective of the human spinal column having a normal configuration, a scoliotic configuration exhibiting a generalized “C-shaped” curvature, and a scoliotic configuration exhibiting a generalized “S-shaped” curvature.

FIG. 1U shows diagrams from a right-lateral perspective of the human spinal column having a normal coronal configuration, a kyphosis coronal configuration, and a lordosis coronal configuration.

FIG. 1V shows a chart of the Lenke Classification System for AIS.

FIG. 1W shows a chart of scoliotic spinal diagrams corresponding to scoliosis curve classifications within the Lenke Classification System for AIS.

FIG. 1X shows a diagram illustrating how to measure the Cobb angle of scoliotic curve.

FIG. 1Y shows a diagram of anatomical planes and reference directions relative to the human body that are used to facilitate description of the systems and methods disclosed herein.

FIG. 2 shows a schematic diagram of a nervous system stretching apparatus, in accordance with some embodiments of the present invention.

FIG. 3A shows a top view of a nervous system stretching apparatus, in accordance with some embodiments of the present invention.

FIG. 3B shows a left side view of the nervous system stretching apparatus (View A-A as referenced in FIG. 3A), in accordance with some embodiments of the present invention.

FIG. 3C shows a right side view of the nervous system stretching apparatus (View B-B as referenced in FIG. 3A), in accordance with some embodiments of the present invention.

FIG. 3D shows a head end view of the nervous system stretching apparatus (View C-C as referenced in FIG. 3A), in accordance with some embodiments of the present invention.

FIG. 3E shows a foot end view of the nervous system stretching apparatus (View D-D as referenced in FIG. 3A), in accordance with some embodiments of the present invention.

FIG. 3F shows a bottom view of the nervous system stretching apparatus (View E-E as referenced in FIG. 3B), in accordance with some embodiments of the present invention.

FIG. 3G shows a close-up top view of the positions of the connection mechanisms of the left leg armature and right leg armature relative to the pelvic restraint, corresponding to the area referenced as 3001 in FIG. 3A, in accordance with some embodiments.

FIG. 3H shows a close-up side view of the position of the connection mechanism of the left leg armature relative to the pelvic restraint, corresponding to the area referenced as 3003 in FIG. 3B, in accordance with some embodiments.

FIG. 3I shows a close-up side view of the position of the connection mechanism of the right leg armature relative to the pelvic restraint, corresponding to the area referenced as 3005 in FIG. 3C, in accordance with some embodiments.

FIG. 3J shows a schematic side-view of rotational movement of the right leg armature, with the axis of rotation of the right leg armature positioned directly posterior to the axis of the rotation of the right hip joint of the person, in accordance with some embodiments.

FIG. 3K shows a variation from the example of FIG. 3J in which the axis of rotation of the right leg armature is positioned both posterior and inferior to the right hip joint of the person, in accordance with some embodiments.

FIG. 3L shows a variation from the example of FIG. 3J in which the axis of rotation of the right leg armature is positioned inferior to the right hip joint of the person, but neither substantially posterior nor substantially anterior to the right hip joint of the person, in accordance with some embodiments.

FIGS. 4, 5, 6, 7, 8, 9, 10, 11, 12, 13, 14, 15, 16, 17, and 18 show various views of a person using a nervous system stretching apparatus, in accordance with some embodiments of the present invention.

FIG. 19 shows a flowchart of a method for nervous system stretching, in accordance with some embodiments of the present invention.

FIG. 20A shows a flowchart of a method for nervous system stretching, in accordance with some embodiments of the present invention.

FIG. 20B shows a flowchart of a first stretching process, in accordance with some embodiments of the present invention.

FIG. 20C shows a flowchart of a second stretching process, in accordance with some embodiments of the present invention.

FIG. 20D shows a flowchart of a third stretching process, in accordance with some embodiments of the present invention.

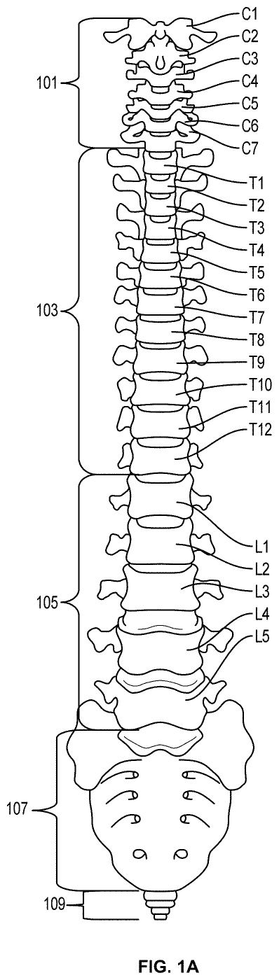

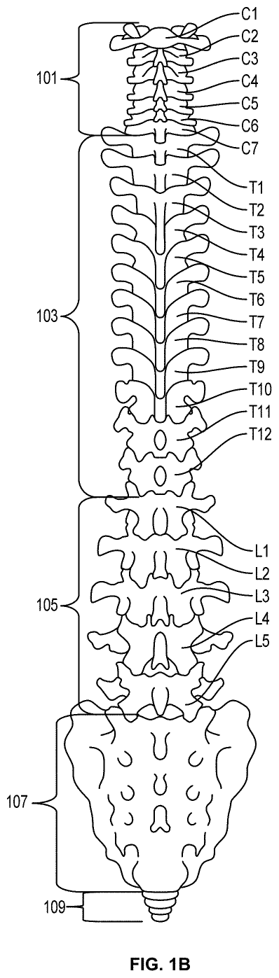

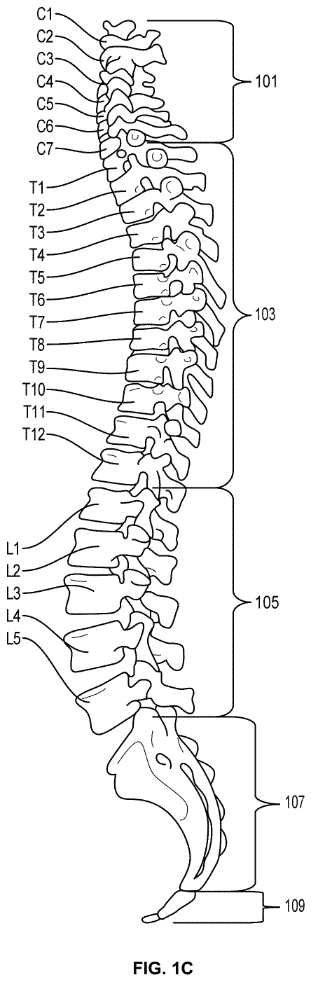

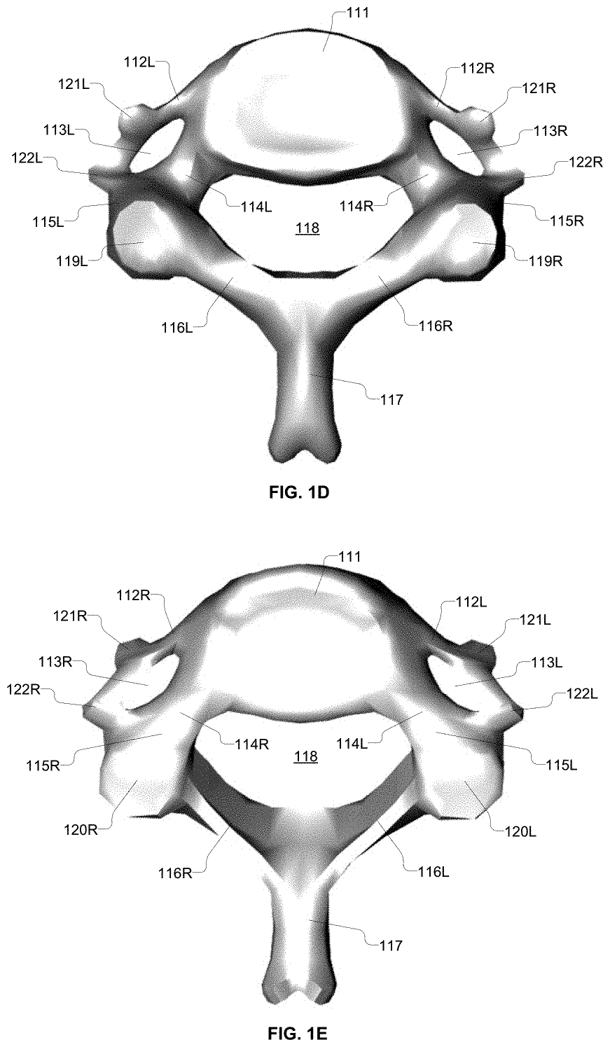

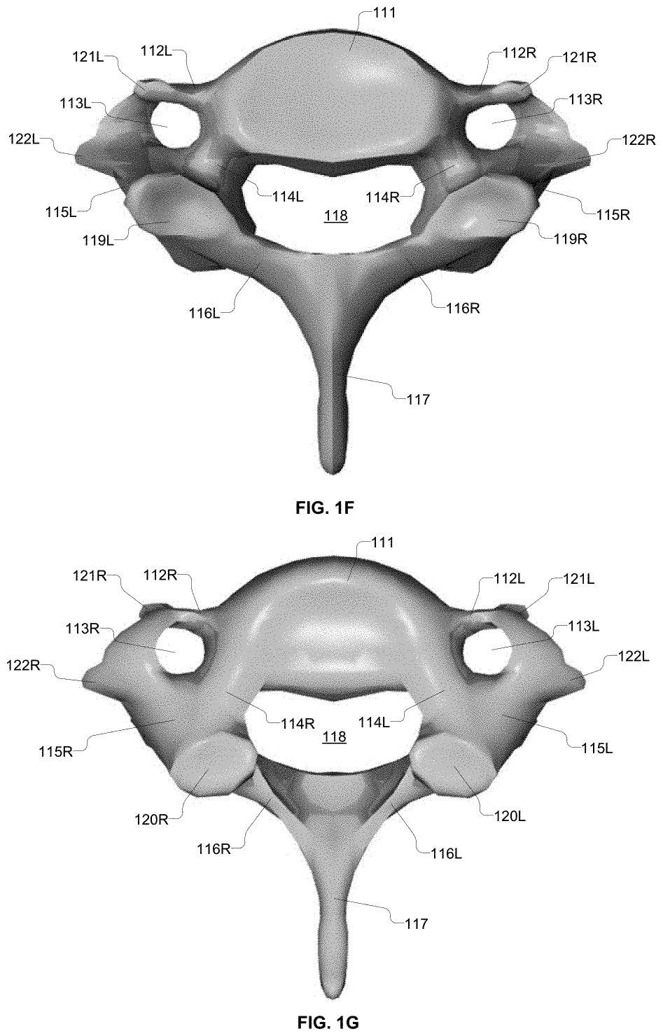

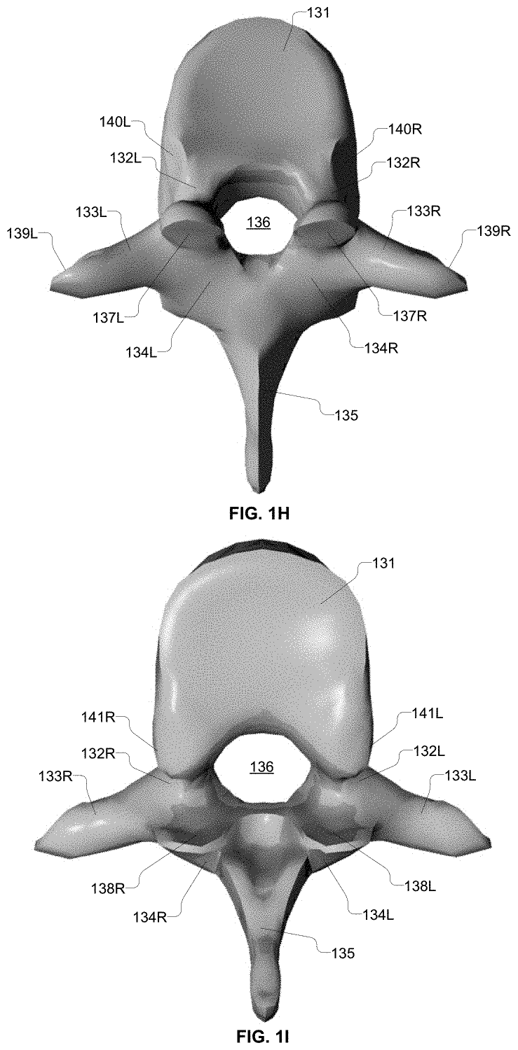

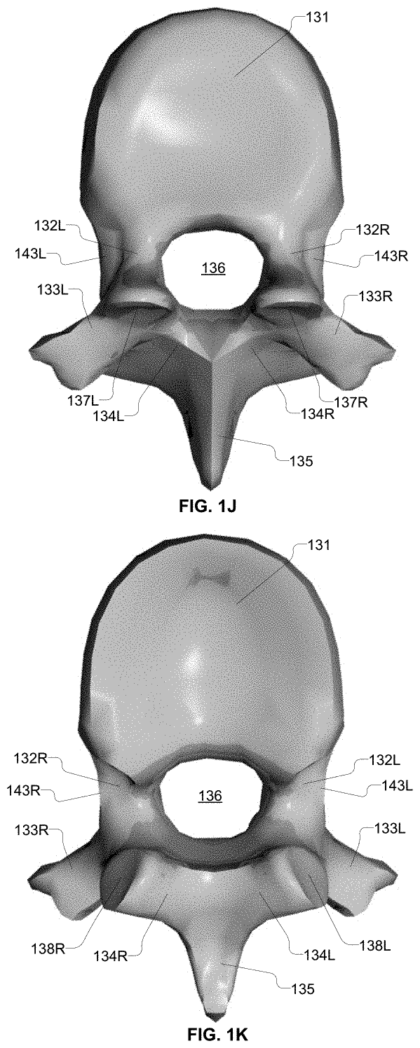

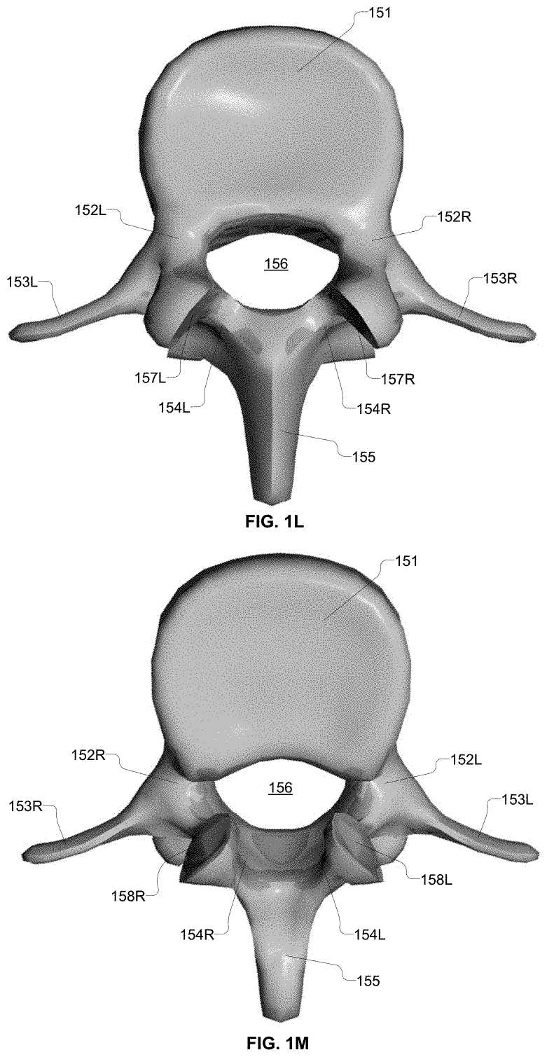

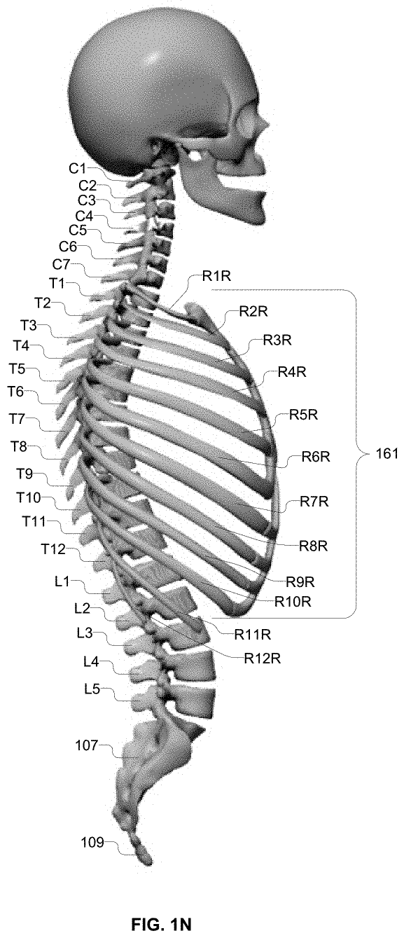

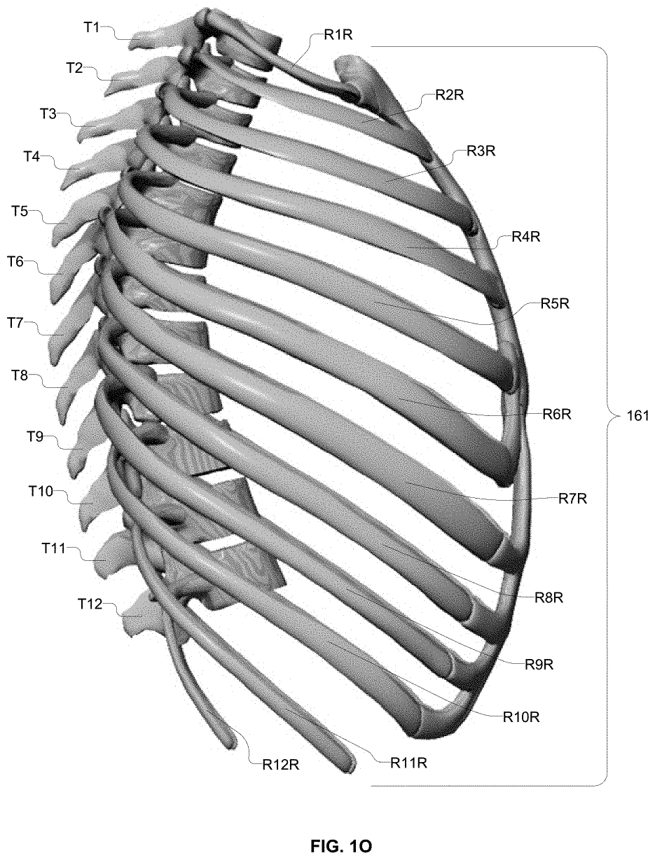

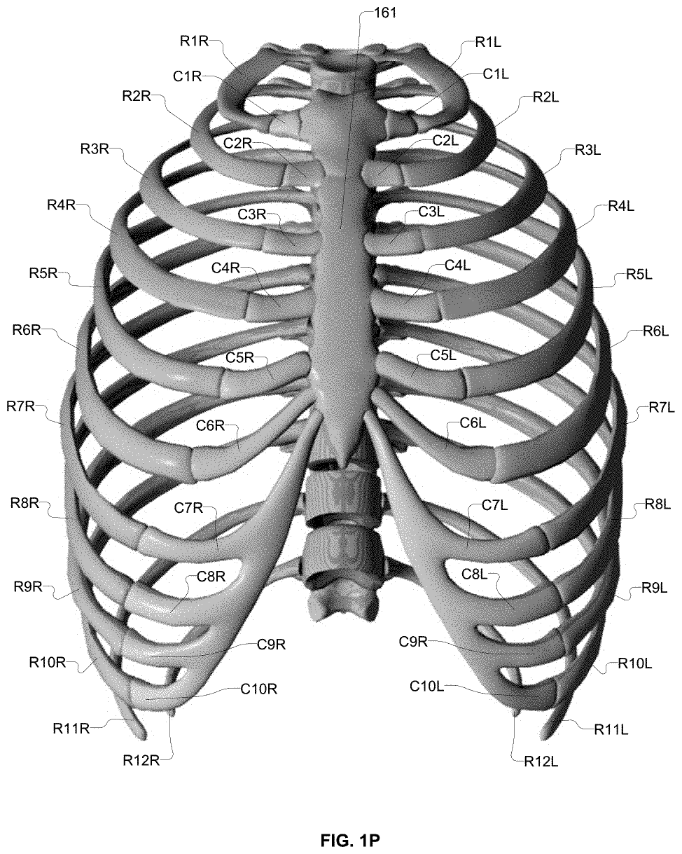

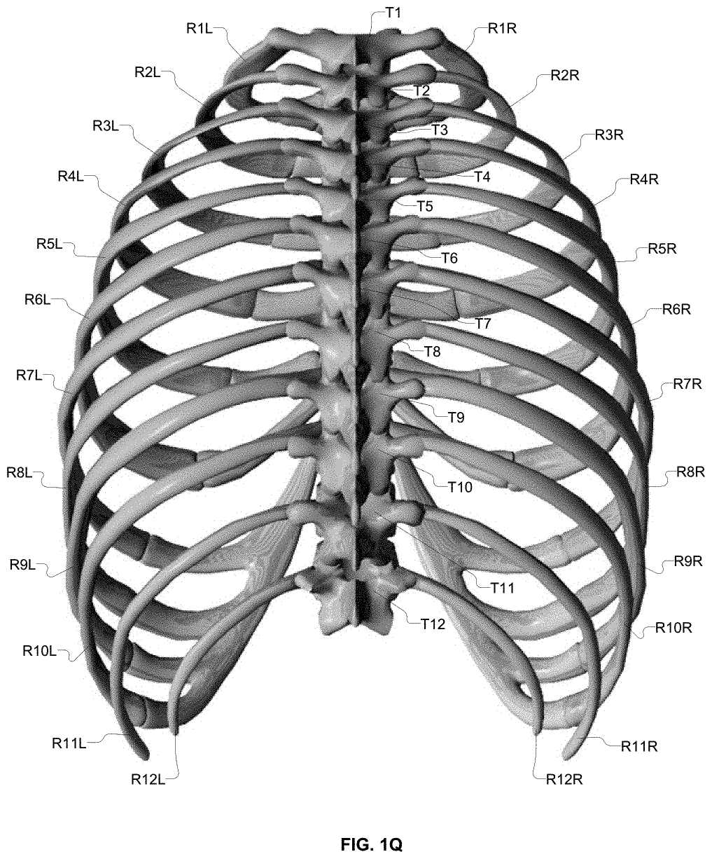

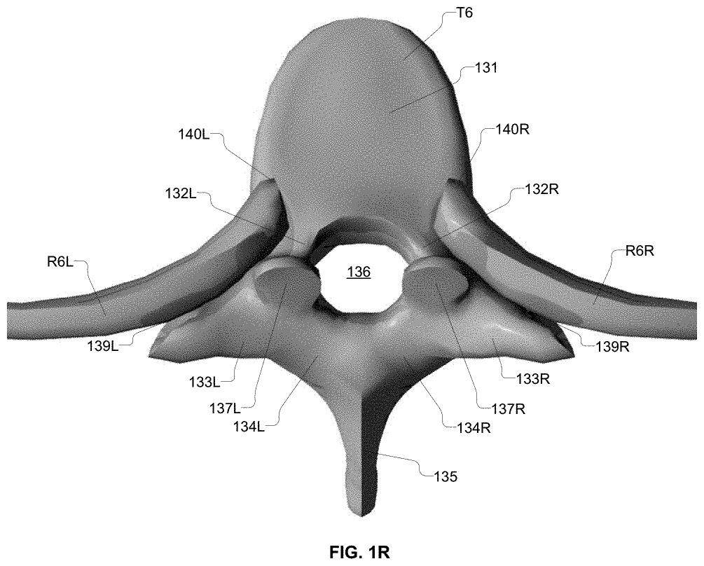

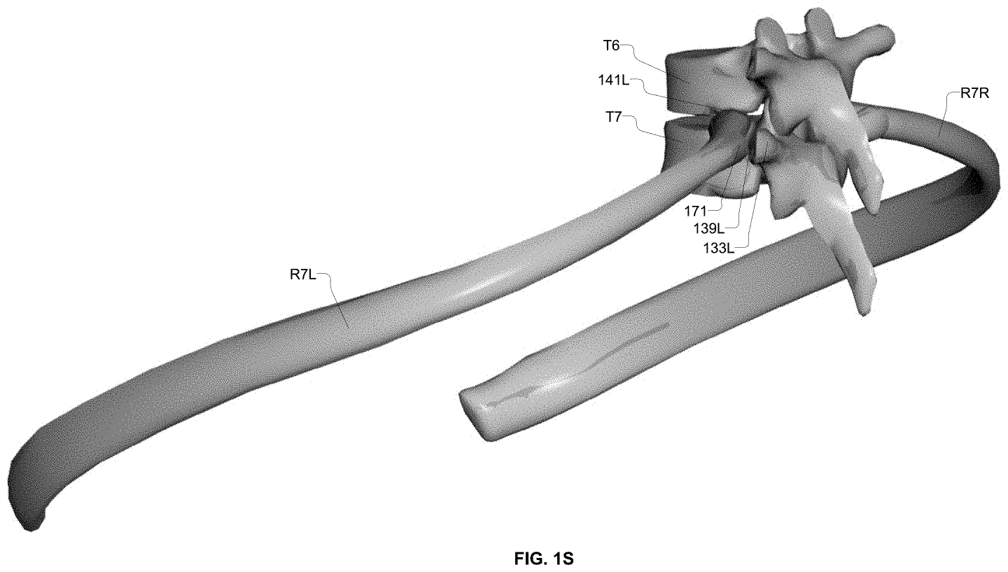

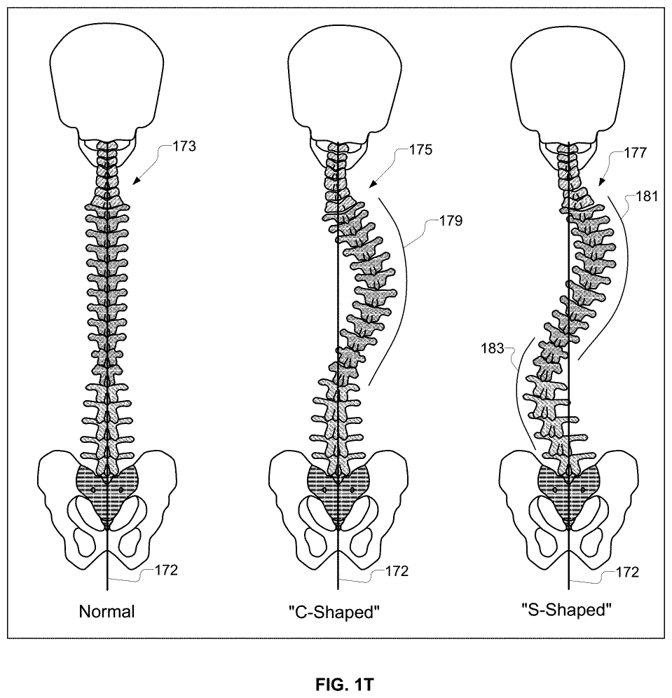

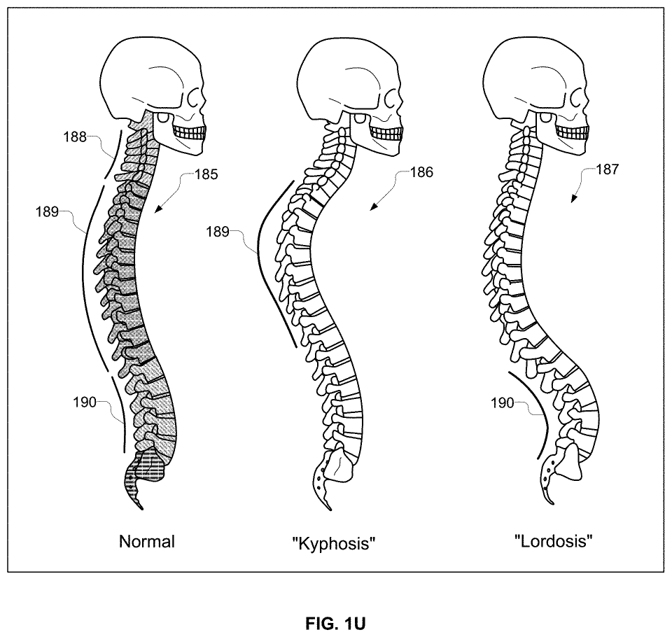

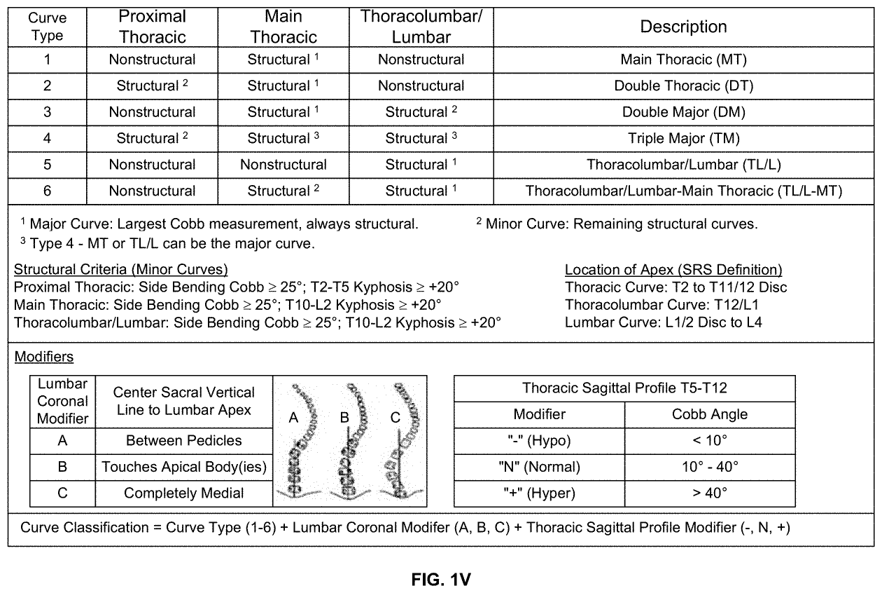

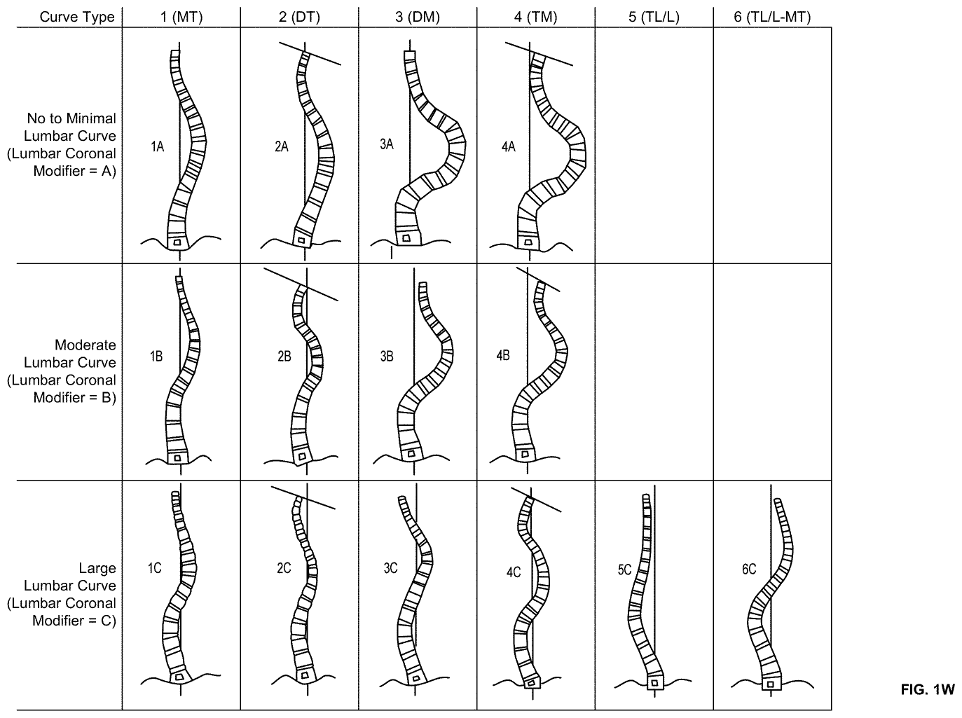

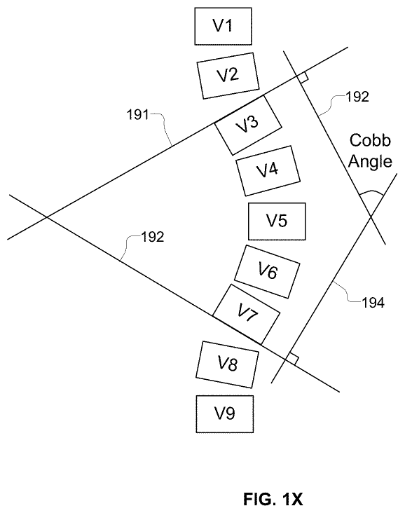

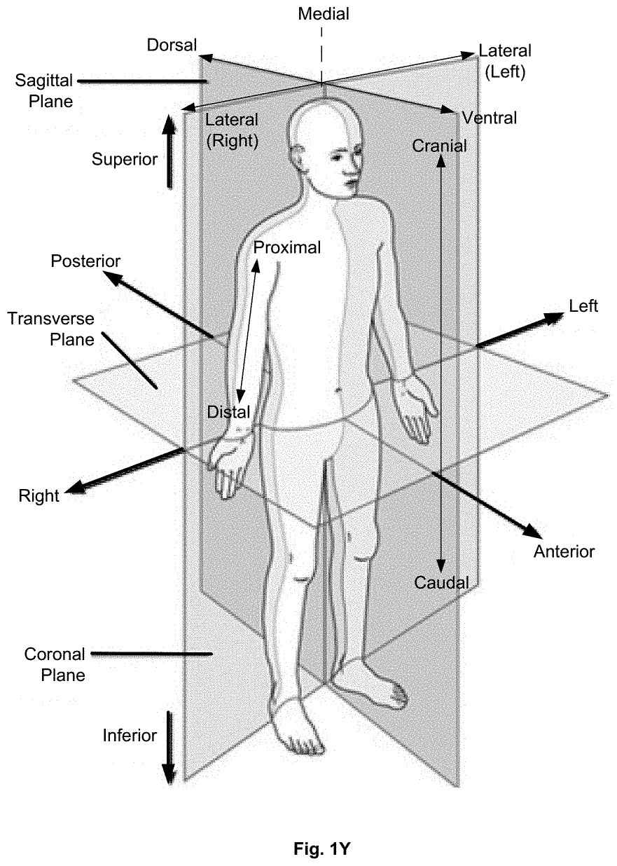

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

A nerve tension scoliosis case is a situation where there is either a tight, inelastic, or tethered spinal cord. In the nerve tension scoliosis case, the nerve root or meninges creates the main driving force that causes the spinal column to coil down into the scoliotic configuration. If a scoliosis is progressing rapidly in a growing spinal column and is diagnosed as idiopathic, meaning unknown cause, there is a high likelihood that nerve tension is the root cause of the scoliosis. Nerve tension is likely the most common root cause of adolescent idiopathic scoliosis (AIS). If it is possible to address the root cause of a scoliosis case, i.e., the driving force causing the scoliosis, then it is possible to achieve a better scoliosis treatment outcome. Therefore, given that nerve tension and/or a tight spinal cord is likely the most common root cause of adolescent scoliosis, it is of interest to seek non-surgical treatment systems and methods that will reduce the nerve tension and/or relax the tight spinal cord.

In accordance with some embodiments, an example method for treating a patient with scoliosis includes testing for nerve tension in the patient and treating nerve tension in the patient when present. With the methods and systems disclosed herein it is possible to detect nerve tension, quantify nerve tension, treat nerve tension, and resolve nerve tension. In many cases, relieving the spine of the nerve tension that causes scoliosis provides for reduction and/or elimination of the driving force or root cause of the scoliosis. The methods and systems disclosed herein for relieving spinal nerve tension, especially in scoliosis cases having scoliotic curves under 25 degrees, can be effective in avoiding the need for surgical intervention to address the scoliosis. For example, a method for treating adolescent scoliosis can include a process for addressing the root cause of the scoliosis. Addressing the root cause of the scoliosis can include weakening and/or eliminating the driving force causing the spine to coil down, which is usually a tight spinal cord. The method can also include another process for bracing of the spinal column in a corrected configuration with maximal bracing effectiveness. The bracing operation can be done to make the spine as straight as possible, or even hyper-corrected, and hold the spine in the corrected/hyper-corrected configuration as much as possible, e.g., around the clock. The process to address the tight spinal cord may be done for a period of time before starting the process to provide maximal bracing. Then, the processes to address the tight spinal cord and provide maximal bracing can be done in conjunction with each other. Also, in some cases, it may be necessary to perform additional processes, such as a process to reduce and/or eliminate spinal contractures that prevent straightening of the spine out of the scoliotic configuration. And, once the spinal column can be straightened, the patient can perform neuromuscular exercises to strengthen and train the patient's nerves and muscles to maintain a substantially normal spinal posture.

Once nerve tension is diagnosed in conjunction with a scoliosis condition, very specific nerve stretching techniques are needed to create elasticity and elongation of the spinal cord. These nerve stretching techniques should be done with essentially perfect technique in order to keep the spinal cord under tension throughout the entire stretch without ever letting the tension escape. With consistent stretching, the spinal cord will gradually elongate and have increased elasticity. The elongation and increased elasticity of the spinal cord will contribute to enabling corrective straightening of the spinal column and will reduce the driving force for the scoliosis to get worse during growth spurts of the spinal column.

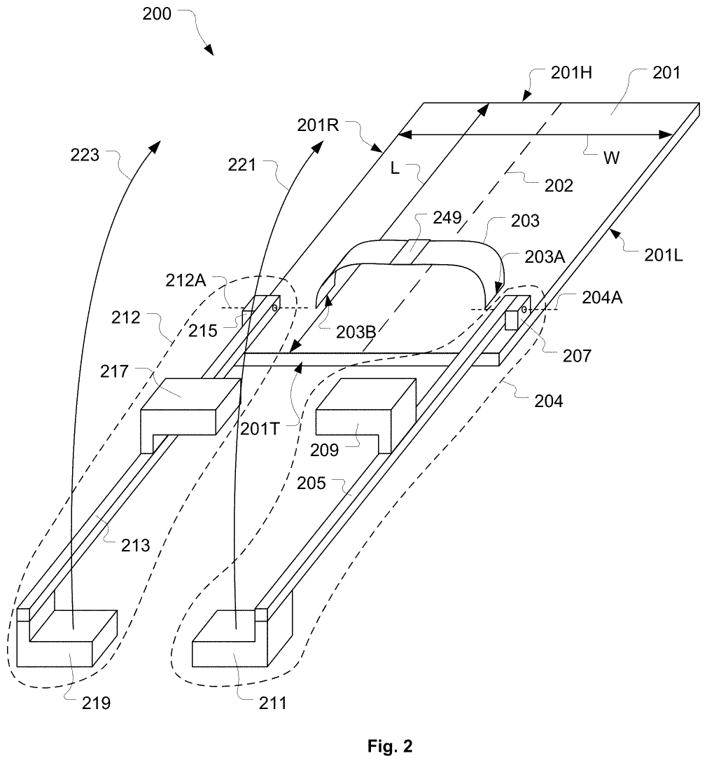

FIG. 2 shows a schematic diagram of a nervous system stretching apparatus 200, in accordance with some embodiments of the present invention. The nervous system stretching apparatus 200 is configured to apply targeted and controlled stretching to a person's nervous system to enable elongation and increased elasticity of the person's spinal cord and peripheral nervous system, and thereby mitigate nervous system tension as a root cause or contributing cause of scoliosis in the person.

The nervous system stretching apparatus 200 includes a platform 201 configured to support a person in a supine position. In some embodiments, the platform 201 has a substantially planar shape. The platform 201 has a head end 201H and a tail end 201T. The platform 201 also has a left side 201L extending between the head end 201H and the tail end 201T. The platform 201 also has a right side 201R extending between the head end 201H and the tail end 201T. In some embodiments, the platform 201 includes a frame structure and a planar member disposed on the frame structure. In some embodiments, the platform 201 is an integral structure that includes an upper planar surface and supporting portions underlying the upper planar surface. In some embodiments, the platform 201 is configured to include a substantially planar surface having a length (L) and a width (W). In some embodiments, the length (L) of the platform 201 is at least a distance extending from a location just inferior to a buttocks of the person to a location just superior to a head of the person, when the person is in the supine position on the platform 201. In some embodiments, the width (W) of the platform 201 is at least a distance extending from a location laterally outside a left hip of the person to a location laterally outside a right hip of the person. In various embodiments, the platform 201 can be formed of one or more of metal, plastic, and wood, among other materials. Also, in some embodiments, a pad can be disposed on the upper surface of the platform 201, so that the person can lie in the supine position on the pad.

The nervous system stretching apparatus 200 includes a left leg armature 204 rotatably connected to the platform 201 by a connection mechanism 207. An axis of rotation 204A of the left leg armature 204 is positioned at a first prescribed distance from an axis of a left hip joint of the person when the hips of the person are secured to the platform 201 by a pelvic restraint 203. In some embodiments, the pelvic restraint 203 is a belt. However, in other embodiments, the pelvic restraint 203 is a structure, such as a pad or contoured rigid member, configured to apply force to the pelvis of person so as to hold the hips of the person to the platform 201 as the leg(s) of the person are raised upward. The pelvic restraint 203 holds the pelvis of the person down toward the platform 201, so that as the left leg of the person is raised by the left leg armature 203, the left hip of the person cannot lift from the platform 201. In some embodiments, the left leg armature 204 is connected to the platform 201 at a location laterally outside and proximate to a left hip of the person. In some embodiments, the first prescribed distance is within a range extending up to about 5 centimeters. However, in other embodiments, the first prescribed distance can be greater than about 5 centimeters. In some embodiments, the axis of rotation 204A is positioned to be at (sufficiently aligned with) or inferior/distal to an axis of the left hip joint of the person to ensure that a proper downward force (toward the platform 201) is exerted on the left leg of the person as the left leg armature 204 is raised in the direction of arrow 221, by rotation of the left leg armature 204 about the axis of rotation 204A. The left leg armature 204 and the position of the axis of rotation 204A of the left leg armature 204 relative to the axis of the left hip joint of the person are collectively configured to apply a downward force to a left hip of the person as the left leg armature 204 is rotated to lift the left leg of the person. Also, in some embodiments, the axis of rotation 204A of the left leg armature 204 is positioned relative to the axis of the left hip joint of the person so that as the left leg armature 204 is rotated upward about the axis of rotation 204A, the downward force applied to the left hip of the person by the left leg armature 204 increases. The axis of rotation 204A of the left leg armature 204 is positioned at a location proximate to the left side 201L of the platform 201 and between the pelvic restraint 203 and the tail end 201T of the platform 201. The left leg armature 204 is configured to lift a left leg of the person while maintaining a substantially full extension of a left knee of the person. The left leg armature 204 is configured to rotate within a plane substantially perpendicular to the platform 201, as indicated by arrow 221. In some embodiments, the axis of rotation 204A of the left leg armature 204 is oriented to provided for rotational movement of the left leg armature 204 within a substantially vertical plane.

The nervous system stretching apparatus 200 includes a right leg armature 223 rotatably connected to the platform 201 by a connection mechanism 215. An axis of rotation 212A of the right leg armature 212 is positioned at a second prescribed distance from an axis of a right hip joint of the person when the hips of the person are secured to the platform 201 by the pelvic restraint 203. The pelvic restraint 203 holds the pelvis of the person down toward the platform 201, so that as the right leg of the person is raised by the right leg armature 212, the right hip of the person cannot lift from the platform 201. In some embodiments, the right leg armature 212 is connected to the platform 201 at a location laterally outside and proximate to a right hip of the person. In some embodiments, the second prescribed distance is within a range extending up to about 5 centimeters. However, in other embodiments, the second prescribed distance can be greater than about 5 centimeters. In some embodiments, the axis of rotation 212A is positioned to be at (sufficiently aligned with) or inferior/distal to an axis of the right hip joint of the person to ensure that a proper downward force (toward the platform 201) is exerted on the right leg of the person as the right leg armature 212 is raised in the direction of arrow 223, by rotation of the right leg armature 212 about the axis of rotation 212A. The right leg armature 212 and the position of the axis of rotation 212A of the right leg armature 212 relative to the axis of the right hip joint of the person are collectively configured to apply a downward force to a right hip of the person as the right leg armature 212 is rotated to lift the right leg of the person. Also, in some embodiments, the axis of rotation 212A of the right leg armature 212 is positioned relative to the axis of the right hip joint of the person so that as the right leg armature 212 is rotated upward about the axis of rotation 212A, the downward force applied to the right hip of the person by the right leg armature 212 increases. The axis of rotation 212A of the right leg armature 212 is positioned at a location proximate to the right side 201R of the platform 201 and between the pelvic restraint 203 and the tail end 201T of the platform 201. The right leg armature 212 is configured to lift a right leg of the person while maintaining a substantially full extension of a right knee of the person. The right leg armature 212 is configured to rotate within a plane substantially perpendicular to the platform, as indicated by arrow 223. In some embodiments, the axis of rotation 212A of the right leg armature 212 is oriented to provided for rotational movement of the right leg armature 212 within a substantially vertical plane.

In some embodiments, the position of the axis of rotation 204A of the left leg armature 204 is adjustable in the length (L) direction, parallel to a midline 202 of the platform 201. The midline 202 of the platform 201 extends between the head end 201H of the platform 201 and the tail end 201T of the platform 201 at a location substantially equidistant between the left side 201L of the platform 201 and the right side 201R of the platform 201. And, in some embodiments, the position of the axis of rotation 212A of the right leg armature 212 is adjustable in the length (L) direction, parallel to the midline 202 of the platform 201. In some embodiments, the axis of rotation 204A of the left leg armature 204 is substantially aligned with the axis of rotation 212A of the right leg armature 212. However, in some embodiments, the axis of rotation 204A of the left leg armature 204 is not aligned with the axis of rotation 212A of the right leg armature 212. For example, if the person's pelvis is rotated in the coronal plane, it may be necessary to position the axis of rotation 204A of the left leg armature 204 and the axis of rotation 212A of the right leg armature 212 at different positions along the length (L) of the platform 201.

The nervous system stretching apparatus 200 includes a pelvic restraint 203 configured to secure hips of the person to the platform 201. In some embodiments, the pelvic restraint 203 is a belt configured to tighten toward the platform 201 and loosen away from the platform 201. The pelvic restraint 203 is configured to prevent movement of the hips of the person away from the platform 201 when either the left leg of the person is lifted by the left leg armature 204 or the right leg of the person is lifted by the right leg armature 212. In some embodiments, the pelvic restraint 203 belt includes a buckle 249 for connecting the pelvic restraint 203 belt around the pelvis of the person. The pelvic restraint 203 is positioned to extend over and contact the person at locations over and around the pelvis of the person (inferior and proximate to iliac crests of the person) when the person is in the supine position on the platform 201, with the axis of rotation 204A of the left leg armature 204 positioned at a first prescribed distance from the axis of the left hip joint of the person, e.g., inferior/distal to the axis of the left hip joint of the person, and with the axis of rotation 212A of the right leg armature 212 positioned at a second prescribed distance from the axis of the right hip joint of the person, e.g., inferior/distal to the axis of the right hip joint of the person.

In some embodiments, the pelvic restraint 203 is configured and positioned to extend across the platform 201 in a direction substantially parallel to both the axis of rotation 204A of the left leg armature 204 and the axis of rotation 212A of the right leg armature 212. However, in some embodiments, one or both of the axis of rotation 204A of the left leg armature 204 and the axis of rotation 212A of the right leg armature 212 can be oriented in a non-parallel orientation with respect to the direction of extension of the pelvic restraint 203 across the platform 201. In this manner, the pelvic restraint 203, the axis of rotation 204A of the left leg armature 204, and the axis of rotation 212A of the right leg armature 212 can be positioned and oriented independently as needed to fit the physical characteristics of the person.

In some embodiments, the pelvic restraint 203 is configured as a belt that extends through the platform 201 at a first location 203A just laterally outside of a left hip of the person and at a second location 203B just laterally outside of a right hip of the person. In some embodiments, the first location 203A is between the left side 201L of the platform 201 and the midline 202 of the platform 201. In some embodiments, the second location 203B is between the right side 201R of the platform 201 and the midline 202 of the platform 201. In some embodiments, one or both of the first location 203A and the second location 203B are adjustable in the width (W) direction of the platform 201 (in a direction perpendicular to the midline 202 of the platform 201). In some embodiments, one or both the first location 203A and the second location 203B are adjustable in the length (L) direction of the platform 201 (in a direction parallel to the midline 202 of the platform 201). In some embodiments, a distance between the pelvic restraint 203 belt and the axes of rotation 204A/212A of the left/right leg armatures 204/212 is adjustable in the direction parallel to the midline 202 of the platform 201.

In some embodiments, the pelvic restraint 203 belt extends under the platform 201 to one or two ratchet mechanism(s) configured to receive the pelvic restraint 203 belt and provide for tightening of the pelvic restraint 203 belt toward the platform 201 and releasing of the pelvic restraint 203 belt away from the platform 201. The ratchet mechanism(s) are configured to draw and hold the pelvic restraint 203 belt toward the platform. In some embodiments, one ratchet mechanism is rigidly connected to either the left side 201L or the right side 201R of the platform 201. In some embodiments, one ratchet mechanism is rigidly connected to the left side 201L of the platform 201, and one ratchet mechanism is rigidly connected to the right side 201R of the platform 201. In some embodiments, the pelvic restraint 203 belt is rigidly connected to the platform 201 at one or both of the first location 203A and the second location 203B. For example, in some embodiments, the pelvic restraint 203 belt is rigidly connected to the platform 201 at the first location 203A, and extends through the platform 201 at the second location 203B and over to a ratchet mechanism rigidly connected to the right side 201R of the platform 201. Or, in some embodiments, the pelvic restraint 203 belt is rigidly connected to the platform 201 at the second location 203B, and extends through the platform 201 at the first location 203A and over to a ratchet mechanism rigidly connected to the left side 201L of the platform 201. Or, in some embodiments, the pelvic restraint 203 belt is rigidly connected to the platform 201 at both the first location 203A and the second location 203B of the platform 201.

In some embodiments, the pelvic restraint 203 has a width of at least 1 inch. In some embodiments, the pelvic restraint 203 is configured to have a width within a range extending from about 1 inches to about 3 inches, or within a range extending from about 2 inches to about 3 inches, or within a range extending from about 2 inches to about 2.5 inches. In some embodiments, the pelvic restraint 203 is substantially non-stretchable. In some embodiments, the pelvic restraint 203 can be formed of a single material, such as rubber, nylon, cotton, vinyl, polypropylene, hemp, among others. In some embodiments, the pelvic restraint 203 can be configured to provide increased comfort to the person. For example, in some embodiments, the pelvic restraint 203 can be formed to have multiple layers of material, with one or more layers of material closer to the person having increased softness relative to one or more other layers of material farther away from the person. More specifically, in some embodiments, one or more layers of the pelvic restraint 203 that are positioned closer to the person can be formed of material having a smaller modulus of elasticity, such as foam, rubber, gel, among others, whereas one or more layers of the pelvic restraint 203 that are positioned farther from the person can be formed of material having a larger modulus of elasticity, such as nylon, cotton, vinyl, polypropylene, hemp, among others. Also, in various embodiments, a padding or liner material can be placed on the patient-contacting-portions of the pelvic restraint 203. For example, in some embodiments, Valeo padding by Valeo Technologies LLC, or Plastazote® foam by Zotefoams plc, or foam rubber padding, or other similar material, can be placed on the portions of pelvic restraint 203 that contact the person.

The left leg armature 204 includes a support arm 205 that extends from the connection mechanism 207 to a distal end of the left leg armature 204. The support arm 205 is configured to engage with the connection mechanism 207, such that the support arm 205 is rotatable about the axis of rotation 204A of the left leg armature 204. The support arm 205 has sufficient mechanical strength to provide for lifting of the left leg of the person, by rotation of the support arm 205 about the axis of rotation 204A, with minimal or no deflection of the support arm 205. In various embodiments, the support arm 205 is formed of steel, stainless steel, aluminum, or other metal or metal alloy. In some embodiments, the support arm 205 is formed of high-strength plastic or polymer material. In some embodiments, the support arm 205 is formed of carbon-fiber material. In some embodiments, the support arm 205 is formed of wood.

The left leg armature 204 includes a left thigh clamp 209 configured to contact an anterior side of a left thigh of the person so as to hold the left knee of the person in substantially full extension when the left leg of the person is secured within the left leg armature 204. In some embodiments, a position of the left thigh clamp 209 is adjustable along the left leg armature 204 in the directions toward and away from the platform 201. One or two degrees of escape in the left knee joint will give the person a false sense of stretching without actually stretching the nerves. The left thigh clamp 209 is configured to prevent the left knee joint from bending in a way that would allow the nerves to escape from the stretching.

In some embodiments, the left thigh clamp 209 is configured to release when too much pressure is applied to the left thigh clamp 209 by the left leg in order to safeguard the ligaments in the left knee from being over stretched. In some embodiments, the left thigh clamp 209 includes an overpressure release mechanism configured to release the left thigh clamp 209 in a direction away from the anterior surface of the left thigh of the person when a pressure applied to the left thigh clamp 209 by the left thigh of the person exceeds a set threshold pressure. In some embodiments, the left thigh clamp 209 includes a toggle clamp that allows for setting of a resistance at which the left thigh clamp 209 will release. In some embodiments, the left thigh clamp 209 includes one or more springs configured and positioned to provide for limited movement of the left thigh clamp 209 in the direction away from the anterior surface of the left thigh of the person without activation of the overpressure release mechanism of the left thigh clamp 209. For example, in some embodiments, the left thigh clamp 209 is mounted on springs, or spring-like material, to provide an additional safeguard against damaging the ligaments in the left knee of the person as the left leg is raised by the left leg armature 204.

In some embodiments, patient contacting portions of the left thigh clamp 209 are formed of a foam material, such as a polyurethane foam material or a polyethylene foam material. In some embodiments, the foam material used to form the patient contacting portions of the left thigh clamp 209 has a density within a range extending from about 3 pounds per cubic foot (lb/ft³) to about 10 lb/ft³, or has a density of about 6 lb/ft³. In some embodiments, patient contacting portions of the left thigh clamp 209 can be formed to have a semi-rigid or rigid inner core of foam (such as polyurethane or polyethylene foam) with an outer layer of orthotic material over surface(s) to contact the patient. For example, in some embodiments, the outer layer of orthotic material may be formed of a thermoplastic closed-cell foam, such as AliPlast™ 4E provided by AliMed, Inc., or Volara Type S provided by Sekisui Voltek, LLC, other similar material.

The left leg armature 204 includes a left leg engagement mechanism 211 positioned near a distal end of the left leg armature 204, where the distal end of the left leg armature 204 is an end of the left leg armature 204 farthest from the axis of rotation 204A of the left leg armature 204. In some embodiments, a position of the left leg engagement mechanism 211 is adjustable along the left leg armature 204, e.g., adjustable along the support arm 205. The left leg engagement mechanism 211 is configured to engage a posterior surface of the left leg of the person at a location inferior to the left knee of the person along either the left leg, the left ankle, or the left heel of the person. In some embodiments, the left leg engagement mechanism 211 is configured as a strap component that extends around the posterior surface of the left leg of the person at the location inferior to the left knee of the person along either the left leg, the left ankle, or the left heel of the person. In some embodiments, the left leg engagement mechanism 211 includes either a rigid component (e.g., metal, plastic, wood, etc.) or a flexible component (e.g., rubber, plastic, textile, etc.) configured to engage the posterior surface of the left leg of the person at the location inferior to the left knee of the person along either the left leg, the left ankle, or the left heel of the person. In some embodiments, an outer layer of orthotic material can be disposed over portions of the left leg engagement mechanism 211 that contact the person. For example, in some embodiments, the outer layer of orthotic material of the left leg engagement mechanism 211 may be formed of a thermoplastic closed-cell foam, such as AliPlast™ 4E provided by AliMed, Inc., or Volara Type S provided by Sekisui Voltek, LLC, other similar material. The left leg engagement mechanism 211 is configured to move in conjunction with rotational movement of the left leg armature 204 about the axis of rotation 204A of the left leg armature 204. The left leg engagement mechanism 211 is configured to apply a force to the left leg of the person in conjunction with rotational movement of the left leg armature 204 in the direction 221 about the axis of rotation 204A of the left leg armature 204.

The right leg armature 212 includes a support arm 213 that extends from the connection mechanism 215 to a distal end of the right leg armature 212. The support arm 213 is configured to engage with the connection mechanism 215, such that the support arm 213 is rotatable about the axis of rotation 212A of the right leg armature 212. The support arm 213 has sufficient mechanical strength to provide for lifting of the right leg of the person, by rotation of the support arm 213 about the axis of rotation 212A, with minimal or no deflection of the support arm 213. In various embodiments, the support arm 213 is formed of steel, stainless steel, aluminum, or other metal or metal alloy. In some embodiments, the support arm 213 is formed of high-strength plastic or polymer material. In some embodiments, the support arm 213 is formed of carbon-fiber material. In some embodiments, the support arm 213 is formed of wood.

The right leg armature 212 includes a right thigh clamp 217 configured to contact an anterior side of a right thigh of the person so as to hold the right knee of the person in substantially full extension when the right leg of the person is secured within the right leg armature 212. In some embodiments, a position of the right thigh clamp 217 is adjustable along the right leg armature 212 in the directions toward and away from the platform 201. One or two degrees of escape in the right knee joint will give the person a false sense of stretching without actually stretching the nerves. The right thigh clamp 217 is configured to prevent the right knee joint from bending in a way that would allow the nerves to escape from the stretching.

In some embodiments, the right thigh clamp 217 is configured to release when too much pressure is applied to the right thigh clamp 217 by the right leg in order to safeguard the ligaments in the right knee from being over stretched. In some embodiments, the right thigh clamp 217 includes an overpressure release mechanism configured to release the right thigh clamp 217 in a direction away from the anterior surface of the right thigh of the person when a pressure applied to the right thigh clamp 217 by the right thigh of the person exceeds a set threshold pressure. In some embodiments, the right thigh clamp 217 includes a toggle clamp that allows for setting of a resistance at which the right thigh clamp 217 will release. In some embodiments, the right thigh clamp 217 includes one or more springs configured and positioned to provide for limited movement of the right thigh clamp 217 in the direction away from the anterior surface of the right thigh of the person without activation of the overpressure release mechanism of the right thigh clamp 217. For example, in some embodiments, the right thigh clamp 217 is mounted on springs, or spring-like material, to provide an additional safeguard against damaging the ligaments in the right knee of the person as the right leg is raised by the right leg armature 212.

In some embodiments, patient contacting portions of the right thigh clamp 217 are formed of a foam material, such as a polyurethane foam material or a polyethylene foam material. In some embodiments, the foam material used to form the patient contacting portions of the right thigh clamp 217 has a density within a range extending from about 3 pounds per cubic foot (lb/ft³) to about 10 lb/ft³, or has a density of about 6 lb/ft³. In some embodiments, patient contacting portions of the right thigh clamp 217 can be formed to have a semi-rigid or rigid inner core of foam (such as polyurethane or polyethylene foam) with an outer layer of orthotic material over surface(s) to contact the patient. For example, in some embodiments, the outer layer of orthotic material may be formed of a thermoplastic closed-cell foam, such as AliPlast™ 4E provided by AliMed, Inc., or Volara Type S provided by Sekisui Voltek, LLC, other similar material.

The right leg armature 212 includes a right leg engagement mechanism 219 positioned near a distal end of the right leg armature 212, where the distal end of the right leg armature 212 is an end of the right leg armature 212 farthest from the axis of rotation 212A of the right leg armature 212. In some embodiments, a position of the right leg engagement mechanism 219 is adjustable along the right leg armature 212, e.g., adjustable along the support arm 213. The right leg engagement mechanism 219 is configured to engage a posterior surface of the right leg of the person at a location inferior to the right knee of the person along either the right leg, the right ankle, or the right heel of the person. In some embodiments, the right leg engagement mechanism 219 is configured as a strap component that extends around the posterior surface of the right leg of the person at the location inferior to the right knee of the person along either the right leg, the right ankle, or the right heel of the person. In some embodiments, the right leg engagement mechanism 219 includes either a rigid component (e.g., metal, plastic, wood, etc.) or a flexible component (e.g., rubber, plastic, textile, etc.) configured to engage the posterior surface of the right leg of the person at the location inferior to the right knee of the person along either the right leg, the right ankle, or the right heel of the person. In some embodiments, an outer layer of orthotic material can be disposed over portions of the right leg engagement mechanism 219 that contact the person. For example, in some embodiments, the outer layer of orthotic material of the right leg engagement mechanism 219 may be formed of a thermoplastic closed-cell foam, such as AliPlast™ 4E provided by AliMed, Inc., or Volara Type S provided by Sekisui Voltek, LLC, other similar material. The right leg engagement mechanism 219 is configured to move in conjunction with rotational movement of the right leg armature 212 about the axis of rotation 212A of the right leg armature 212. The right leg engagement mechanism 219 is configured to apply a force to the right leg of the person in conjunction with rotational movement of the right leg armature 212 in the direction 223 about the axis of rotation 212A of the right leg armature 212.

Various mechanisms can be implemented to lift and hold the left leg armature 204 and the right leg armature 212 in the directions 221 and 223, respectively. In some embodiments, a left lifting mechanism is configured to apply a lifting force to the left leg armature 204 and hold the left leg armature 204 at an elevated position. Similarly, in some embodiments, a right lifting mechanism is configured to apply a lifting force to the right leg armature 212 and hold the right leg armature 212 at an elevated position. In some embodiments, the left lifting mechanism and the right lifting mechanism are independently operable.

In some embodiments, each of the left lifting mechanism and the right lifting mechanism is respectively configured as a system that includes pulleys, rope, and a rope holding device. The pulleys of the left lifting mechanism provide mechanical advantage to allow the person being stretched to apply sufficient force to the rope to raise the left leg armature 204 in the direction 221. Similarly, the pulleys of the right lifting mechanism provide mechanical advantage to allow the person being stretched to apply sufficient force to the rope to raise the right leg armature 212 in the direction 223. In some embodiments, the left lifting mechanism includes a first block and tackle assembly and a first rope extending through the first block and tackle assembly, and the right lifting mechanism includes a second block and tackle assembly and a second rope extending through the second block and tackle assembly. In some embodiments, the block and tackle assemblies of the left lifting mechanism and the right lifting mechanism, respectively, can be arranged as gun tackle, luff tackle, double tackle, gyn tackle, threefold purchase, etc. And, in some embodiments, the block and tackle assemblies of the left lifting mechanism and right lifting mechanism, respectively, can be arranged in either a rove-to-advantage configuration or a rove-to-disadvantage configuration. In various embodiments, the rope holding device of the left lifting mechanism and the right lifting mechanism, respectively, can be a rope cleat, a rope clutch, a rope cam cleat, a rope jam cleat, a rope jammer, among other rope holding devices.

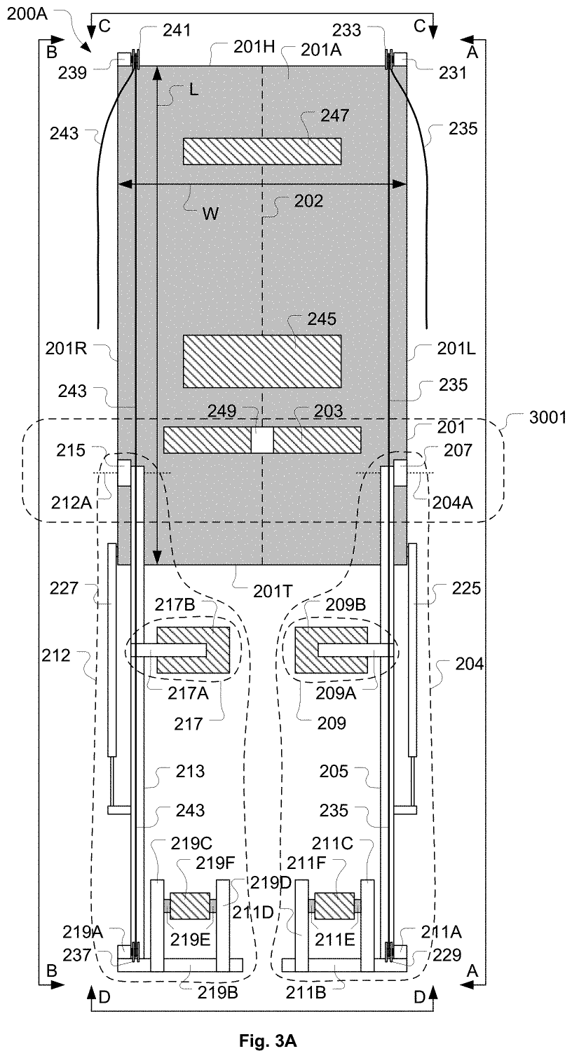

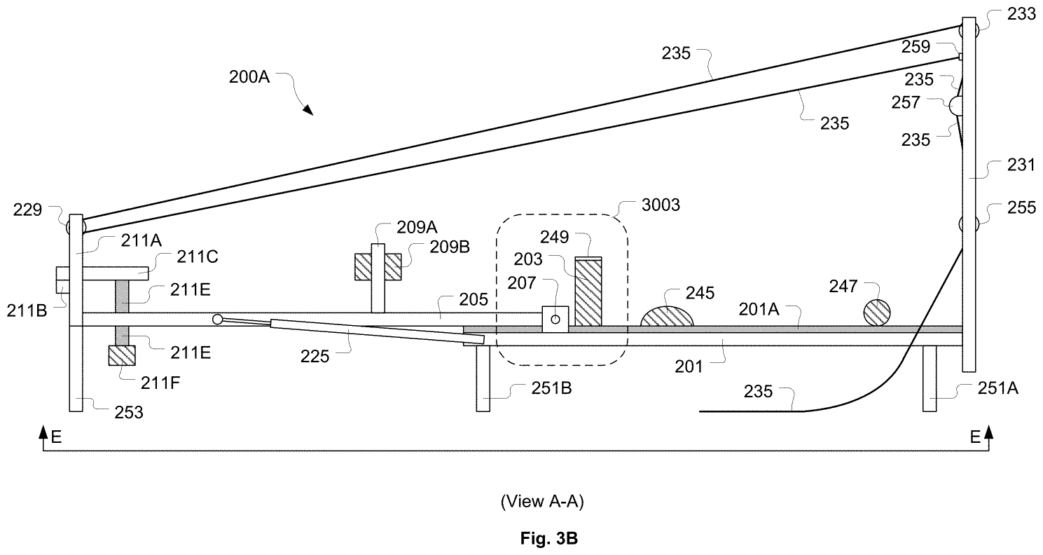

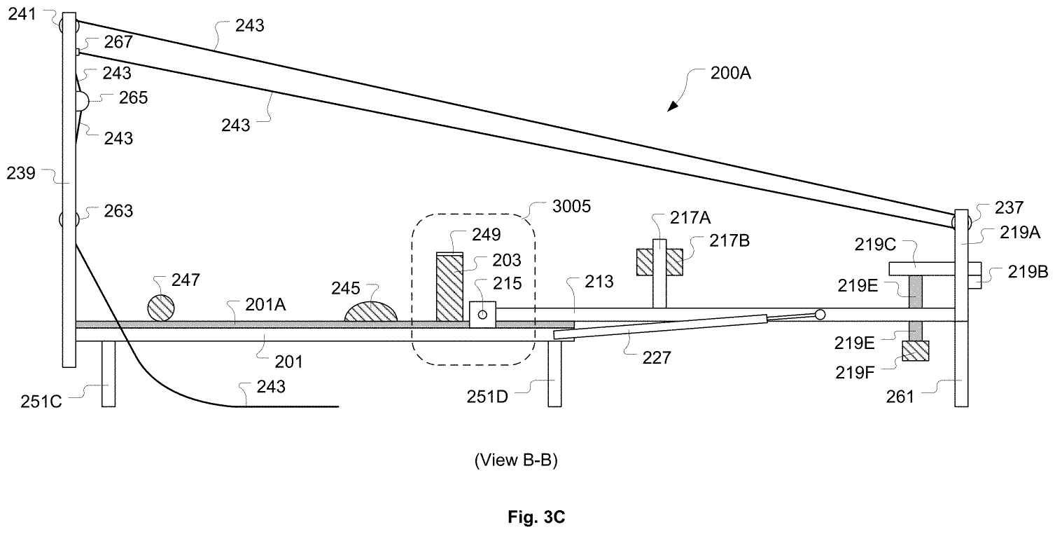

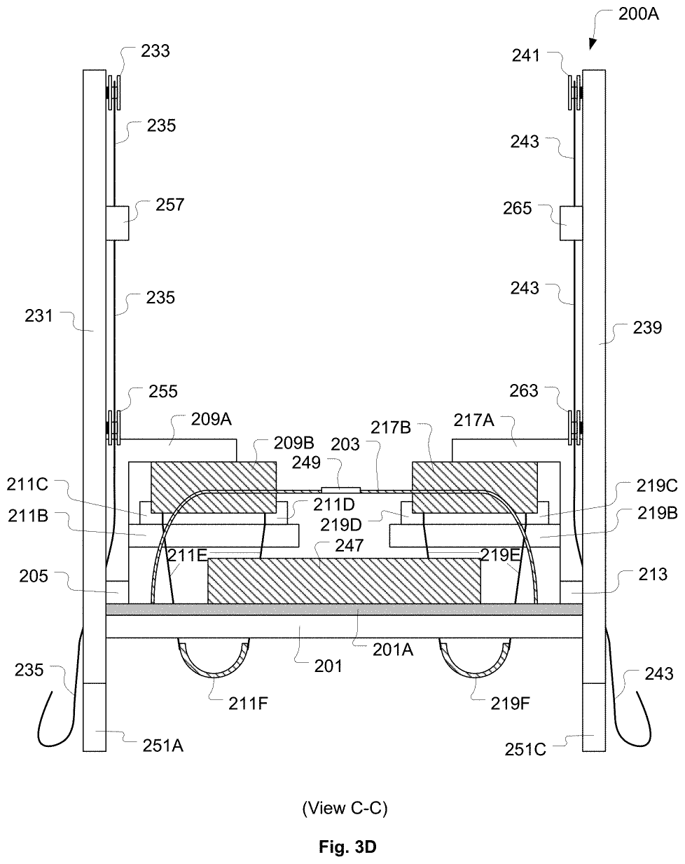

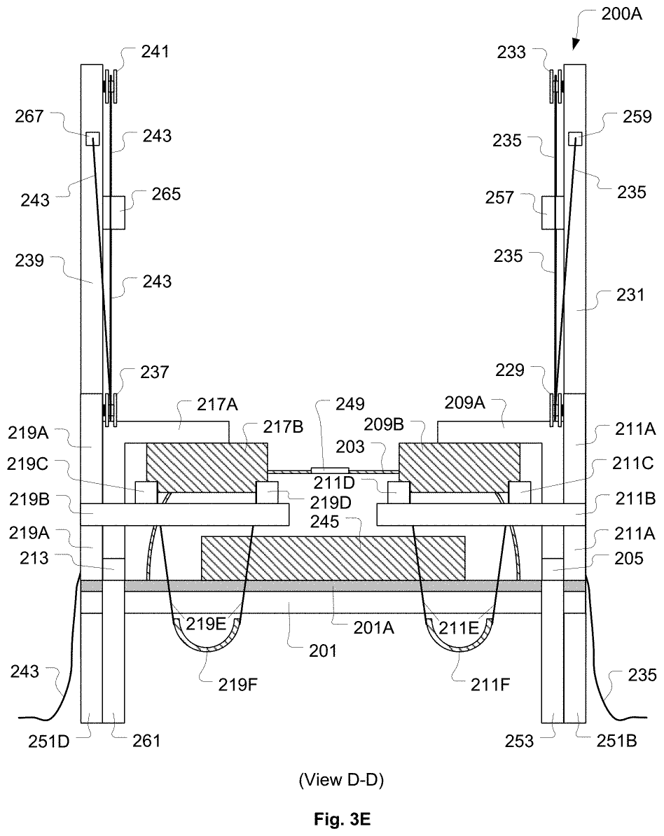

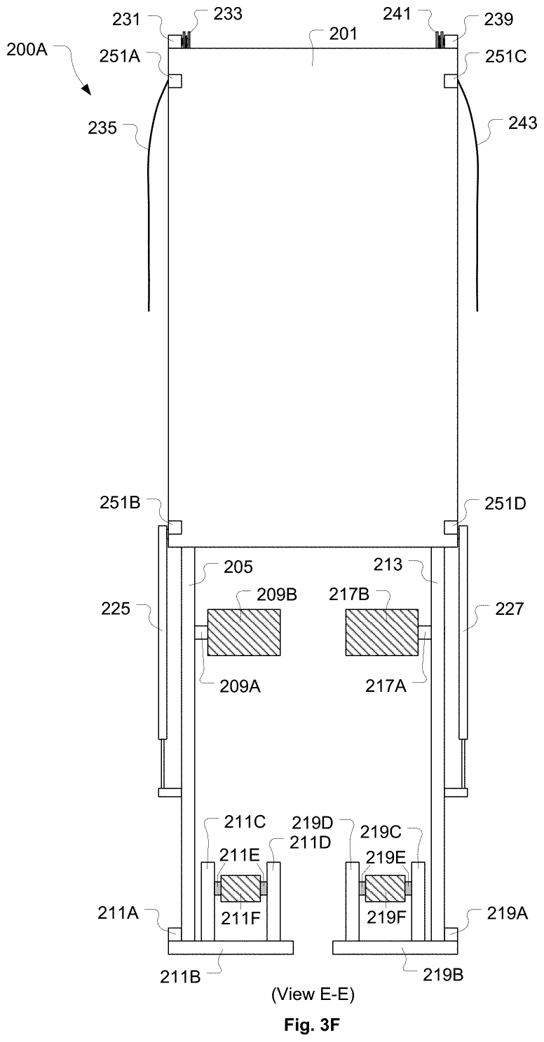

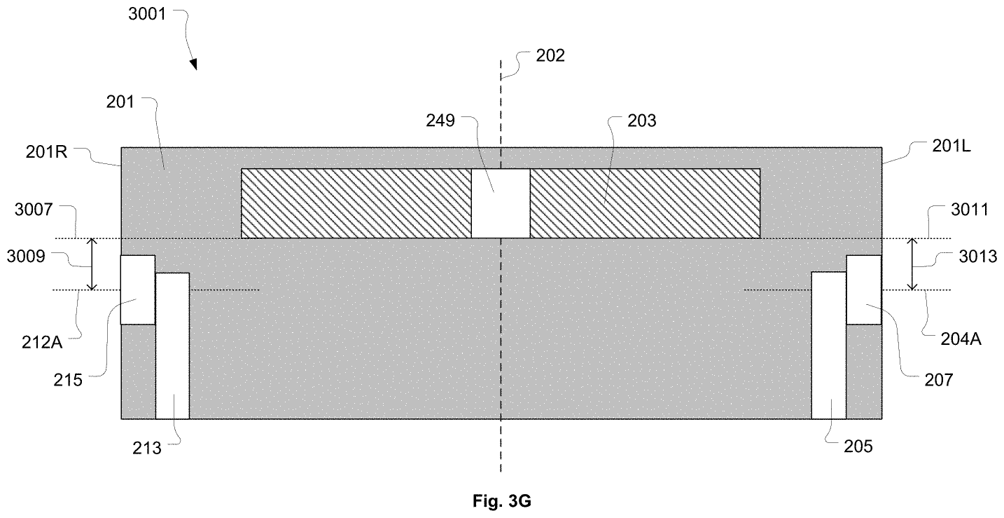

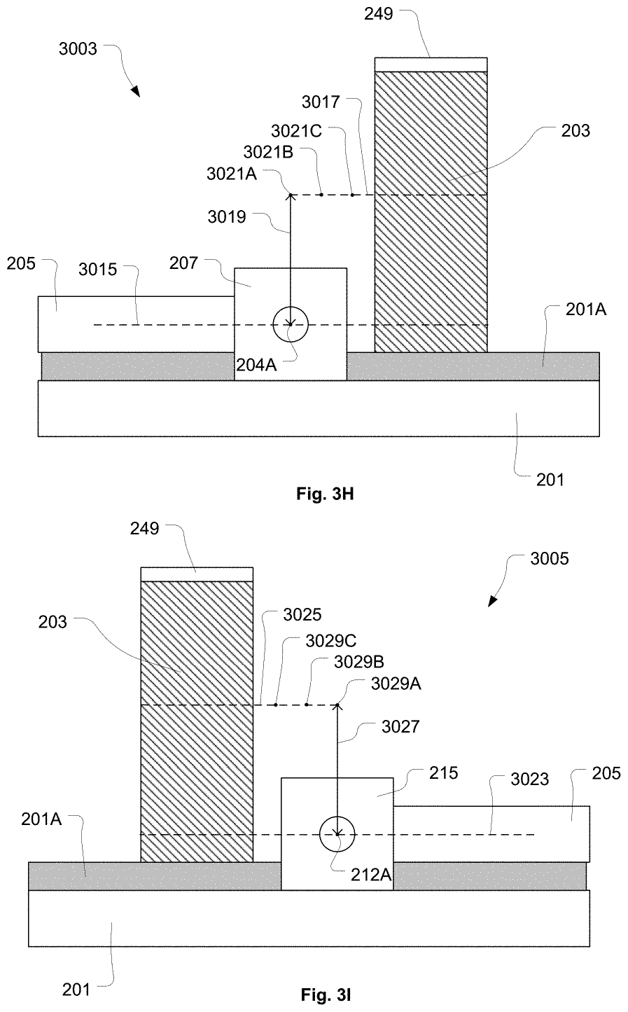

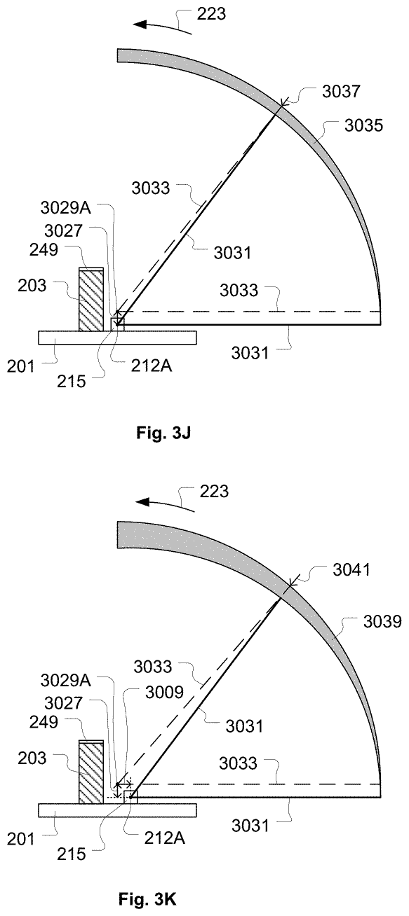

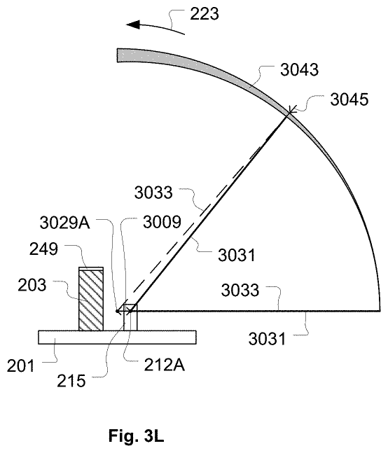

FIG. 3A shows a top view of a nervous system stretching apparatus 200A, in accordance with some embodiments of the present invention. The nervous system stretching apparatus 200A is an example implementation of the nervous system stretching apparatus 200 of FIG. 2. FIG. 3B shows a left side view of the nervous system stretching apparatus 200A (View A-A as referenced in FIG. 3A), in accordance with some embodiments of the present invention. FIG. 3C shows a right side view of the nervous system stretching apparatus 200A (View B-B as referenced in FIG. 3A), in accordance with some embodiments of the present invention. FIG. 3D shows a head end view of the nervous system stretching apparatus 200A (View C-C as referenced in FIG. 3A), in accordance with some embodiments of the present invention. FIG. 3E shows a foot end view of the nervous system stretching apparatus 200A (View D-D as referenced in FIG. 3A), in accordance with some embodiments of the present invention. FIG. 3F shows a bottom view of the nervous system stretching apparatus 200A (View E-E as referenced in FIG. 3B), in accordance with some embodiments of the present invention. FIG. 3G shows a close-up top view of the positions of the connection mechanisms 207 and 215 of the left leg armature 204 and right leg armature 212, respectively, relative to the pelvic restraint 203, corresponding to the area referenced as 3001 in FIG. 3A, in accordance with some embodiments. FIG. 3H shows a close-up side view of the position of the connection mechanism 207 of the left leg armature 204 relative to the pelvic restraint 203, corresponding to the area referenced as 3003 in FIG. 3B, in accordance with some embodiments. FIG. 3I shows a close-up side view of the position of the connection mechanism 215 of the right leg armature 212 relative to the pelvic restraint 203, corresponding to the area referenced as 3005 in FIG. 3C, in accordance with some embodiments.

The nervous system stretching apparatus 200A includes the platform 201 and a pad 201A disposed on the platform 201. The platform 201 has the length (L) and the width (W), and is bisected by the midline 202. The platform 201 also has the left side 201L, the right side 201R, the head end 201H, and the tail end 201T. The nervous system stretching apparatus 200A also includes the pelvic restraint 203. In some embodiments, the pelvic restraint 203 is configured as a belt and can include the buckle 249.

In some embodiments, a lumbar support 245 is disposed on the platform 201 at a location between the pelvic restraint 203 and the head end 201H of the platform 201. The lumbar support 245 is disposed on the platform 201 to engage a lumbar region of the person when the person is in the supine position on the platform 201, with the axis of rotation 204A of the left leg armature 204 positioned at the first prescribed distance from the axis of the left hip joint of the person, and with the axis of rotation 212A of the right leg armature 212 positioned at the second prescribed distance from the axis of the right hip joint of the person. In some embodiments, the lumbar support 245 is configured to create a forced lordosis of a lumbar spinal region of the person and/or of a thoracolumbar spinal region of the person. In some embodiments, the lumbar support 245 has a thickness as measured perpendicular to the top surface of the platform 201 within a range extending from about 0.5 inch to about 4 inches. In other embodiments, the thickness of the lumbar support 245 is greater than about 4 inches. In some embodiments, the lumbar support 245 has a height as measured in a direction extending perpendicularly between the head end 201H of the platform 201 and the tail end 201T of the platform 201 within a range extending from about 3 inches to about 6 inches. In other embodiments, the height of the lumbar support 245 is either less than about 3 inches or greater than about 6 inches. In some embodiments, a distance between the pelvic restraint 203 and an edge of the lumbar support 245 closest to the pelvic restraint 203 is measured in the direction extending perpendicularly between the head end 201H and the tail end 201T of the platform 201 and is within a range extending from about 3 inches to about 12 inches. In other embodiments, the distance between the edge of the lumbar support 245 and the pelvic restraint 203 is less than about 3 inches.

In some embodiments, a neck support 247 is disposed on the platform 201 at a location near a head end 201H of the platform 201. The neck support 247 is disposed on the platform 201 to engage a posterior neck region of the person when the person is in the supine position on the platform 201, with the axis of rotation 204A of the left leg armature 204 positioned at the first prescribed distance from the axis of the left hip joint of the person, and with the axis of rotation 212A of the right leg armature 212 positioned at the second prescribed distance from the axis of the right hip joint of the person. In some embodiments, the neck support 247 is configured to support a lordosis of a neck spinal region of the person. In some embodiments, the neck support 247 is configured to force an upper cervical flexion and/or cervical flexion of a spine of the person. In some embodiments, the neck support 247 disposed on the platform 201 has a thickness as measured perpendicular to a top surface of the platform 201 within a range extending from about 0.5 inch to about 3 inches. In some embodiments, the neck support 247 disposed on the platform has a height as measured in a direction extending perpendicularly between the head end 201H of the platform 201 and the tail end 201T of the platform 201 within a range extending from about 1 inch to about 3 inches. In some embodiments, the neck support 247 disposed on the platform 201 has a width as measured perpendicularly between the left side 201L of the platform 201 and the right side 201R of the platform 201 within a range extending from about 3 inches to about 12 inches. Also, in some embodiments, the thickness of the neck support 247 is adjustable when the neck support 247 is disposed to engage the posterior neck region of the person.

In some embodiments, a number of support structures are attached to the platform 201 to support the platform 201 at an elevated vertical position above a floor. In some embodiments, at least three support structures are attached to the platform 201. In some embodiments, at least four support structures are attached to the platform 201. For example, a support structure 251A is connected to the platform 201 at a location near the left side 201L and head end 201H of the platform 201. And, a support structure 251B is connected to the platform 201 at a location near the left side 201L and tail end 201T of the platform 201. And, a support structure 251C is connected to the platform 201 at a location near the right side 201R and head end 201H of the platform 201. And, a support structure 251D is connected to the platform 201 at a location near the right side 201R and tail end 201T of the platform 201. Each of the support structures 251A, 251B, 251C, and 251D are configured to support the platform 201 at the elevated vertical position above the floor. In some embodiments, the support structures 251A, 251B, 251C, and 251D are formed of tubing material. In some embodiments, the support structures 251A, 251B, 251C, and 251D are formed of solid material, such as metal, wood, or plastic, among other materials.

Also, in some embodiments, the left leg armature 204 includes a support structure 253 configured to support the left leg armature 204 in a resting position above the floor at which the left leg armature 204 is substantially parallel to the platform 201, e.g., at which the left leg armature 204 is in a substantially parallel orientation with respect to the left side 201L of the platform 201. In some embodiments, the right leg armature 212 includes a support structure 261 configured to support the right leg armature 212 in a resting position above the floor at which the right leg armature 212 is substantially parallel to the platform 201, e.g., at which the right leg armature 212 is in a substantially parallel orientation with respect to the right side 201R of the platform 201. In some embodiments, the support structures 253 and 261 are formed of tubing material. In some embodiments, the support structures 253 and 261 are formed of solid material, such as metal, wood, or plastic, among other materials.

The nervous system stretching apparatus 200A includes the left leg armature 204 rotatably connected to the platform 201 by the connection mechanism 207. The left leg armature 204 includes the support arm 205 that extends from the connection mechanism 207 to the distal end of the left leg armature 204. The left leg armature 204 is configured to rotate vertically upward about the axis of rotation 204A of the left leg armature 204. In some embodiments, a gas spring 225, or similar device, is connected to the support arm 205 and to the platform 201. The gas spring 225 is configured and positioned to provide mechanical assistance with controlled upward rotation of the left leg armature 204 about the axis of rotation 204A to an elevated position, with holding of the left leg armature 204 at the elevated position, and with controlled downward rotation of the left leg armature 204 about the axis of rotation 204A to the resting position.

In the nervous system stretching apparatus 200A, the left leg armature 204 includes the left thigh clamp 209 configured to contact the anterior side of the left thigh of the person so as to hold the left knee of the person in substantially full extension when the left leg of the person is secured within the left leg armature 204. In the nervous system stretching apparatus 200A, the left thigh clamp 209 includes a support and clamping structure 209A and a contacting member 209B. The support and clamping structure 209A is connected to the support arm 205. The support and clamping structure 209A is configured to enable clamping of the contacting member 209B toward and against the anterior surface of the left thigh of the person at a location superior to the left knee of the person.

In some embodiments, the support and clamping structure 209A includes a quick-release toggle clamp that allows for rotation of the contacting member 209B downward toward the left leg of the person to a locked position, and that allows for rotation of the contacting member 209B upward away from the left leg of the person to a released position. In some embodiments, the quick-release toggle clamp of the support and clamping structure 209A is configured to automatically release upward away from the left leg of the person when a threshold force is exerted on the contacting member 209B by the left leg of the person. In these embodiments, the threshold force is set to protect the ligaments of the left knee of the person as the left leg armature 204 is raised. Also, in some embodiments, the support and clamping structure 209A includes a number of springs, or spring-like material(s), configured and positioned to provide the contacting member 209B with a limited amount of resisted movement upward away from the left leg of the person when the contacting member 209B is exposed to force that is less than the threshold force at which the quick-release toggle clamp automatically releases. In some embodiments, the contacting member 209B is formed of a foam material, as discussed above with regard to the patient contacting portions of the left thigh clamp 209 of FIG. 2.

In the nervous system stretching apparatus 200A, the left leg armature 204 includes the left leg engagement mechanism 211 positioned near the distal end of the left leg armature 204. In the nervous system stretching apparatus 200A, the left leg engagement mechanism 211 includes a stanchion member 211A rigidly connected to the support arm 205. In some embodiments, the stanchion member 211A is oriented substantially perpendicular to the support arm 205. The stanchion member 211A has sufficient mechanical strength to provide for lifting of the left leg armature 204 by application of force to the stanchion member 211A, with minimal or no deflection of the stanchion member 211A. In some embodiments, the stanchion member 211A is formed of tube material. In various embodiments, the stanchion member 211A is formed of steel, stainless steel, aluminum, or other metal or metal alloy. In some embodiments, the stanchion member 211A is formed of high-strength plastic or polymer material. In some embodiments, the stanchion member 211A is formed of carbon-fiber material. In some embodiments, the stanchion member 211A is formed of wood.

In the nervous system stretching apparatus 200A, the left leg engagement mechanism 211 includes a left foot plate 211B rigidly connected to the stanchion member 211A. In some embodiments, the left foot plate 211B is oriented substantially perpendicular to the stanchion member 211A. In this manner, in some embodiments, the left foot plate 211B is substantially horizontal when the stanchion member 211A is substantially vertical. The left foot plate 211B is configured to contact a bottom of a left foot of the person when the left leg of the person is secured within the left leg armature 204 with the left knee of the person in substantially full extension. In some embodiments, the left foot plate 211B is positioned to prevent plantar flexion of the left foot of the person. In some embodiments, the left foot plate 211B is positioned to maintain the left foot of the person in dorsiflexion. The left foot plate 211B has sufficient mechanical strength to resist downward movement of the left foot of the person, with minimal or no deflection of the left foot plate 211B. In some embodiments, the left foot plate 211B is formed of tube material. In various embodiments, the left foot plate 211B is formed of steel, stainless steel, aluminum, or other metal or metal alloy. In some embodiments, the left foot plate 211B is formed of high-strength plastic or polymer material. In some embodiments, the left foot plate 211B is formed of carbon-fiber material. In some embodiments, the left foot plate 211B is formed of wood.

In the nervous system stretching apparatus 200A, the left leg engagement mechanism 211 includes an outer cantilever member 211C rigidly connected to the left foot plate 211B, and an inner cantilever member 211D rigidly connected to the left foot plate 211B. In some embodiments, the outer cantilever member 211C and the inner cantilever member 211D are connected to a top surface of the left foot plate 211B. However, in some embodiments, each of the outer cantilever member 211C and the inner cantilever member 211D can be connected to one or more of a top surface, a bottom surface, and a side surface of the left foot plate 211B. In some embodiments, each of the outer cantilever member 211C and the inner cantilever member 211D is oriented substantially perpendicular to the left foot plate 211B and substantially parallel to the support arm 205. In this manner, in some embodiments, each of the outer cantilever member 211C and the inner cantilever member 211D is substantially horizontal when the left foot plate 211B is substantially horizontal and the support arm 205 is substantially horizontal. In some embodiments, each of the outer cantilever member 211C and the inner cantilever member 211D is configured to extend from the left foot plate 211B toward the platform 201 by a distance that is sufficient for each of the outer cantilever member 211C and the inner cantilever member 211D to extend past the left ankle of the person when the bottom of the left foot of the person is positioned against the left foot plate 211B.

Each of the outer cantilever member 211C and the inner cantilever member 211D has sufficient mechanical strength to support lifting of the left leg of the person as the left leg armature 204 is rotated upward, with minimal or no deflection of the outer cantilever member 211C and the inner cantilever member 211D. In some embodiments, each of the outer cantilever member 211C and the inner cantilever member 211D is formed of tube material. In various embodiments, each of the outer cantilever member 211C and the inner cantilever member 211D is formed of steel, stainless steel, aluminum, or other metal or metal alloy. In some embodiments, each of the outer cantilever member 211C and the inner cantilever member 211D is formed of high-strength plastic or polymer material. In some embodiments, each of the outer cantilever member 211C and the inner cantilever member 211D is formed of carbon-fiber material. In some embodiments, each of the outer cantilever member 211C and the inner cantilever member 211D is formed of wood.

In the nervous system stretching apparatus 200A, the left leg engagement mechanism 211 includes a strap 211E connected to each of the outer cantilever member 211C and the inner cantilever member 211D. The strap 211E is configured to extend in a U-shape between the outer cantilever member 211C and the inner cantilever member 211D, so as to form a lifting cradle for the left leg of the person. In some embodiments, the strap 211E has a width of at least 1 inch. In some embodiments, the strap 211E is configured to have a width within a range extending from about 1 inch to about 6 inches, or within a range extending from about 1 inch to about 3 inches, or within a range extending from about 1 inch to about 2 inches. In some embodiments, the strap 211E is substantially non-stretchable. In some embodiments, the strap 211E can be formed of a single material, such as rubber, nylon, cotton, vinyl, polypropylene, hemp, among others.

Also, in some embodiments, an engagement member 211F can be attached to the strap 211E, where the engagement member 211F is configured to contact and wrap around a posterior of the left leg of the person at or inferior/distal to the left knee of the person. In some embodiments, the engagement member 211F is configured to provide increased comfort to the person. For example, in some embodiments, the engagement member 211F is formed to have multiple layers of material, with one or more layers of material closer to the person having increased softness relative to one or more other layers of material farther away from the person. More specifically, in some embodiments, one or more layers of the engagement member 211F that are positioned closer to the person can be formed of material having a smaller modulus of elasticity, such as foam, rubber, gel, among others, whereas one or more layers of the engagement member 211F that are positioned farther from the person can be formed of material having a larger modulus of elasticity, such as nylon, cotton, vinyl, polypropylene, hemp, among others. Also, in various embodiments, a padding or liner material can be placed on the patient-contacting-portions of the engagement member 211F. For example, in some embodiments, Valeo padding by Valeo Technologies LLC, or Plastazote® foam by Zotefoams plc, or foam rubber padding, or other similar material, can be placed on the portions of engagement member 211F that contact the person.

The nervous system stretching apparatus 200A includes a left lifting mechanism that includes a left stanchion 231 connected to the platform 201. The left lifting mechanism includes a rope 235 having a first end connected to the left stanchion 231 at a location 259. The left lifting mechanism includes a first pulley 229 connected to the left leg armature 204. More specifically, the first pulley 229 is connected to the stanchion member 211A. The rope 235 is positioned to extend from the location 259 to and around the first pulley 229. The left lifting mechanism includes a second pulley 233 rotatably connected to the left stanchion 231. In some embodiments, the second pulley 233 is positioned at a higher elevation above the platform 201 than the first pulley 229, when the left leg armature 204 is in the resting position. The rope 235 of the left lifting mechanism is configured and positioned to extend from the first pulley 229 to and around the second pulley 233. The second pulley 233 is positioned such that rotation of the left leg armature 204 about the axis of rotation 204A of the left leg armature 204 causes a reduction in a linear distance between the first pulley 229 and the second pulley 233. The left lifting mechanism also includes a rope holding device 257 connected to the left stanchion 231. The rope 235 of the left lifting mechanism is configured and positioned to extend from the second pulley 233 to and through the rope holding device 257. The left lifting mechanism also includes a third pulley 255 rotatably connected to the left stanchion 231. The rope 235 of the left lifting mechanism is configured and positioned to extend from the rope holding device 257 to and around the third pulley 255.

A second end of the rope 235 is positioned so that the rope 235 can be grasped and pulled by the person when the person is in the supine position on the platform 201. When the person pulls on the rope 235, the left leg armature 204 rotates upward about the axis of rotation 204A, thereby lifting the left leg of the person, while the left thigh clamp 209 holds the left knee of the person in substantially full extension, and while the hips of the person are held against the platform 201 by the pelvic restraint 203, thereby providing a controlled stretching of the nervous system of the person. The person can control the amount of stretch by controlling the amount of pull on the rope 235. The person is also able to reach up and release the rope holding device 257 to allow for lowering of the left leg armature 204 to the resting position. The gas spring 225 assists with controlling the lowering the left leg armature 204 to the resting position.

In some embodiments, the left stanchion 231 is formed of tube material. In various embodiments, the left stanchion 231 is formed of steel, stainless steel, aluminum, or other metal or metal alloy. In some embodiments, the left stanchion 231 is formed of high-strength plastic or polymer material. In some embodiments, the left stanchion 231 is formed of carbon-fiber material. In some embodiments, the left stanchion 231 is formed of wood. In some embodiments, the rope holding device 257 of the left lifting mechanism is configured as a rope cleat, a rope clutch, a rope cam cleat, a rope jam cleat, a rope jammer, among other rope holding devices.

The nervous system stretching apparatus 200A includes the right leg armature 212 rotatably connected to the platform 201 by the connection mechanism 215. The right leg armature 212 includes the support arm 213 that extends from the connection mechanism 215 to the distal end of the right leg armature 212. The right leg armature 212 is configured to rotate vertically upward about the axis of rotation 212A of the right leg armature 212. In some embodiments, a gas spring 227, or similar device, is connected to the support arm 213 and to the platform 201. The gas spring 227 is configured and positioned to provide mechanical assistance with controlled upward rotation of the right leg armature 212 about the axis of rotation 212A to an elevated position, with holding of the right leg armature 212 at the elevated position, and with controlled downward rotation of the right leg armature 212 about the axis of rotation 212A to the resting position.

In the nervous system stretching apparatus 200A, the right leg armature 212 includes the right thigh clamp 217 configured to contact the anterior side of the right thigh of the person so as to hold the right knee of the person in substantially full extension when the right leg of the person is secured within the right leg armature 212. In the nervous system stretching apparatus 200A, the right thigh clamp 217 includes a support and clamping structure 217A and a contacting member 217B. The support and clamping structure 217A is connected to the support arm 213. The support and clamping structure 217A is configured to enable clamping of the contacting member 217B toward and against the anterior surface of the right thigh of the person at a location superior to the right knee of the person.

In some embodiments, the support and clamping structure 217A includes a quick-release toggle clamp that allows for rotation of the contacting member 217B downward toward the right leg of the person to a locked position, and that allows for rotation of the contacting member 217B upward away from the right leg of the person to a released position. In some embodiments, the quick-release toggle clamp of the support and clamping structure 217A is configured to automatically release upward away from the right leg of the person when a threshold force is exerted on the contacting member 217B by the right leg of the person. In these embodiments, the threshold force is set to protect the ligaments of the right knee of the person as the right leg armature 212 is raised. Also, in some embodiments, the support and clamping structure 217A includes a number of springs, or spring-like material(s), configured and positioned to provide the contacting member 217B with a limited amount of resisted movement upward away from the right leg of the person when the contacting member 217B is exposed to force that is less than the threshold force at which the quick-release toggle clamp automatically releases. In some embodiments, the contacting member 217B is formed of a foam material, as discussed above with regard to the patient contacting portions of the right thigh clamp 217 of FIG. 2.

In the nervous system stretching apparatus 200A, the right leg armature 212 includes the right leg engagement mechanism 219 positioned near the distal end of the right leg armature 212. In the nervous system stretching apparatus 200A, the right leg engagement mechanism 219 includes a stanchion member 219A rigidly connected to the support arm 213. In some embodiments, the stanchion member 219A is oriented substantially perpendicular to the support arm 213. The stanchion member 219A has sufficient mechanical strength to provide for lifting of the right leg armature 212 by application of force to the stanchion member 219A, with minimal or no deflection of the stanchion member 219A. In some embodiments, the stanchion member 219A is formed of tube material. In various embodiments, the stanchion member 219A is formed of steel, stainless steel, aluminum, or other metal or metal alloy. In some embodiments, the stanchion member 219A is formed of high-strength plastic or polymer material. In some embodiments, the stanchion member 219A is formed of carbon-fiber material. In some embodiments, the stanchion member 219A is formed of wood.

In the nervous system stretching apparatus 200A, the right leg engagement mechanism 219 includes a right foot plate 219B rigidly connected to the stanchion member 219A. In some embodiments, the right foot plate 219B is oriented substantially perpendicular to the stanchion member 219A. In this manner, in some embodiments, the right foot plate 219B is substantially horizontal when the stanchion member 219A is substantially vertical. The right foot plate 219B is configured to contact a bottom of a right foot of the person when the right leg of the person is secured within the right leg armature 212, with the right knee of the person in substantially full extension. In some embodiments, the right foot plate 219B is positioned to prevent plantar flexion of the right foot of the person. In some embodiments, the right foot plate 219B is positioned to maintain the right foot of the person in dorsiflexion. The right foot plate 219B has sufficient mechanical strength to resist downward movement of the right foot of the person, with minimal or no deflection of the right foot plate 219B. In some embodiments, the right foot plate 219B is formed of tube material. In various embodiments, the right foot plate 219B is formed of steel, stainless steel, aluminum, or other metal or metal alloy. In some embodiments, the right foot plate 219B is formed of high-strength plastic or polymer material. In some embodiments, the right foot plate 219B is formed of carbon-fiber material. In some embodiments, the right foot plate 219B is formed of wood.

In the nervous system stretching apparatus 200A, the right leg engagement mechanism 219 includes an outer cantilever member 219C rigidly connected to the right foot plate 219B, and an inner cantilever member 219D rigidly connected to the right foot plate 219B. In some embodiments, the outer cantilever member 219C and the inner cantilever member 219D are connected to a top surface of the right foot plate 219B. However, in some embodiments, each of the outer cantilever member 219C and the inner cantilever member 219D can be connected to one or more of a top surface, a bottom surface, and a side surface of the right foot plate 219B. In some embodiments, each of the outer cantilever member 219C and the inner cantilever member 219D is oriented substantially perpendicular to the right foot plate 219B and substantially parallel to the support arm 213. In this manner, in some embodiments, each of the outer cantilever member 219C and the inner cantilever member 219D is substantially horizontal when the right foot plate 219B is substantially horizontal and the support arm 213 is substantially horizontal. In some embodiments, each of the outer cantilever member 219C and the inner cantilever member 219D is configured to extend from the right foot plate 219B toward the platform 201 by a distance that is sufficient for each of the outer cantilever member 219C and the inner cantilever member 219D to extend past the right ankle of the person when the bottom of the right foot of the person is positioned against the right foot plate 219B.

Each of the outer cantilever member 219C and the inner cantilever member 219D has sufficient mechanical strength to support lifting of the right leg of the person as the right leg armature 212 is rotated upward, with minimal or no deflection of the outer cantilever member 219C and the inner cantilever member 219D. In some embodiments, each of the outer cantilever member 219C and the inner cantilever member 219D is formed of tube material. In various embodiments, each of the outer cantilever member 219C and the inner cantilever member 219D is formed of steel, stainless steel, aluminum, or other metal or metal alloy. In some embodiments, each of the outer cantilever member 219C and the inner cantilever member 219D is formed of high-strength plastic or polymer material. In some embodiments, each of the outer cantilever member 219C and the inner cantilever member 219D is formed of carbon-fiber material. In some embodiments, each of the outer cantilever member 219C and the inner cantilever member 219D is formed of wood.

In the nervous system stretching apparatus 200A, the right leg engagement mechanism 219 includes a strap 219E connected to each of the outer cantilever member 219C and the inner cantilever member 219D. The strap 219E is configured to extend in a U-shape between the outer cantilever member 219C and the inner cantilever member 219D, so as to form a lifting cradle for the right leg of the person. In some embodiments, the strap 219E has a width of at least 1 inch. In some embodiments, the strap 219E is configured to have a width within a range extending from about 1 inch to about 6 inches, or within a range extending from about 1 inch to about 3 inches, or within a range extending from about 1 inch to about 2 inches. In some embodiments, the strap 219E is substantially non-stretchable. In some embodiments, the strap 219E can be formed of a single material, such as rubber, nylon, cotton, vinyl, polypropylene, hemp, among others.

Also, in some embodiments, an engagement member 219F can be attached to the strap 219E, where the engagement member 219F is configured to contact and wrap around a posterior of the right leg of the person at or inferior/distal to the right knee of the person. In some embodiments, the engagement member 219F is configured to provide increased comfort to the person. For example, in some embodiments, the engagement member 219F is formed to have multiple layers of material, with one or more layers of material closer to the person having increased softness relative to one or more other layers of material farther away from the person. More specifically, in some embodiments, one or more layers of the engagement member 219F that are positioned closer to the person can be formed of material having a smaller modulus of elasticity, such as foam, rubber, gel, among others, whereas one or more layers of the engagement member 219F that are positioned farther from the person can be formed of material having a larger modulus of elasticity, such as nylon, cotton, vinyl, polypropylene, hemp, among others. Also, in various embodiments, a padding or liner material can be placed on the patient-contacting-portions of the engagement member 219F. For example, in some embodiments, Valeo padding by Valeo Technologies LLC, or Plastazote® foam by Zotefoams plc, or foam rubber padding, or other similar material, can be placed on the portions of engagement member 219F that contact the person.

The nervous system stretching apparatus 200A includes a right lifting mechanism that includes a right stanchion 239 connected to the platform 201. The right lifting mechanism includes a rope 243 having a first end connected to the right stanchion 239 at a location 267. The right lifting mechanism includes a first pulley 237 connected to the right leg armature 212. More specifically, the first pulley 237 is connected to the stanchion member 219A. The rope 243 is positioned to extend from the location 267 to and around the first pulley 237. The right lifting mechanism includes a second pulley 241 rotatably connected to the right stanchion 239. In some embodiments, the second pulley 241 is positioned at a higher elevation above the platform 201 than the first pulley 237, when the right leg armature 212 is in the resting position. The rope 243 of the right lifting mechanism is configured and positioned to extend from the first pulley 237 to and around the second pulley 241. The second pulley 241 is positioned such that rotation of the right leg armature 212 about the axis of rotation 212A of the right leg armature 212 causes a reduction in a linear distance between the first pulley 237 and the second pulley 241. The right lifting mechanism also includes a rope holding device 265 connected to the right stanchion 239. The rope 243 of the right lifting mechanism is configured and positioned to extend from the second pulley 241 to and through the rope holding device 265. The right lifting mechanism also includes a third pulley 263 rotatably connected to the right stanchion 239. The rope 243 of the right lifting mechanism is configured and positioned to extend from the rope holding device 265 to and around the third pulley 263.

A second end of the rope 243 is positioned so that the rope 243 can be grasped and pulled by the person when the person is in the supine position on the platform 201. When the person pulls on the rope 243, the right leg armature 212 rotates upward about the axis of rotation 212A, thereby lifting the right leg of the person, while the right thigh clamp 217 holds the right knee of the person in substantially full extension, and while the hips of the person are held against the platform 201 by the pelvic restraint 203, thereby providing a controlled stretching of the nervous system of the person. The person can control the amount of stretch by controlling the amount of pull on the rope 243. The person is also able to reach up and release the rope holding device 265 to allow for lowering of the right leg armature 212 to the resting position. The gas spring 227 assists with controlling the lowering the right leg armature 212 to the resting position.

In some embodiments, the right stanchion 239 is formed of tube material. In various embodiments, the right stanchion 239 is formed of steel, stainless steel, aluminum, or other metal or metal alloy. In some embodiments, the right stanchion 239 is formed of high-strength plastic or polymer material. In some embodiments, the right stanchion 239 is formed of carbon-fiber material. In some embodiments, the right stanchion 239 is formed of wood. In some embodiments, the rope holding device 265 of the right lifting mechanism is configured as a rope cleat, a rope clutch, a rope cam cleat, a rope jam cleat, a rope jammer, among other rope holding devices.

FIG. 3G shows a close-up top view of the positions of the connection mechanisms 207 and 215 of the left leg armature 204 and right leg armature 212, respectively, relative to the pelvic restraint 203, corresponding to the area referenced as 3001 in FIG. 3A, in accordance with some embodiments. As shown in FIG. 3G, a distance 3013 between the axis of rotation 204A of the left leg armature 204 and the lower left edge of the pelvic restraint 203 is measured a direction extending perpendicularly between the head end 201H of the platform 201 and the tail end 201T of the platform 201 (parallel to the midline 202 of the platform 201), and parallel to the top surface of the platform 201. The position of the lower left edge of the pelvic restraint 203 is shown by a dashed line 3011 in FIG. 3G that extends perpendicular to the midline 202 of the platform 201 and parallel to the top surface of the platform 201. The distance 3013 is adjustable as needed based on the anatomy of the person fitted in the therapeutic position within the nervous system stretching apparatus 200. In some embodiments, the distance 3013 is within a range extending from zero to about 3 inches. In some embodiments, the distance 3013 is within a range extending from zero to about 2 inches. In some embodiments, the distance 3013 is within a range extending from zero to about 1 inch. In some embodiments, the distance 3013 is within a range extending from zero to about 0.8 inch. In some embodiments, the distance 3013 is greater than about 3 inches. It should be understood that in most embodiments, the distance 3013 is set such that the axis of rotation 204A of the left leg armature 204 is positioned at or inferior/distal to the axis of rotation of the left hip joint of the person when the person is fitted in the therapeutic position within the nervous system stretching apparatus 200.

Also, as shown in FIG. 3G, a distance 3009 between the axis of rotation 212A of the right leg armature 212 and the lower right edge of the pelvic restraint 203 is measured a direction extending perpendicularly between the head end 201H of the platform 201 and the tail end 201T of the platform 201 (parallel to the midline 202 of the platform 201), and parallel to the top surface of the platform 201. The position of the lower right edge of the pelvic restraint 203 is shown by a dashed line 3007 in FIG. 3G that extends perpendicular to the midline 202 of the platform 201 and parallel to the top surface of the platform 201. The distance 3009 is adjustable as needed based on the anatomy of the person fitted in the therapeutic position within the nervous system stretching apparatus 200. Also, it should be understood that the distances 3009 and 3013 are independently adjustable, which allows for accommodation of a person having a pelvis that is rotated within the coronal plane. In some embodiments, the distance 3009 is within a range extending from zero to about 3 inches. In some embodiments, the distance 3009 is within a range extending from zero to about 2 inches. In some embodiments, the distance 3009 is within a range extending from zero to about 1 inch. In some embodiments, the distance 3009 is within a range extending from zero to about 0.8 inch. In some embodiments, the distance 3009 is greater than about 3 inches. It should be understood that in most embodiments, the distance 3009 is set such that the axis of rotation 212A of the left leg armature 212 is positioned at or inferior/distal to the axis of rotation of the right hip joint of the person when the person is fitted in the therapeutic position within the nervous system stretching apparatus 200.

FIG. 3H shows a close-up side view of the position of the connection mechanism 207 of the left leg armature 204 relative to the pelvic restraint 203, corresponding to the area referenced as 3003 in FIG. 3B, in accordance with some embodiments. FIG. 3H shows various locations 3021A, 3021B, and 3021C that represent various possible locations of the axis of rotation of the left hip joint of the person when the person is fitted in the therapeutic position within the nervous system stretching apparatus 200. It should be understood that the locations 3021A, 3021B, and 3021C are provided by way of example. The actual location of the axis of rotation of the left hip joint of the person can be anywhere along the dashed line 3017. However, in most embodiments, the axis of rotation of the left hip joint of the person is on the dashed line 3017 at a location superior to the axis of rotation 204A of the left leg armature 204. As shown in FIG. 3H, a vertical distance 3019 between the axis of rotation 204A of the left leg armature 204 and the vertical position of the axis of rotation of the left hip joint of the person (of the dashed line 317) is measured in a direction extending perpendicular to the top surface of the platform 201. The distance 3019 is adjustable as needed based on the anatomy of the person fitted in the therapeutic position within the nervous system stretching apparatus 200. In some embodiments, the distance 3019 is within a range extending from zero to about 3 inches. In some embodiments, the distance 3019 is within a range extending from zero to about 2 inches. In some embodiments, the distance 3019 is within a range extending from zero to about 1.5 inches. In some embodiments, the distance 3019 is within a range extending from about 1 inch to about 2 inches. In some embodiments, the distance 3019 is about 1.5 inches. In some embodiments, the distance 3019 is greater than about 3 inches. It should be understood that in most embodiments, the distance 3019 is set such that the axis of rotation 204A of the left leg armature 204 is positioned at or posterior to the axis of rotation of the left hip joint of the person when the person is fitted in the therapeutic position within the nervous system stretching apparatus 200.

FIG. 3I shows a close-up side view of the position of the connection mechanism 215 of the right leg armature 212 relative to the pelvic restraint 203, corresponding to the area referenced as 3005 in FIG. 3C, in accordance with some embodiments. FIG. 3I shows various locations 3029A, 3029B, and 3029C that represent various possible locations of the axis of rotation of the right hip joint of the person when the person is fitted in the therapeutic position within the nervous system stretching apparatus 200. It should be understood that the locations 3029A, 3029B, and 3029C are provided by way of example. The actual location of the axis of rotation of the right hip joint of the person can be anywhere along the dashed line 3025. However, in most embodiments, the axis of rotation of the right hip joint of the person is on the dashed line 3025 at a location superior to the axis of rotation 212A of the right leg armature 212. As shown in FIG. 3I, a vertical distance 3027 between the axis of rotation 212A of the right leg armature 212 and the vertical position of the axis of rotation of the right hip joint of the person (of the dashed line 3025) is measured a direction extending perpendicular to the top surface of the platform 201. The distance 3027 is adjustable as needed based on the anatomy of the person fitted in the therapeutic position within the nervous system stretching apparatus 200. In some embodiments, the distance 3027 is within a range extending from zero to about 3 inches. In some embodiments, the distance 3027 is within a range extending from zero to about 2 inches. In some embodiments, the distance 3027 is within a range extending from zero to about 1.5 inches. In some embodiments, the distance 3027 is within a range extending from about 1 inch to about 2 inches. In some embodiments, the distance 3027 is about 1.5 inches. In some embodiments, the distance 3027 is greater than about 3 inches. It should be understood that in most embodiments, the distance 3027 is set such that the axis of rotation 212A of the left leg armature 212 is positioned at or posterior to the axis of rotation of the right hip joint of the person when the person is fitted in the therapeutic position within the nervous system stretching apparatus 200.

Adjustment and tuning of the position of the axis of rotation 204A of the left leg armature 204 relative to the axis of rotation of the left hip joint of the person is done to adjust an amount of downward force that is applied to the left pelvis of the person by the left leg armature 204, as the left leg armature 204 is rotated upward in the direction indicated by arrow 221 in FIG. 2. Similarly, adjustment and tuning of the position of the axis of rotation 212A of the right leg armature 212 relative to the axis of rotation of the right hip joint of the person is done to adjust an amount of downward force that is applied to the right pelvis of the person by the right leg armature 212, as the right leg armature 212 is rotated upward in the direction indicated by arrow 223 in FIG. 2. The above-mentioned effect on downward force to the right pelvis caused by adjustment and tuning of the position of the axis of rotation 212A of the right leg armature 212 is described with regard to FIGS. 3J, 3K, and 3L. It should be understood that the effect on downward force to the left pelvis caused by adjustment and tuning of the position of the axis of rotation 204A of the left leg armature 204 is the same as described with regard to FIGS. 3J, 3K, and 3L concerning the effect on downward force to the right pelvis caused by adjustment and tuning of the position of the axis of rotation 212A of the right leg armature 212.

FIG. 3J shows a schematic side-view of rotational movement of the right leg armature 212, with the axis of rotation 212A of the right leg armature 212 positioned directly posterior to the axis of the rotation of the right hip joint of the person, in accordance with some embodiments. In the example, of FIG. 3J, the distance 3009 as shown in FIG. 3G is essentially zero, and the distance 3027 as shown in FIG. 3I is greater than zero. The right leg armature 212 is represented by the line 3031. The right leg of the person is represented by the dashed line 3033. And, the right hip joint of the person is represented by location 3029A. The gray region 3035 represents the offset between a rotational arc of the right leg armature 212 and a rotational arc of the right leg of the person if it were not constrained by the right foot plate 219B of the right leg armature. It should be understood that because the right foot of the person is constrained by the right foot plate 219B of the right leg armature 212, the right foot of the person is forced to follow the rotational arc of the right leg armature 212, rather than the more extended rotational arc of the unconstrained right leg. Therefore, the offset between the rotational arc of the right leg armature 212 and the rotational arc of the right leg of the person if it were not constrained by the right foot plate 219B of the right leg armature manifests as a downward force 3037 applied to the right pelvis of the person. The amount of offset represented by the gray region 3035 at a given rotational angle of the right leg armature 212 is proportional to the downward force 3037 applied by the right leg armature 212 to the right pelvis of the person at the given rotational angle of the right leg armature 212. In the configuration of FIG. 3J, as the right leg armature 212 is raised, the amount of offset between the rotational arcs of the right leg armature 212 and the right leg of the person (if the right leg was unconstrained) continuously increases, thereby causing a corresponding continuous increase in the downward force 3037 applied to the right pelvis of the person. It should be understood that application of the downward force 3037 to the right pelvis of the person in conjunction with, and in a synchronous manner with, upward rotation of the right leg armature 212 prevents lifting of the right hip of the person from the platform 201, where such lifting of the right hip could release nerve tension and negate the therapeutic effects of the nerve stretching exercise. Also, as the right leg armature is raised further, the nerve tension in the person becomes greater, which requires an increase in the downward force 3037 on the right pelvis of the person to prevent lifting of the right hip of the person in order to escape the nerve stretching. Therefore, the continuously increasing amount of offset between the rotational arcs of the right leg armature 212 and the right leg of the person (if the right leg was unconstrained) as the right leg armature 212 is raised serves to continuously increase the downward force applied to the right pelvis of the person as the right leg armature 212 is raised, thereby resisting the increasing nerve tension in the person as the right leg armature 212 is raised.

The offset between the rotational arcs of the right leg armature 212 and the right leg of the person (if the right leg was unconstrained) as the right leg armature 212 is raised can be adjusted/tuned by positioning the axis of rotation 212A of the right leg armature at different locations relative to the axis of rotation of the right hip joint of the person. For example, FIG. 3K shows a variation from the example of FIG. 3J in which the axis of rotation 212A of the right leg armature 212 is positioned both posterior and inferior to the right hip joint of the person, in accordance with some embodiments. In FIG. 3K, the right hip joint of the person is at location 3029A. In FIG. 3K, the distance 3027 is greater than zero, which puts the axis of rotation 212A of the right leg armature 212 posterior to the right hip joint of the person. And, in FIG. 3K, the distance 3033 is greater than zero, which puts the axis of rotation 212A of the right leg armature 212 inferior to the right hip joint of the person. The gray region 3039 represents the offset between rotational arcs of the right leg armature 212 and the right leg of the person (if the right leg was unconstrained), as the right leg armature 212 is rotated upward in the direction 223. The amount of offset represented by the gray region 3039 at a given rotational angle of the right leg armature 212 is proportional to a downward force 3041 applied to the right pelvis of the person at the given rotational angle of the right leg armature 212. Comparison of FIGS. 3K and 3J shows that positioning of the axis of rotation 212A of the right leg armature 212 both posterior to and inferior to the right hip joint of the person causes the offset between rotational arcs of the right leg armature 212 and the right leg of the person (if the right leg was unconstrained) to increase more rapidly as the right leg armature 212 is raised in the direction 223, which in turn causes the downward force on the right pelvis of the person to increase more rapidly as the right leg armature 212 is raised in the direction 223.

FIG. 3L shows a variation from the example of FIG. 3J in which the axis of rotation 212A of the right leg armature 212 is positioned inferior to the right hip joint of the person, but neither substantially posterior nor substantially anterior to the right hip joint of the person, in accordance with some embodiments. In FIG. 3L, the right hip joint of the person is at location 3029A. In FIG. 3L, the distance 3027 is essentially zero. And, in FIG. 3L, the distance 3033 is greater than zero, which puts the axis of rotation 212A of the right leg armature 212 directly inferior to the right hip joint of the person. The gray region 3043 represents the offset between rotational arcs of the right leg armature 212 and the right leg of the person (if the right leg was unconstrained), as the right leg armature 212 is rotated upward in the direction 223. The amount of offset represented by the gray region 3043 at a given rotational angle of the right leg armature 212 is proportional to a downward force 3045 applied to the right pelvis of the person at the given rotational angle of the right leg armature 212. Comparison of FIGS. 3L and 3J shows that positioning of the axis of rotation 212A of the right leg armature 212 inferior to the right hip joint of the person, but neither substantially posterior nor substantially anterior to the right hip joint of the person, causes the offset between rotational arcs of the right leg armature 212 and the right leg of the person (if the right leg was unconstrained) to increase more slowly as the right leg armature 212 is raised in the direction 223, which in turn causes the downward force on the right pelvis of the person to increase more slowly as the right leg armature 212 is raised in the direction 223.

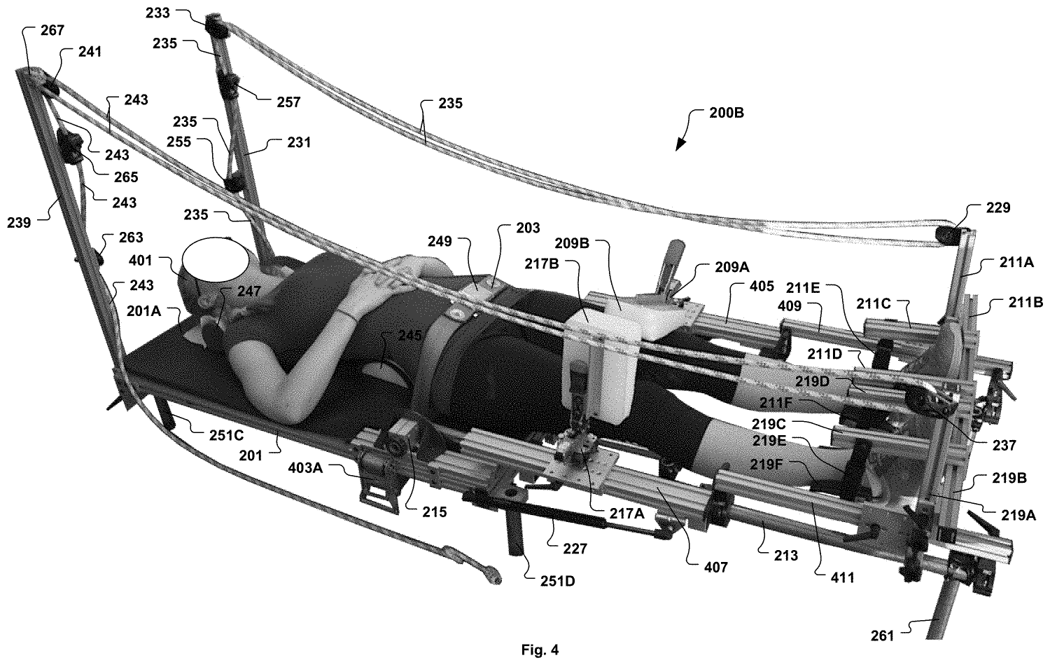

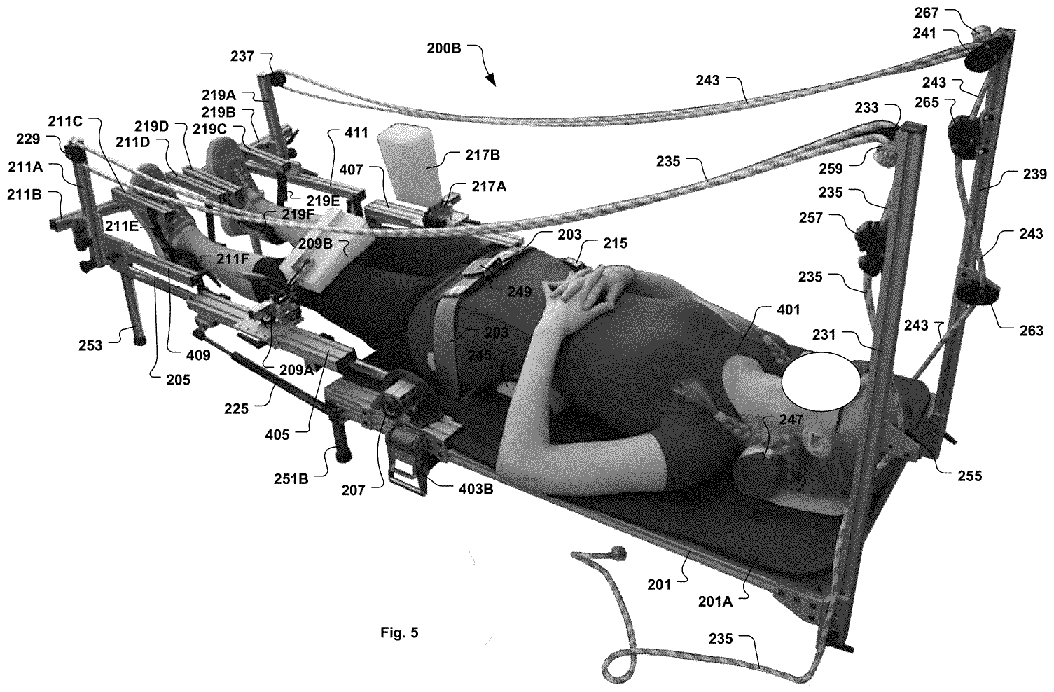

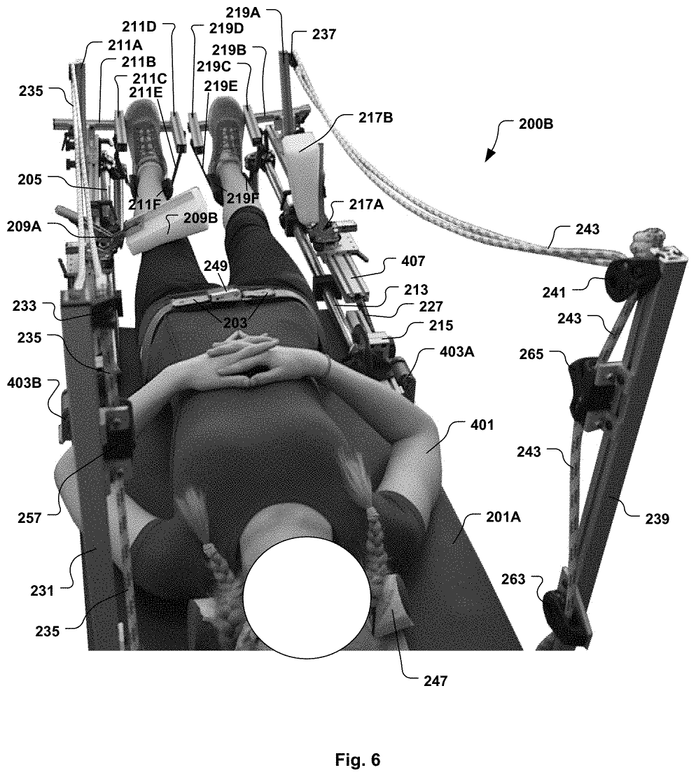

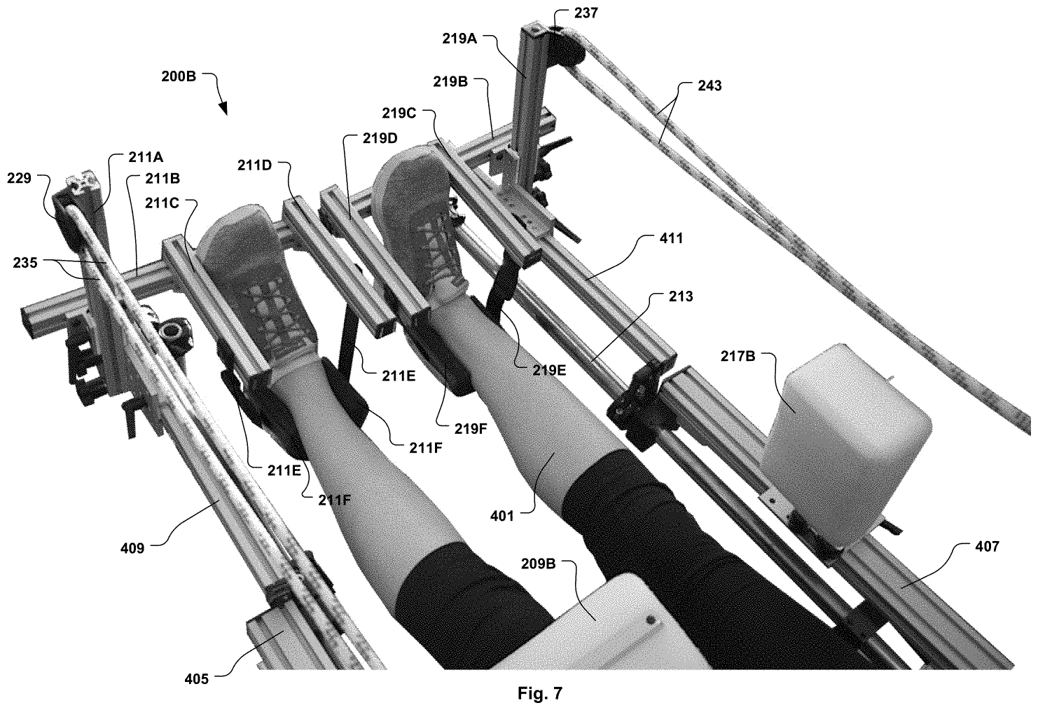

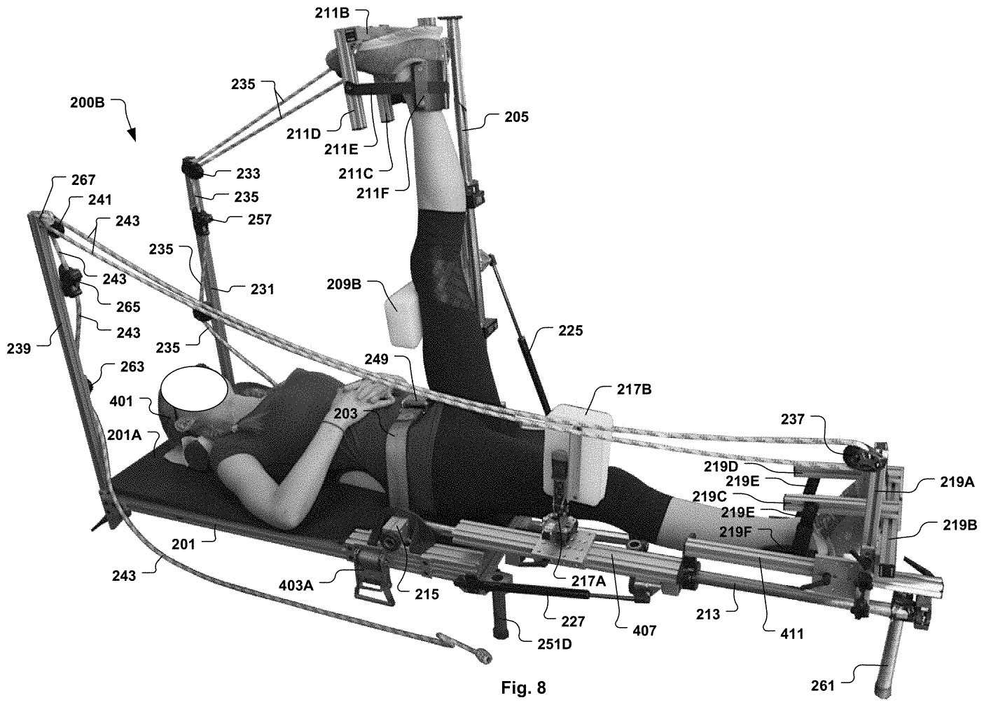

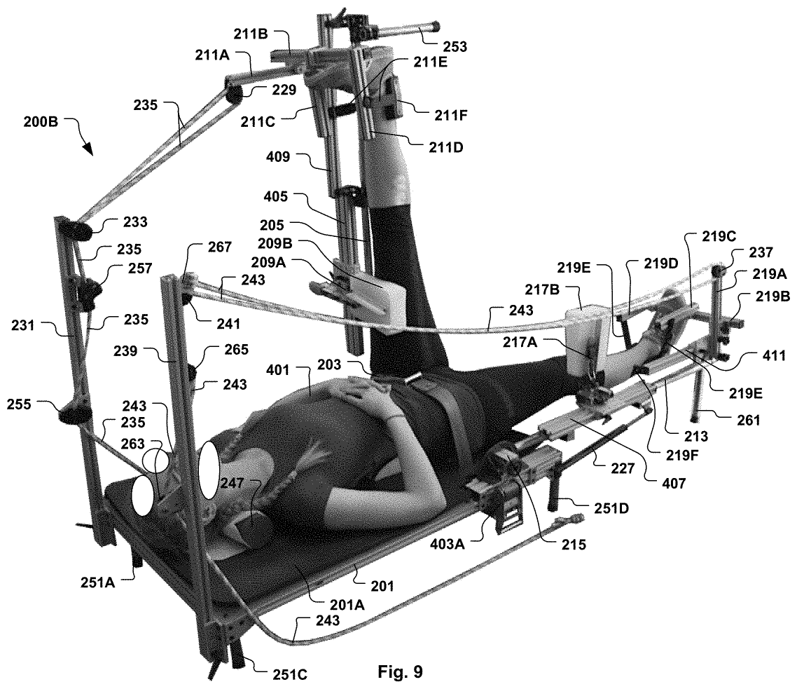

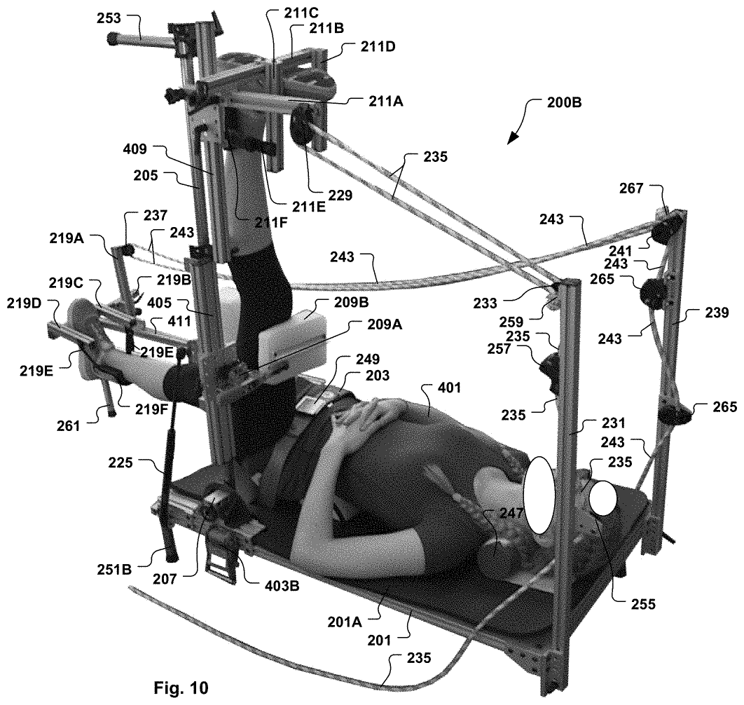

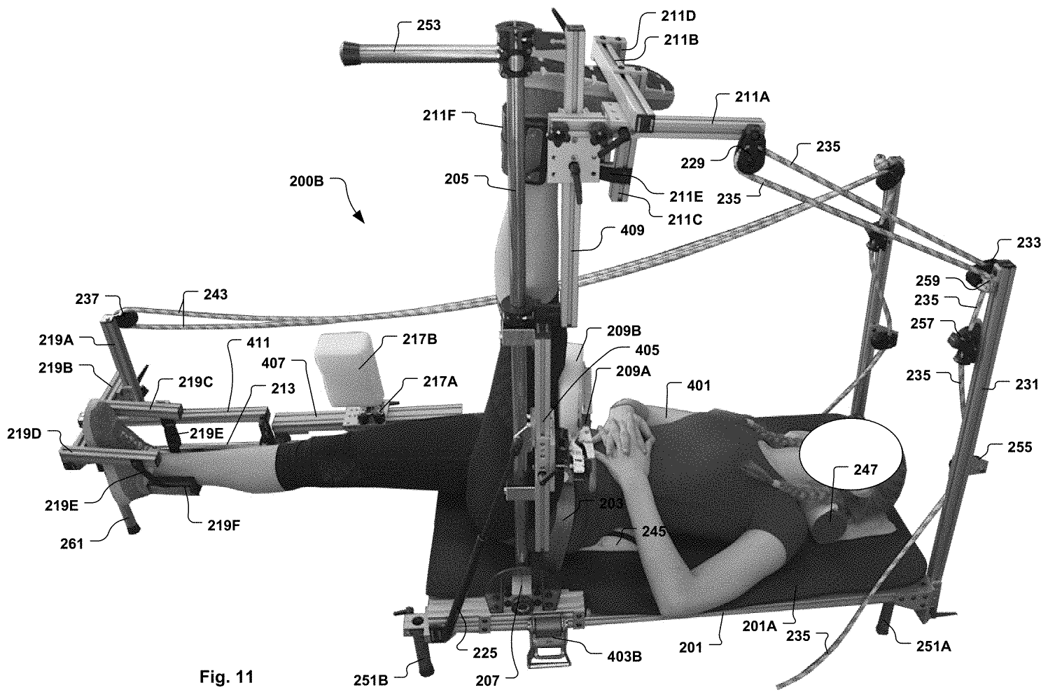

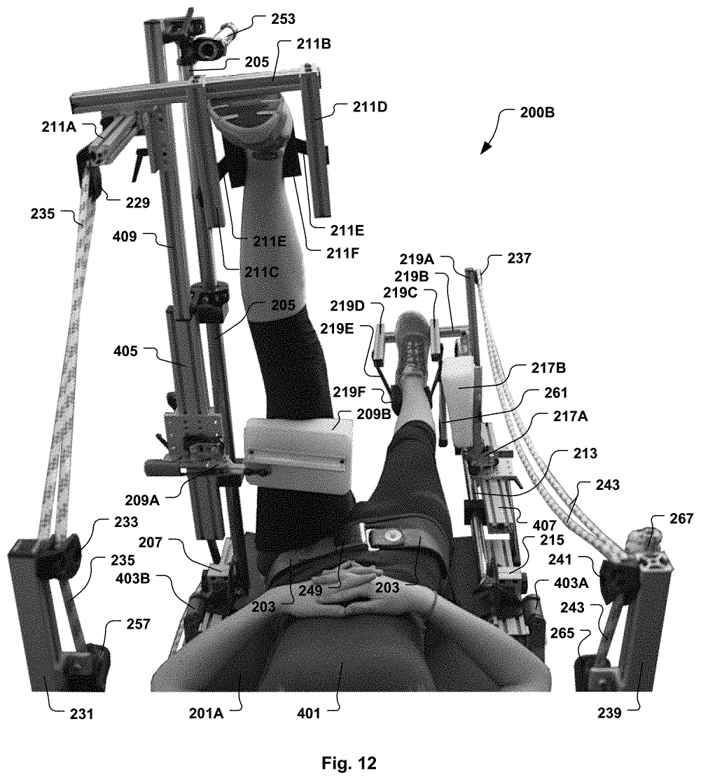

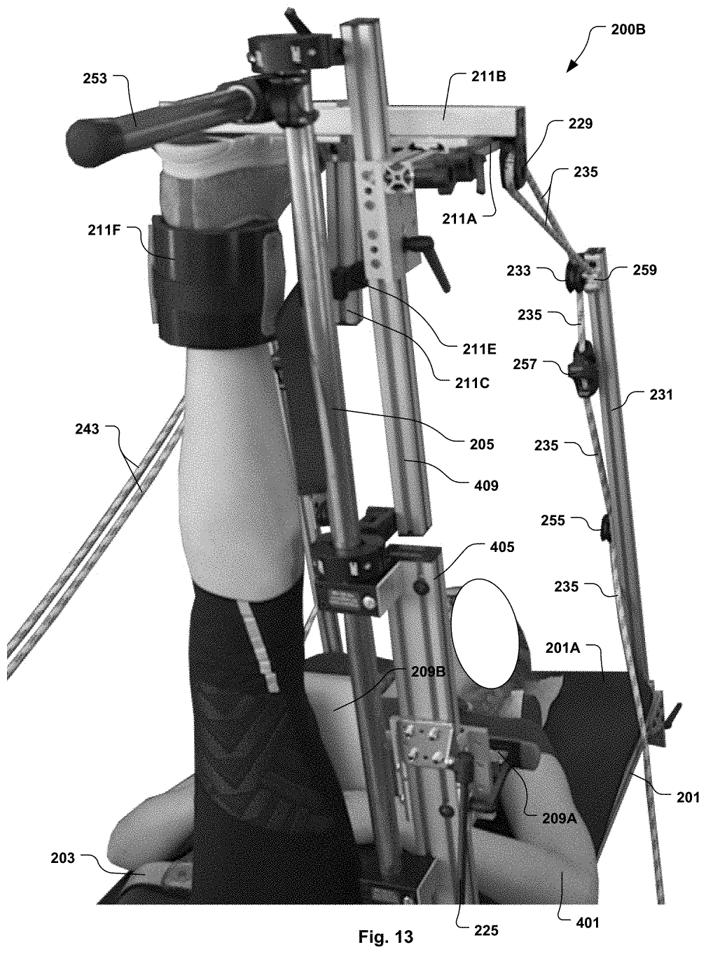

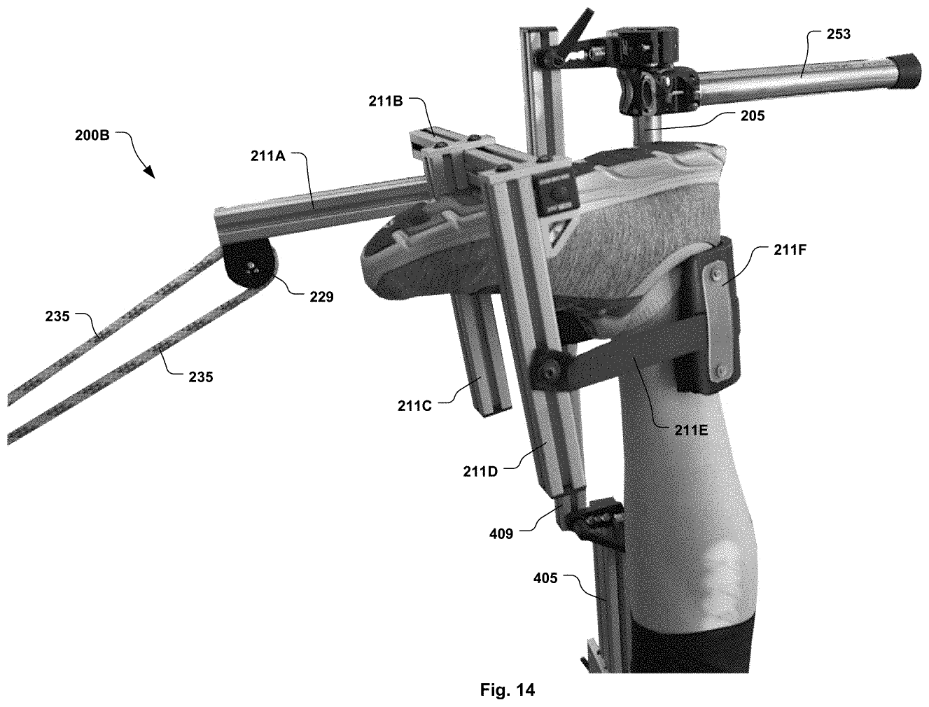

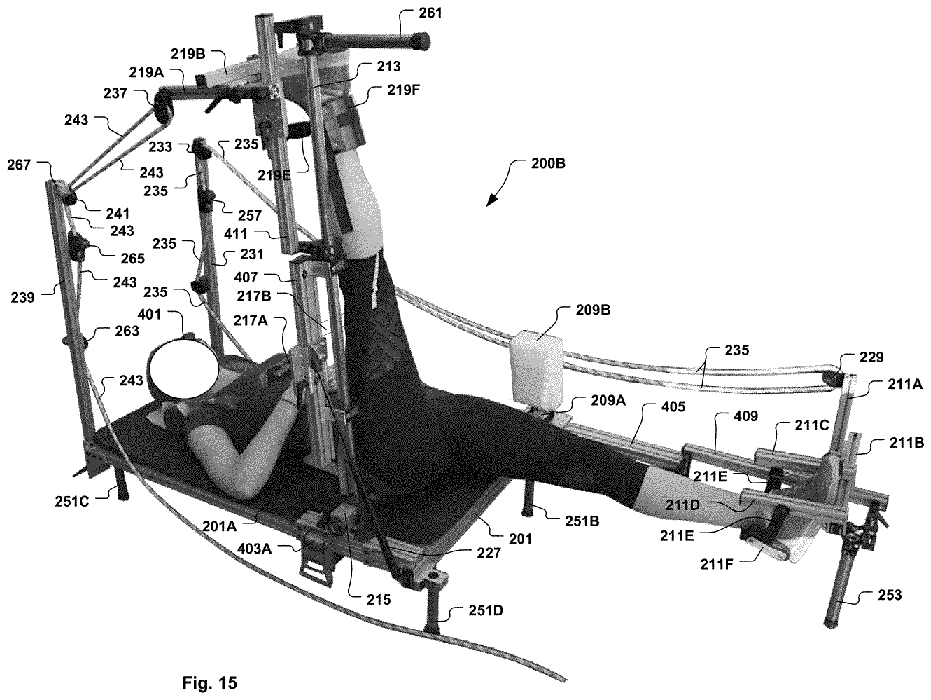

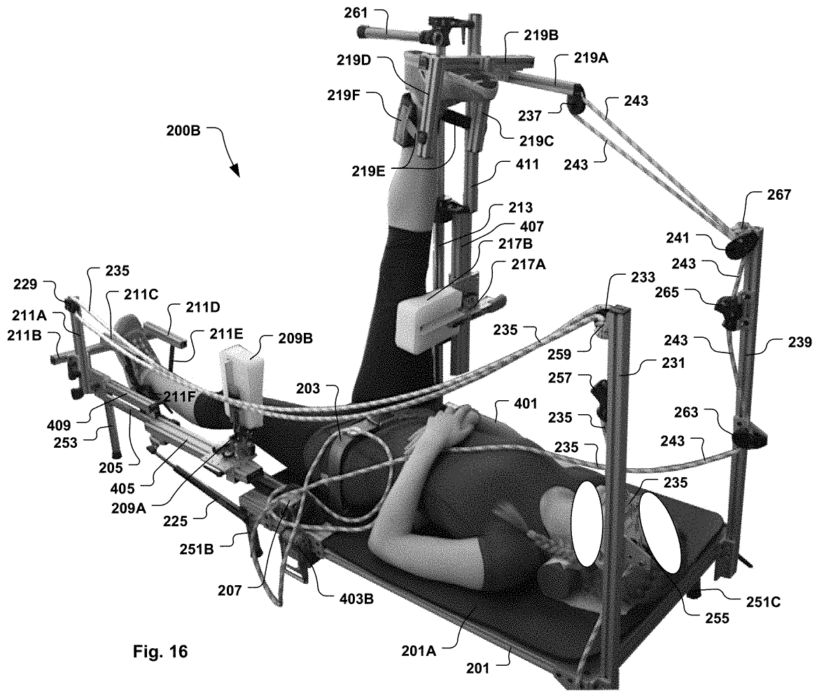

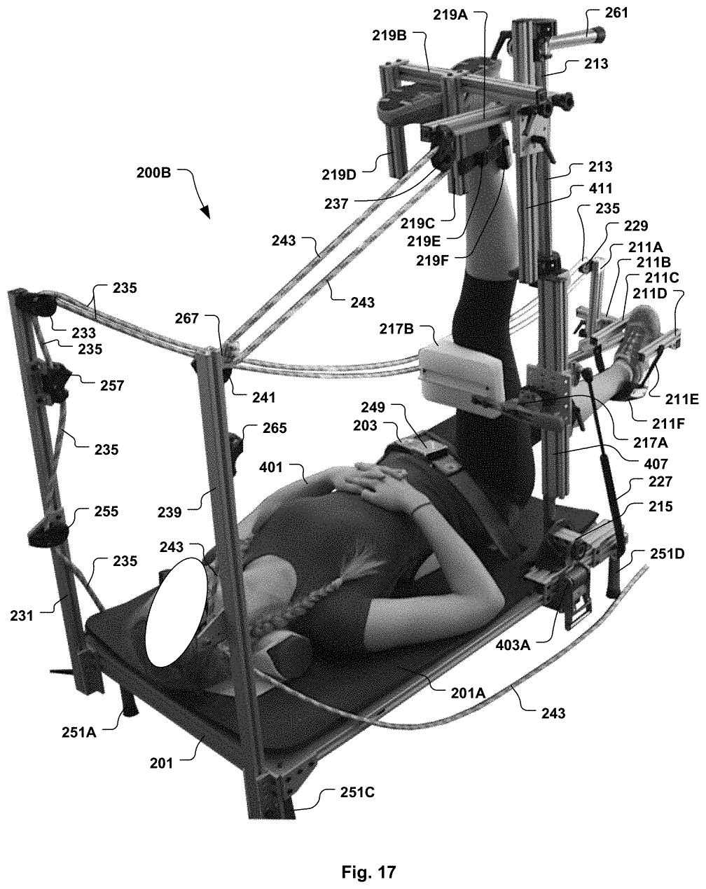

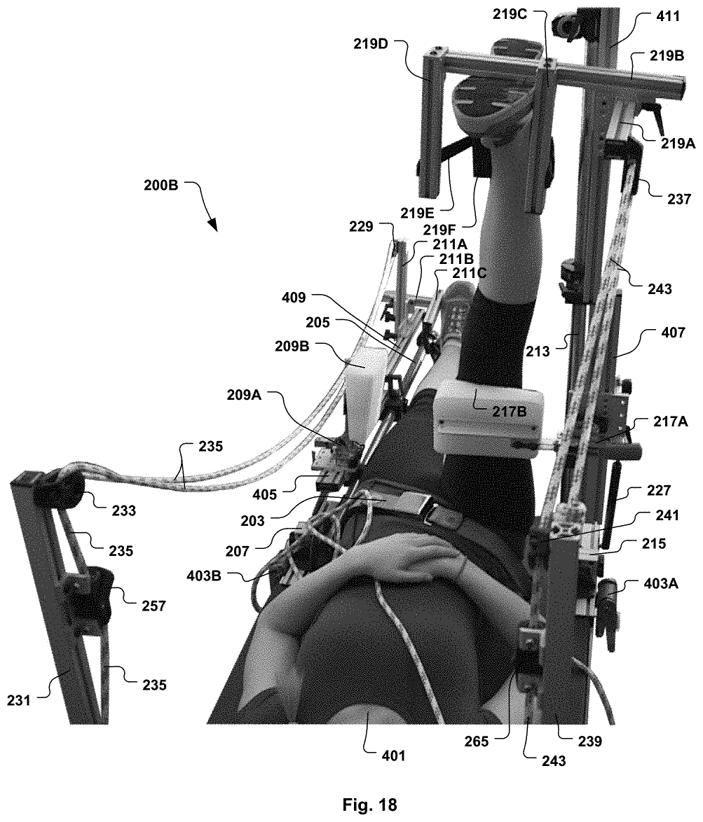

FIGS. 4 through 18 show various views of a person 401 using a nervous system stretching apparatus 200B, in accordance with some embodiments of the present invention. The nervous system stretching apparatus 200B is an example implementation of the nervous system stretching apparatus 200A of FIGS. 3A through 3L, which is an example implementation of the nervous system stretching apparatus 200 of FIG. 2. The nervous system stretching apparatus 200B includes a right ratchet mechanism 403A and a left ratchet mechanism 403B for the pelvic restraint 203 configured as a belt. More specifically, in the nervous system stretching apparatus 200B, the pelvic restraint 203 belt extends through the platform 201 and over to each of the right ratchet mechanism 403A and the left ratchet mechanism 403B. The right ratchet mechanism 403A is rigidly connected to the right side 201R of the platform 201. The left ratchet mechanism 403B is rigidly connected to the left side 201L of the platform 201. Each of the right ratchet mechanism 403A and the left ratchet mechanism 403B is configured to receive the pelvic restraint 203 belt and provide for tightening of the pelvic restraint 203 belt toward the platform 201 and releasing of the pelvic restraint 203 belt away from the platform 201.

Also, in the nervous system stretching apparatus 200B, the support and clamping structure 209A of the left thigh clamp 209 includes a mounting bar 405 that is rigidly connected to the support arm 205 of the left leg armature 204. The support and clamping structure 209A also includes a quick-release toggle clamp connected to the mounting bar 405. The contacting member 209B of the left thigh clamp 209 is attached to a backing member that is connected to the quick-release toggle clamp support and clamping structure 209A.

Also, in the nervous system stretching apparatus 200B, the support and clamping structure 217A of the right thigh clamp 217 includes a mounting bar 407 that is rigidly connected to the support arm 213 of the right leg armature 212. The support and clamping structure 217A also includes a quick-release toggle clamp connected to the mounting bar 407. The contacting member 217B of the right thigh clamp 217 is attached to a backing member that is connected to the quick-release toggle clamp of the support and clamping structure 217A.

Also, in the nervous system stretching apparatus 200B, the left leg engagement mechanism 211 includes a mounting bar 409 that is rigidly connected to the support arm 205 of the left leg armature 204. The stanchion member 211A of the left leg engagement mechanism 211 is rigidly connected to the mounting bar 409. Similarly, the right leg engagement mechanism 219 includes a mounting bar 411 that is rigidly connected to the support arm 213 of the right leg armature 212. The stanchion member 219A of the right leg engagement mechanism 219 is rigidly connected to the mounting bar 411.

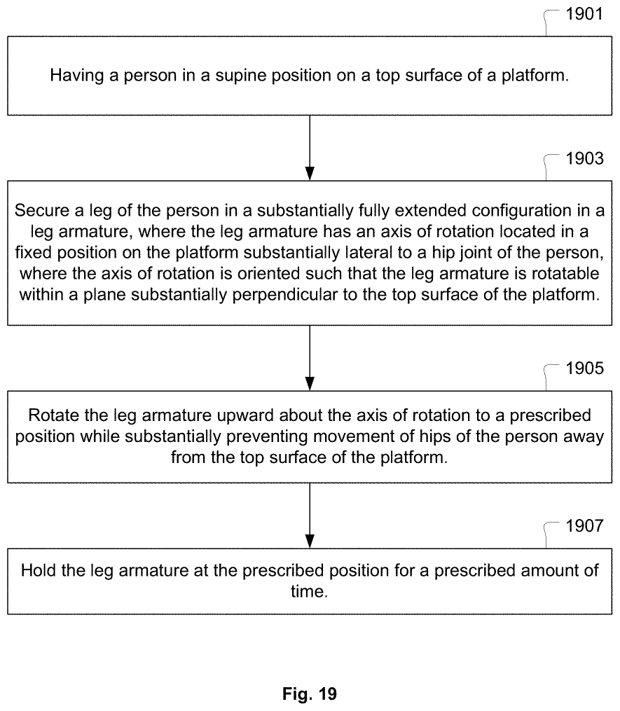

FIG. 19 shows a flowchart of a method for nervous system stretching, in accordance with some embodiments of the present invention. The method includes an operation 1901 for having a person (401) in a supine position on a top surface of a platform (201). The method proceeds with an operation 1903 for securing a leg of the person (401) in a substantially fully extended configuration in a leg armature (204 or 212). In some embodiments, securing the leg of the person (401) in the substantially fully extended configuration in the leg armature (204/212) includes applying a thigh clamp (209/217) to an anterior surface of a thigh of the leg of the person (401). In some embodiments, the thigh clamp (209/217) is configured to release in a direction away from the anterior surface of the thigh of the person (401) when a pressure applied to the thigh clamp (209/217) by the thigh of the leg of the person (401) exceeds a set threshold pressure. In some embodiments, the set threshold pressure is set to enable release of the thigh clamp (209/217) before damage/injury can occur to ligaments of the knee of the person (401).

In some embodiments, securing the leg of the person (401) in the substantially fully extended configuration in the leg armature (204/212) includes positioning a posterior surface of a lower portion of the leg of the person (401) against a leg engagement mechanism (211/219) configured to apply force to the leg of the person (401) in conjunction with rotational movement of the leg armature (204/212) about an axis of rotation (204A/212A) of the leg armature (204/212). The axis of rotation (204A/212A) of the leg armature (204/212) is located in a fixed position relative to the platform (201) at a prescribed distance from an axis of rotation of a hip joint of the person (401). The axis of rotation (204A/212A) is oriented such that the leg armature (204/212) is rotatable within a plane substantially perpendicular to the top surface of the platform (201).

The method further includes an operation 1905 for rotating the leg armature (204/212) upward about the axis of rotation (204A/212A) to a prescribed position while substantially preventing movement of hips of the person (401) away from the top surface of the platform (201). In some embodiments, substantially preventing movement of hips of the person (401) away from the top surface of the platform (201) includes positioning a pelvic restraint (203) over the pelvis of the person (401) and tightening the pelvic restraint (203) toward the top surface of the platform (201). In some embodiments, the pelvic restraint (203) is positioned just inferior to iliac crests of the person (401). In some embodiments, the pelvic restraint (203) is positioned over iliac crests of the person (401). In some embodiments, the pelvic restraint (203) is configured as a belt. In some embodiments, the pelvic restraint 203 is a structure, such as a pad or contoured rigid member, configured to apply force to the pelvis of person so as to hold the hips of the person to the platform 201 as the leg(s) of the person are raised upward.

In some embodiments, the method includes applying an increasing downward force to a pelvis of the person as the leg armature (204/212) is rotated upward about the axis of rotation (204A/212A). In some embodiments, a magnitude of the increasing downward force is a function of location of the axis of rotation (204A/212A) of the leg armature (204/212) relative to an axis of rotation of a hip joint of the person. In some embodiments, the increasing downward force is applied to the pelvis of the person by the leg armature (204/212).

The method also includes an operation 1907 for holding the leg armature (204/212) at the prescribed position for a prescribed amount of time. The leg of the person (401) is maintained in the substantially fully extended configuration in the leg armature (204/212) as the leg armature (204/212) is rotated upward and held at the prescribed position for the prescribed amount of time. In some embodiments, the method can also include an operation for holding a foot of the leg of the person (401) in dorsiflexion as the leg armature (204/212) is rotated upward and held at the prescribed position for the prescribed amount of time. In some embodiments, the foot of the leg of the person (401) is held in dorsiflexion by positioning a foot plate (211B/219B) of the leg armature (204/212) in a fixed position against a bottom of the foot of the leg of the person (401).

In some embodiments, the leg armature (204/212) is rotated upward about the axis of rotation (204A/212A) by a lifting mechanism, and is held at an elevated position by the lifting mechanism. In some embodiments, the lifting mechanism is operable by the person (401). In some embodiments, the lifting mechanism includes a block and tackle assembly and a rope (235/243) extending through the block and tackle assembly. It should be understood that any of the example lifting mechanisms described herein, or equivalents thereof, for lifting and holding the leg armatures (204/212) can be used in the method of FIG. 19.

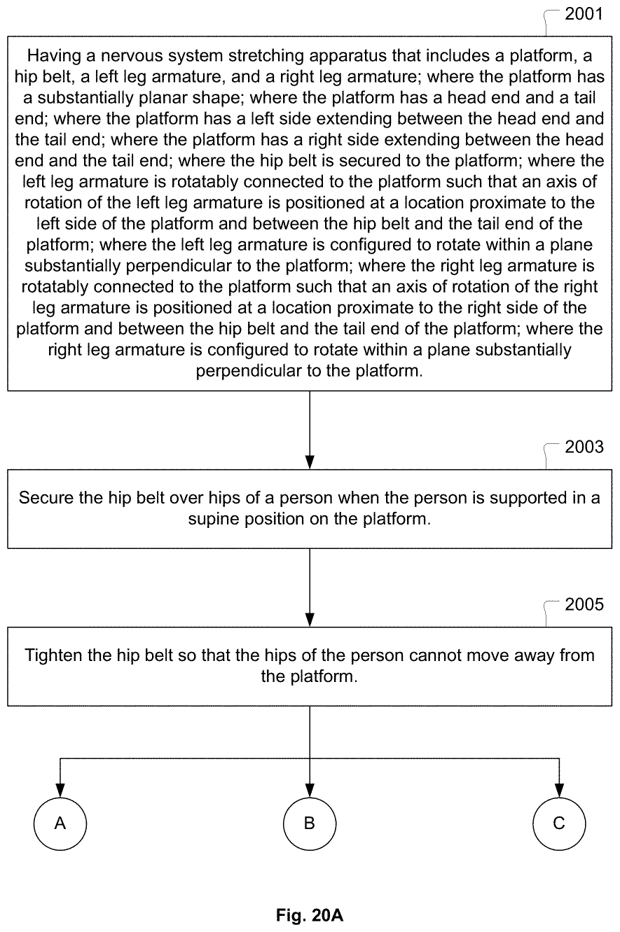

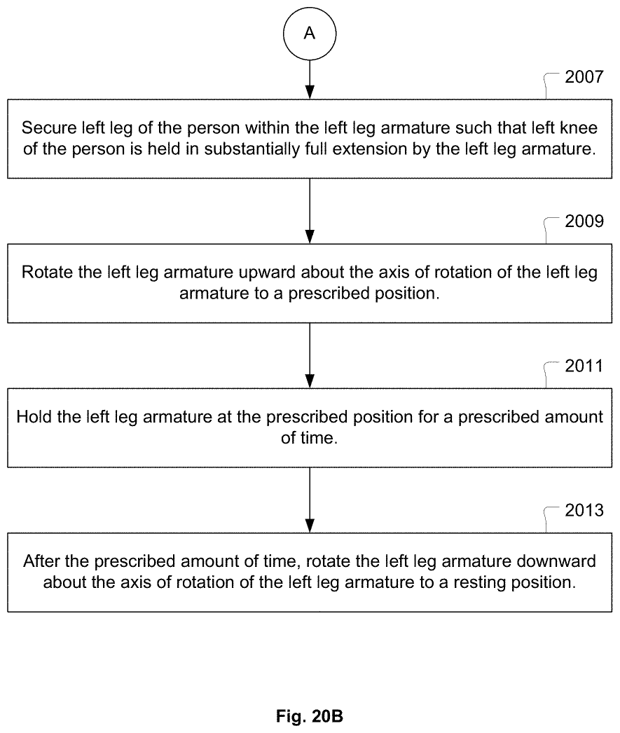

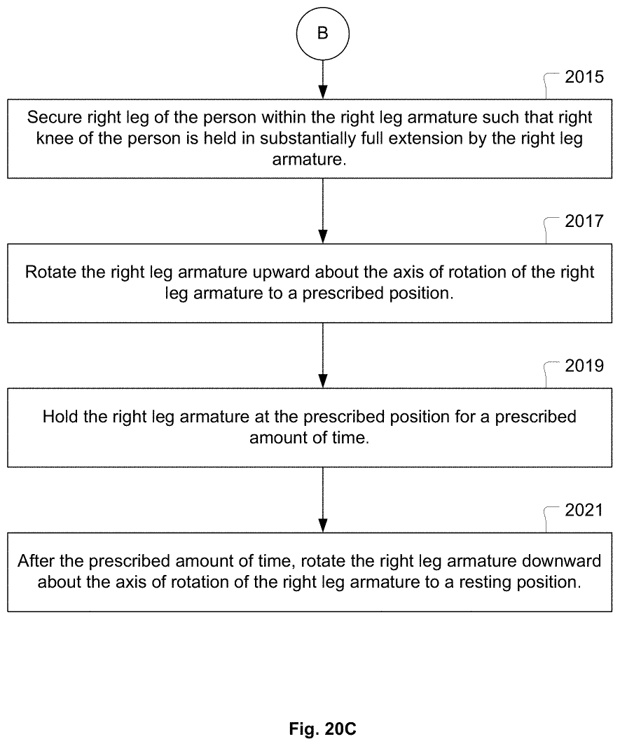

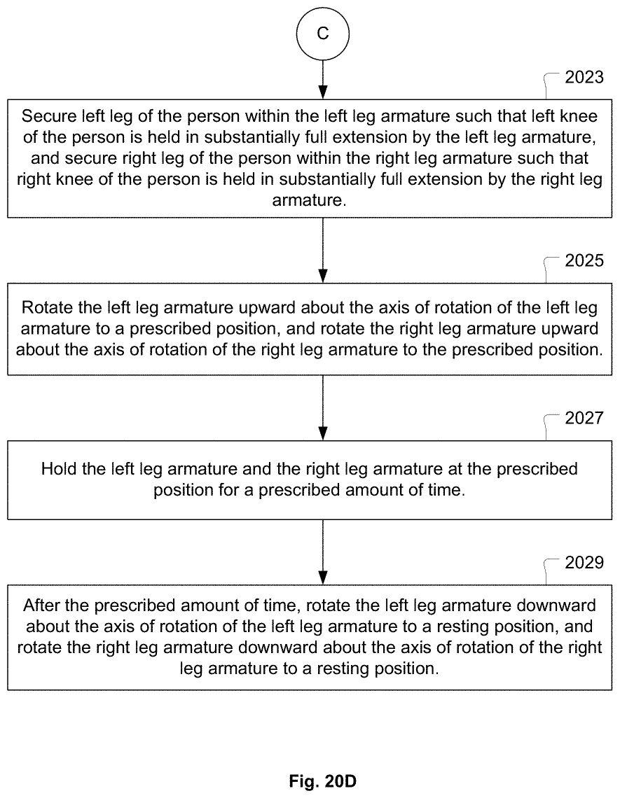

FIG. 20A shows a flowchart of a method for nervous system stretching, in accordance with some embodiments of the present invention. The method includes an operation 2001 for having a nervous system stretching apparatus (200/200A/200B) that includes a platform (201), a pelvic restraint (203), a left leg armature (204), and a right leg armature (212). The platform (201) has a substantially planar shape. The platform (201) has a head end (201H) and a tail end (201T). The platform (201) has a left side (201L) extending between the head end (201H) and the tail end (201T). The platform (201) has a right side (201R) extending between the head end (201H) and the tail end (201T). The pelvic restraint (203) is secured to the platform (201). The left leg armature (204) is rotatably connected to the platform (201) such that an axis of rotation (204A) of the left leg armature (204) is positioned at a location proximate to the left side (201L) of the platform (201) and between the pelvic restraint (203) and the tail end (201T) of the platform (201). The left leg armature (204) is configured to rotate within a plane substantially perpendicular to the platform (201), e.g., within a vertically oriented plane that is substantially perpendicular to the horizontally oriented top surface of the platform (201). The right leg armature (212) is rotatably connected to the platform (201) such that an axis of rotation (212A) of the right leg armature (212) is positioned at a location proximate to the right side (201R) of the platform (201) and between the pelvic restraint (203) and the tail end (201T) of the platform (201). The right leg armature (212) is configured to rotate within a plane substantially perpendicular to the platform (201), e.g., within a vertically oriented plane that is substantially perpendicular to the horizontally oriented top surface of the platform (201).

The method also includes an operation 2003 for securing the pelvic restraint (203) over the pelvis of a person (401) when the person (401) is supported in a supine position on the platform (201). In some embodiments, the pelvic restraint (203) is positioned just inferior to iliac crests of a pelvis of the person (401). In some embodiments, the pelvic restraint (203) is positioned over iliac crests of the pelvis of the person (401). The method also includes an operation 2005 for tightening the pelvic restraint (203) toward the top surface of the platform (201) so that the hips of the person (401) cannot move away from the platform (201).

From the operation 2005, the method proceeds with performing a nerve stretching process on the person using the nervous system stretching apparatus (200/200A/200B). The nerve stretching process can be either a first stretching process (A) in which the left leg of the person (401) is raised and held at an elevated position, or a second stretching process (B) in which the right leg of the person (401) is raised and held at an elevated position, or a third stretching process (C) in which both the left leg and the right leg of the person (401) are raised and held at an elevated position. FIG. 20B shows a flowchart of the first stretching process (A), in accordance with some embodiments of the present invention. FIG. 20C shows a flowchart of the second stretching process (B), in accordance with some embodiments of the present invention. FIG. 20D shows a flowchart of the third stretching process (C), in accordance with some embodiments of the present invention.

As shown in FIG. 2B, the first stretching process (A) includes an operation 2007 for securing the left leg of the person (401) within the left leg armature (204) such that the left knee of the person is held in substantially full extension by the left leg armature (204). In some embodiments, securing the left leg of the person (401) in the substantially fully extended configuration in the left leg armature (204) includes applying a left thigh clamp (209) to an anterior surface of the left thigh of the person (401). In some embodiments, the left thigh clamp (209) is configured to release in a direction away from the anterior surface of the left thigh of the person (401) when a pressure applied to the left thigh clamp (209) by the left thigh of the person (401) exceeds a set threshold pressure. In some embodiments, the set threshold pressure is set to enable release of the left thigh clamp (209) before damage/injury can occur to ligaments of the left knee of the person (401). In some embodiments, securing the left leg of the person (401) in the substantially fully extended configuration in the left leg armature (204) includes positioning a posterior surface of a lower portion of the left leg of the person (401) against a left leg engagement mechanism (211) configured to apply force to the left leg of the person (401) in conjunction with rotational movement of the left leg armature (204) about an axis of rotation (204A) of the left leg armature (204).

The first stretching process (A) also includes an operation 2009 for rotating the left leg armature (204) upward about the axis of rotation (204A) of the left leg armature (204) to a prescribed position. It should be understood that the pelvic restraint 203 functions to prevent the hips of the person (401) from moving away from the top surface of the platform (201) as the left leg armature (204) is rotated upward in operation 2009. The first stretching process (A) also includes an operation 2011 for holding the left leg armature (204) at the prescribed position for a prescribed amount of time. The left leg of the person (401) is maintained in the substantially fully extended configuration in the left leg armature (204) as the left leg armature (204) is rotated upward and held at the prescribed position for the prescribed amount of time. In some embodiments, the method can also include an operation for holding the left foot of the person (401) in dorsiflexion as the left leg armature (204) is rotated upward and held at the prescribed position for the prescribed amount of time. In some embodiments, the left foot of the person (401) is held in dorsiflexion by positioning a left foot plate (211B) of the left leg armature (204) in a fixed position against a bottom of the left foot of the person (401).

The first stretching process (A) also includes an operation 2013 in which, after the prescribed amount of time, the left leg armature (204) is rotated downward about the axis of rotation (204A) of the left leg armature (204) to a resting position. In some embodiments, the operations 2009, 2011, and 2013 are performed using a lifting mechanism. In some embodiments, the lifting mechanism is operable by the person (401). In some embodiments, the lifting mechanism includes a block and tackle assembly and a rope (235) extending through the block and tackle assembly. It should be understood that any of the example lifting mechanisms described herein, or equivalents thereof, for lifting and holding the left leg armature (204) can be used in the method of FIG. 20B.

As shown in FIG. 2C, the second stretching process (B) includes an operation 2015 for securing the right leg of the person (401) within the right leg armature (212) such that the right knee of the person (401) is held in substantially full extension by the right leg armature (212). In some embodiments, securing the right leg of the person (401) in the substantially fully extended configuration in the right leg armature (212) includes applying a right thigh clamp (217) to an anterior surface of the right thigh of the person (401). In some embodiments, the right thigh clamp (217) is configured to release in a direction away from the anterior surface of the right thigh of the person (401) when a pressure applied to the right thigh clamp (217) by the right thigh of the person (401) exceeds a set threshold pressure. In some embodiments, the set threshold pressure is set to enable release of the right thigh clamp (217) before damage/injury can occur to ligaments of the right knee of the person (401). In some embodiments, securing the right leg of the person (401) in the substantially fully extended configuration in the right leg armature (212) includes positioning a posterior surface of a lower portion of the right leg of the person (401) against a right leg engagement mechanism (219) configured to apply force to the right leg of the person (401) in conjunction with rotational movement of the right leg armature (212) about an axis of rotation (212A) of the right leg armature (212).

The second stretching process (B) also includes an operation 2017 for rotating the right leg armature (212) upward about the axis of rotation (212A) of the right leg armature (212) to a prescribed position. It should be understood that the pelvic restraint 203 functions to prevent the hips of the person (401) from moving away from the top surface of the platform (201) as the right leg armature (212) is rotated upward in operation 2017. The second stretching process (B) also includes an operation 2019 for holding the right leg armature (212) at the prescribed position for a prescribed amount of time. The right leg of the person (401) is maintained in the substantially fully extended configuration in the right leg armature (212) as the right leg armature (212) is rotated upward and held at the prescribed position for the prescribed amount of time. In some embodiments, the method can also include an operation for holding the right foot of the person (401) in dorsiflexion as the right leg armature (212) is rotated upward and held at the prescribed position for the prescribed amount of time. In some embodiments, the right foot of the person (401) is held in dorsiflexion by positioning a right foot plate (219B) of the right leg armature (212) in a fixed position against a bottom of the right foot of the person (401).

The second stretching process (B) also includes an operation 2021 in which, after the prescribed amount of time, the right leg armature (212) is rotated downward about the axis of rotation (212A) of the right leg armature (212) to a resting position. In some embodiments, the operations 2017, 2019, and 2021 are performed using a lifting mechanism. In some embodiments, the lifting mechanism is operable by the person (401). In some embodiments, the lifting mechanism includes a block and tackle assembly and a rope (243) extending through the block and tackle assembly. It should be understood that any of the example lifting mechanisms described herein, or equivalents thereof, for lifting and holding the right leg armature (212) can be used in the method of FIG. 20C.

As shown in FIG. 2D, the third stretching process (C) includes an operation 2023 for securing the left leg of the person (401) within the left leg armature (204) such that the left knee of the person (401) is held in substantially full extension by the left leg armature (204), and securing the right leg of the person (401) within the right leg armature (212) such that the right knee of the person (401) is held in substantially full extension by the right leg armature (212). The operation 2023 is substantially equivalent to performance of both of the operations 2007 and 2015 of FIGS. 20B and 20C, respectively. The third stretching process (C) also includes an operation 2025 for rotating the left leg armature (204) upward about the axis of rotation (204A) of the left leg armature (204) to a prescribed position, and rotating the right leg armature (212) upward about the axis of rotation (212A) of the right leg armature (212) to a prescribed position. The operation 2025 is substantially equivalent to simultaneous performance of both of the operations 2009 and 2017 of FIGS. 20B and 20C, respectively.

The third stretching process (C) also includes an operation 2027 for holding the left leg armature (204) at the prescribed position for a prescribed amount of time, and holding the right leg armature (212) at the prescribed position for a prescribed amount of time. The operation 2027 is substantially equivalent to simultaneous performance of both of the operations 2011 and 2019 of FIGS. 20B and 20C, respectively. In some embodiments, the third stretching process (C) can also include an operation for holding the left foot of the person (401) in dorsiflexion as the left leg armature (204) is rotated upward and held at the prescribed position for the prescribed amount of time, and holding the right foot of the person (401) in dorsiflexion as the right leg armature (212) is rotated upward and held at the prescribed position for the prescribed amount of time. In some embodiments, the left foot of the person (401) is held in dorsiflexion by positioning a foot plate (211B) of the left leg armature (204) in a fixed position against a bottom of the left foot of the person (401). Also, in some embodiments, the right foot of the person (401) is held in dorsiflexion by positioning a foot plate (219B) of the right leg armature (212) in a fixed position against a bottom of the right foot of the person (401).

The third stretching process (C) also includes an operation 2029 in which, after the prescribed amount of time, the left leg armature (204) is rotated downward about the axis of rotation (204A) of the left leg armature (204) to a resting position, and the right leg armature (212) is rotated downward about the axis of rotation (212A) of the right leg armature (212) to a resting position. In some embodiments, the operations 2025, 2027, and 2029 are performed using lifting mechanisms. In some embodiments, the lifting mechanisms are operable by the person (401). In some embodiments, the lifting mechanisms includes block and tackle assemblies and ropes (235, 243) extending through the block and tackle assemblies. It should be understood that any of the example lifting mechanisms described herein, or equivalents thereof, for lifting and holding the left leg armature (204) and the right leg armature (212) can be used in the method of FIG. 20D.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the described embodiments.

What is claimed is:

1-48. (canceled)

49. A nervous system stretching apparatus, comprising:
a platform having a substantially planar shape, the platform having a head end and a tail end, the platform having a left side extending between the head end and the tail end, the platform having a right side extending between the head end and the tail end;
a pelvic restraint secured to the platform;
a left leg armature rotatably connected to the platform such that an axis of rotation of the left leg armature is positioned at a location proximate to the left side of the platform and between the pelvic restraint and the tail end of the platform, the left leg armature configured to rotate within a plane substantially perpendicular to the platform; and
a right leg armature rotatably connected to the platform such that an axis of rotation of the right leg armature is positioned at a location proximate to the right side of the platform and between the pelvic restraint and the tail end of the platform, the right leg armature configured to rotate within a plane substantially perpendicular to the platform.

50-52. (canceled)

53. The nervous system stretching apparatus as recited in claim 52, wherein the pelvic restraint is a belt configured and positioned to extend across the platform in a direction substantially parallel to both the axis of rotation of the left leg armature and the axis of rotation of the right leg armature, wherein the belt is configured to tighten toward the platform and loosen away from the platform.

54-61. (canceled)

62. The nervous system stretching apparatus as recited in claim 49, wherein the left leg armature includes a left foot plate, and wherein the right leg armature includes a right foot plate.

63. The nervous system stretching apparatus as recited in claim 49, wherein the left leg armature includes a left thigh clamp, and wherein the right leg armature includes a right thigh clamp.

64. The nervous system stretching apparatus as recited in claim 63, wherein the left thigh clamp includes an overpressure release mechanism configured to release the left thigh clamp when a pressure applied to the left thigh clamp exceeds a set threshold pressure, and wherein the right thigh clamp includes an overpressure release mechanism configured to release the right thigh clamp when a pressure applied to the right thigh clamp exceeds a set threshold pressure.

65. The nervous system stretching apparatus as recited in claim 64, wherein the left thigh clamp includes one or more springs configured and positioned to provide for limited movement of the left thigh clamp without activation of the overpressure release mechanism of the left thigh clamp, and wherein the right thigh clamp includes one or more springs configured and positioned to provide for limited movement of the right thigh clamp without activation of the overpressure release mechanism of the right thigh clamp.

66. (canceled)

67. The nervous system stretching apparatus as recited in claim 63, wherein a position of the left thigh clamp along the left leg armature is adjustable, and wherein a position of the right thigh clamp along the right leg armature is adjustable.

68. The nervous system stretching apparatus as recited in claim 63, wherein the left leg armature includes a left leg engagement mechanism configured to move in conjunction with rotational movement of the left leg armature about the axis of rotation of the left leg armature, the left leg engagement mechanism positioned near a distal end of the left leg armature, the distal end of the left leg armature being an end of the left leg armature farthest from the axis of rotation of the left leg armature, and wherein the right leg armature includes a right leg engagement mechanism configured to move in conjunction with rotational movement of the right leg armature about the axis of rotation of the right leg armature, the right leg engagement mechanism positioned near a distal end of the right leg armature, the distal end of the right leg armature being an end of the right leg armature farthest from the axis of rotation of the right leg armature.

69. The nervous system stretching apparatus as recited in claim 68, wherein the left leg engagement mechanism is a first strap, and wherein the right leg engagement mechanism is a second strap.

70. The nervous system stretching apparatus as recited in claim 49, further comprising:
a lumbar support disposed on the platform at a location between the pelvic restraint and the head end of the platform, wherein the lumbar support is configured to create a forced lordosis of a lumbar spinal region of the person and/or of a thoracolumbar spinal region of the person.

71-73. (canceled)

74. The nervous system stretching apparatus as recited in claim 49, further comprising:
a neck support disposed on the platform at a location near a head end of the platform.

75-76. (canceled)

77. The nervous system stretching apparatus as recited in claim 49, further comprising:
a left lifting mechanism configured to apply a lifting force to the left leg armature, the left lifting mechanism configured hold the left leg armature at an elevated position; and
a right lifting mechanism configured to apply a lifting force to the right leg armature, the right lifting mechanism configured hold the right leg armature at an elevated position, wherein the left lifting mechanism and the right lifting mechanism are independently operable.

78. The nervous system stretching apparatus as recited in claim 77, wherein the left lifting mechanism includes a first block and tackle assembly and a first rope extending through the first block and tackle assembly, and wherein the right lifting mechanism includes a second block and tackle assembly and a second rope extending through the second block and tackle assembly.

79. The nervous system stretching apparatus as recited in claim 77, wherein the left lifting mechanism includes a first pulley connected to the left leg armature and a rope positioned to extend around the first pulley, and wherein the right lifting mechanism includes a first pulley connected to the right leg armature and a rope positioned to extend around the first pulley.

80. The nervous system stretching apparatus as recited in claim 79, wherein the left lifting mechanism includes a second pulley, the rope of the left lifting mechanism configured and positioned to extend from the first pulley of the left lifting mechanism to and around the second pulley of the left lifting mechanism, and wherein the right lifting mechanism includes a second pulley, the rope of the right lifting mechanism configured and positioned to extend from the first pulley of the right lifting mechanism to and around the second pulley of the right lifting mechanism.

81. The nervous system stretching apparatus as recited in claim 80, wherein the second pulley of the left lifting mechanism is positioned such that rotation of the left leg armature about the axis of rotation of the left leg armature causes a reduction in a linear distance between the first and second pulleys of the left lifting mechanism, and wherein the second pulley of the right lifting mechanism is positioned such that rotation of the right leg armature about the axis of rotation of the right leg armature causes a reduction in a linear distance between the first and second pulleys of the right lifting mechanism.

82. The nervous system stretching apparatus as recited in claim 81, wherein the left lifting mechanism includes a rope holding device, the rope of the left lifting mechanism configured and positioned to extend from the second pulley of the left lifting mechanism to and through the rope holding device of the left lifting mechanism, and wherein the right lifting mechanism includes a rope holding device, the rope of the right lifting mechanism configured and positioned to extend from the second pulley of the right lifting mechanism to and through the rope holding device of the right lifting mechanism.

83. The nervous system stretching apparatus as recited in claim 82, further comprising:
a left stanchion connected to the platform, wherein the second pulley of the left lifting mechanism is rotatably connected to the left stanchion; and
a right stanchion connected to the platform, wherein the second pulley of the right lifting mechanism is rotatably connected to the right stanchion.

84. The nervous system stretching apparatus as recited in claim 83, wherein the rope holding device of the left lifting mechanism is connected to the left stanchion, and wherein the rope holding device of the right lifting mechanism is connected to the right stanchion.

85. The nervous system stretching apparatus as recited in claim 84, wherein the left lifting mechanism includes a third pulley rotatably connected to the left stanchion, the rope of the left lifting mechanism configured and positioned to extend from the rope holding device of the left lifting mechanism to and around the third pulley of the left lifting mechanism, and wherein the right lifting mechanism includes a third pulley rotatably connected to the right stanchion, the rope of the right lifting mechanism configured and positioned to extend from the rope holding device of the right lifting mechanism to and around the third pulley of the right lifting mechanism.

86. A method for nervous system stretching, comprising:
having a person in a supine position on a top surface of a platform;
securing a leg of the person in a substantially fully extended configuration in a leg armature, the leg armature having an axis of rotation located in a fixed position relative to the platform at a prescribed distance from an axis of rotation of a hip joint of the person, the axis of rotation oriented such that the leg armature is rotatable within a plane substantially perpendicular to the top surface of the platform;
rotating the leg armature upward about the axis of rotation to a prescribed position while substantially preventing movement of hips of the person away from the top surface of the platform; and
holding the leg armature at the prescribed position for a prescribed amount of time.

87. The method as recited in claim 86, wherein the leg of the person is maintained in the substantially fully extended configuration in the leg armature as the leg armature is rotated upward and held at the prescribed position for the prescribed amount of time.

88. The method as recited in claim 86, wherein substantially preventing movement of hips of the person away from the top surface of the platform includes positioning a pelvic restraint over the pelvis of the person and tightening the pelvic restraint toward the top surface of the platform.

89-90. (canceled)

91. The method as recited in claim 86, wherein securing the leg of the person in the substantially fully extended configuration in the leg armature includes applying a thigh clamp to an anterior surface of a thigh of the leg of the person.

92. The method as recited in claim 91, wherein the thigh clamp is configured to release in a direction away from the anterior surface of the thigh of the person when a pressure applied to the thigh clamp by the thigh of the leg of the person exceeds a set threshold pressure.

93. The method as recited in claim 86, further comprising:
holding a foot of the leg of the person in dorsiflexion as the leg armature is rotated upward and held at the prescribed position for the prescribed amount of time.

94-95. (canceled)

96. The method as recited in claim 86, wherein the leg armature is rotated upward about the axis of rotation by a lifting mechanism, wherein the lifting mechanism is operable by the person.

97. (canceled)

98. The method as recited in claim 97, wherein the lifting mechanism includes a block and tackle assembly and a rope extending through the block and tackle assembly.

99. The method as recited in claim 86, further comprising:
applying an increasing downward force to a pelvis of the person as the leg armature is rotated upward.

100. (canceled)

101. The method as recited in claim 99, wherein the increasing downward force is applied to the pelvis of the person by the leg armature.

102. (canceled)
